(19) United States
(12) Patent Application Publication
(10) Pub. No.: US 2024/0259322 A1
(43) Pub. Date: Aug. 1, 2024

(54) SYSTEMS, DEVICES AND METHODS WITH OFFLOAD PROCESSING DEVICES

(71) Applicant: Xockets, Inc., San Jose, CA (US)

(72) Inventor: Parin Dalal, Palo Alto, CA (US)

(21) Appl. No.: 18/617,599

(22) Filed: Mar. 26, 2024

Related U.S. Application Data
(63) Continuation of application No. 18/085,196, filed on Dec. 20, 2022.
Application No. 18/085,196 is a continuation of application No. 15/396,318, filed on Dec. 30, 2016, now abandoned.
Application No. 15/396,318 is a continuation of application No. 13/900,318, filed on May 22, 2013, now Pat. No. 9,558,351.
Application No. 15/396,318 is a continuation of application No. 15/283,287, filed on Sep. 30, 2016, now abandoned.
Application No. 15/283,287 is a continuation of application No. PCT/US15/23730, filed on Mar. 31, 2015.
Application No. 15/283,287 is a continuation of application No. PCT/US15/23746, filed on Mar. 31, 2015.
(60) Provisional application No. 61/650,373, filed on May 22, 2012.
(60) Provisional application No. 61/753,892, filed on Jan. 17, 2013.
(60) Provisional application No. 61/753,895, filed on Jan. 17, 2013.
(60) Provisional application No. 61/753,899, filed on Jan. 17, 2013.
(60) Provisional application No. 61/753,901, filed on Jan. 17, 2013.
(60) Provisional application No. 61/753,903, filed on Jan. 17, 2013.
(60) Provisional application No. 61/753,904, filed on Jan. 17, 2013.
(60) Provisional application No. 61/753,906, filed on Jan. 17, 2013.
(60) Provisional application No. 61/753,907, filed on Jan. 17, 2013.
(60) Provisional application No. 61/753,910, filed on Jan. 17, 2013.
(60) Provisional application No. 61/973,205, filed on Mar. 31, 2014.
(60) Provisional application No. 61/973,207, filed on Mar. 31, 2014.
(60) Provisional application No. 61/976,471, filed on Apr. 7, 2014.

(51) Int. Cl. H04L 47/2441; G06F 13/16; G06F 13/28; G06F 13/364; G06F 13/40; G06F 13/42; G06F 21/55; H04L 9/40; H04L 47/10; H04L 49/00

(52) U.S. Cl. CPC H04L 47/2441; G06F 13/1605; G06F 13/1652; G06F 13/1673; G06F 13/28; G06F 13/364; G06F 13/4022; G06F 13/404; G06F 13/4234; G06F 21/55; H04L 9/40; H04L 47/10; H04L 49/70; H04L 63/0227; Y02D 10/00

(57) ABSTRACT

A method for accelerating computing applications with bus compatible modules can include receiving network packets that include data for processing, the data being a portion of a larger data set processed by an application; evaluate header information of the network packets to map network packets to any of a plurality of destinations on the first module, each destination corresponding to at least one of a plurality of offload processors of the first module; executing a programmed operation of the application in parallel on multiple offload processors to generate first processed application data; and transport the first processed application data out of the first module. Corresponding systems and devices are also disclosed.

### RELATED APPLICATIONS

This application is a continuation of U.S. patent application Ser. No. 18/085,196, filed Dec. 20, 2022, which is a continuation of U.S. patent application Ser. No. 15/396,318, filed Dec. 30, 2016, which is a continuation of U.S. patent application Ser. No. 13/900,318 filed May 22, 2013, now U.S. Pat. No. 9,558,351, which claims the benefit of U.S. Provisional Patent Application Nos. 61/650,373 filed May 22, 2012, 61/753,892 filed on Jan. 17, 2013, 61/753,895 filed on Jan. 17, 2013, 61/753,899 filed on Jan. 17, 2013, 61/753,901 filed on Jan. 17, 2013, 61/753,903 filed on Jan. 17, 2013, 61/753,904 filed on Jan. 17, 2013, 61/753,906 filed on Jan. 17, 2013, 61/753,907 filed on Jan. 17, 2013, and 61/753,910 filed on Jan. 17, 2013. U.S. patent application Ser. No. 15/396,318 is also a continuation of U.S. patent application Ser. No. 15/283,287 filed Sep. 30, 2016, which is a continuation of International Application no. PCT/US2015/023730, filed Mar. 31, 2015, which claims the benefit of U.S. Provisional Patent Application No. 61/973,205 filed Mar. 31, 2014. U.S. patent application Ser. No. 15/283,287 is also a continuation of International Application no. PCT/US2015/023746, filed Mar. 31, 2015, which claims the benefit of U.S. Provisional Patent Application Nos. 61/973,207 filed Mar. 31, 2014 and 61/976,471 filed Apr. 7, 2014. The contents of all of these applications are incorporated by reference herein.

### TECHNICAL FIELD

The present disclosure relates generally to systems of servers for executing applications across multiple processing nodes, and more particularly to systems having hardware accelerator modules included in such processing nodes.

### BRIEF DESCRIPTION OF DRAWINGS

FIG. 1 is a block diagram of a conventional system.

FIG. 2 is a diagram of a system according to an embodiment.

FIG. 3 is a diagram showing reference architectures and architectures according to embodiments used for simulation.

FIG. 4 is a diagram of a transparent offload system according to an embodiment.

FIG. 5 is a table showing partition of functions according to embodiments.

FIG. 6 is a table showing simulation results for web applications according to embodiments.

FIG. 7 is a diagram of a system with application switches according to embodiments.

FIG. 8 is a table showing a comparison between a conventional system and an embodiment for an application switch function.

FIG. 9 is a table showing a comparison between a conventional system and an embodiment for a video overlay/routing function.

FIG. 10 is a diagram showing system configured for a map-reduce function according to an embodiment.

FIG. 11 is a table showing a comparison between a conventional system and an embodiment for a map-reduce function.

FIG. 12 is a diagram showing a system configured for a rack-level in-memory disk according to an embodiment.

FIG. 13 is a table showing conventional system performance for VPN/SSL function.

FIG. 14 is a diagram showing a system configured for VPN+IPS functions according to an embodiment.

FIG. 15 is a table showing a comparison between a conventional system and an embodiment for a security+VPN application function.

FIG. 16 is a diagram showing a system used in simulation.

FIG. 17 is a diagram of a XIMM module according to an embodiment.

FIG. 18 is a diagram showing connections of a XIMM module according to an embodiment.

FIG. 19 is a table showing a power budget for a XIMM module according to an embodiment.

FIGS. 20A and 20B are diagrams showing power consumption values included in simulations herein.

FIG. 21 is a graph showing power versus junction temperature of devices that can be included in embodiments.

FIG. 22 is a graph showing latency values used in simulations herein.

FIG. 23 is a table showing network loads used for simulations herein.

FIG. 24 is a table showing queue arrangements used for simulations herein.

FIGS. 25 and 26 are graphs showing packet length simulations used for simulations herein.

FIG. 27 are graphs showing packet size profiles used for simulations herein.

FIGS. 28 and 29 are graphs showing simulated data transfer times.

FIG. 30 is a table showing states of threads and their hardware treatment according to embodiments.

FIG. 31 is a block diagram of a system that can be included in embodiments.

FIG. 32 is a diagram showing memory accesses that can be included in embodiments.

FIGS. 33 and 34 are diagrams showing the timing ingress packets.

FIGS. 35 and 36 are diagrams showing incoming packets and queues.

FIGS. 37 and 38 are diagrams showing timing for queues exceeding limits.

FIGS. 39 and 40 are diagrams showing queue buffering.

FIGS. 41 and 42 are diagrams showing service of queues by ARM processors according to embodiments.

FIGS. 43 and 44 are diagrams showing hardware queue scheduling according to embodiments.

FIG. 45 is a diagram showing cache calls that can be included in embodiments.

FIGS. 46A to 46C are diagrams showing decryption resource utilization that can occur in embodiments.

FIG. 47 is a diagram showing program penalties included in simulations herein.

FIGS. 48 and 49 are diagrams cycles per instruction in a system according to embodiments.

FIG. 50 is a diagram showing processing latency that can include in an embodiment.

FIG. 51 is a diagram showing software stacks according to embodiments.

FIG. 52 is a diagram showing power efficiencies of various processors that can be included in embodiments.

FIG. 53 is a diagram showing a system executing map-reduce functions according to an embodiment.

FIG. 54 is a diagram showing a Hadoop task run that can be executed by an embodiment.

FIG. 55 is a graph showing another Hadoop task run that can be executed by an embodiment.

FIGS. 56A and 56B are diagrams showing common storage systems according to embodiments.

FIG. 57 is a block diagram of a system according to an embodiment.

FIG. 58 is a block diagram of a computer system that can be included in embodiments.

FIG. 59A is a diagram showing a system according to an embodiment.

FIG. 59B is a diagram showing a system flow according to an embodiment.

FIG. 60-0 is a block diagram of a processing module according to an embodiment.

FIGS. 60-0 to 60-3 are diagrams showing processor modules according to embodiments.

FIG. 61 is a diagram of a system according to an embodiment.

FIGS. 62-0 to 62-5 are diagrams showing processor module operations according to embodiments.

FIG. 63 is a flow diagram of a method according to an embodiment.

FIG. 64 is a flow diagram of a method according to another embodiment.

FIG. 65 is a diagram showing protocol stacks according to embodiments.

FIG. 66 is a flow diagram of a publish and subscribe model that can be included in embodiments.

FIGS. 67-0 and 67-1 are processing flow diagrams of systems according to embodiments.

FIG. 68 is a diagram of a system for providing network overlay services according to an embodiment.

FIG. 69 is a flow diagram for providing network overlay services according to an embodiment.

FIG. 70 are diagrams of a data transport system according to an embodiment.

FIGS. 71 and 72 is a flow diagrams of encapsulation and decapsulation methods according to embodiments.

FIG. 73 is a diagram of a networked computing system according to an embodiment.

FIG. 74 is a block diagram of an IOMMU that can be included in embodiments.

FIG. 75 is a block diagram of a packet.

FIG. 76 is flow diagram of an IOMMU process flow according to an embodiment.

FIG. 77 is a flow diagram of process flow according to an embodiment.

FIG. 78 is a flow diagram for locking TLB entries according to an embodiment.

FIG. 79 is an IO device according to an embodiment.

FIG. 80 is a schematic diagram of a networked computing system with a hardware scheduler according to an embodiment.

FIG. 81 is a flow diagram of a method according to an embodiment.

FIG. 82 is a diagram of a hardware scheduler according to an embodiment.

FIG. 83 is a flow diagram of a packet processing method according to an embodiment.

FIGS. 84A and 84B are diagrams of conventional memory arrangements.

FIG. 85 is a diagram of a memory arrangement that can be included in embodiments.

FIG. 86 is a flow diagram of a method for reduced overhead context switching according to an embodiment.

FIG. 87 is a diagram of a server rack.

FIGS. 88 and 89 are diagrams of systems.

FIG. 90 is a diagram of a switch architecture according to an embodiment. At least one specification heading is required. Please delete this heading section if it is not applicable to your application. For more information regarding the headings of the specification, please see MPEP 608.01(a).

### DETAILED DESCRIPTION

Embodiments can include devices, systems and methods in which computing elements can be included in a network architecture to provide a heterogenous computing environment. In some embodiments, the computing elements can be formed on hardware accelerator (hwa) modules that can be included in server systems. The computing elements can provide access to various processing components (e.g., processors, logic, memory) over a multiplexed data transfer structure. In a very particular embodiment, computing elements can include a time division multiplex (TDM) fabric to access processing components.

In some embodiments, computing elements can be linked together to form processing pipelines. Such pipelines can be physical pipelines, with data flowing from one computing element to the next. Such pipeline flows can be within a same hwa module, or across a network packet switching fabric. In particular embodiments, a multiplexed connection fabric of the computing element can be programmable, enabling processing pipelines to be configured as needed for an application.

In some embodiments, computing elements can each have fast access memory to receive data from a previous stage of the pipeline, can be capable of sending data to a fast access memory of a next computing element in the pipeline.

In some embodiments, hwa modules can include one or more module processors, different from a host processor of a server, which can execute a networked application capable of accessing heterogeneous components of the module over multiplexed connections in the computing elements.

In the embodiments described, like items can be referred to with the same reference character but with the leading digit(s) corresponding to the figure number.

Embodiments of the present invention relate to an application-level socket, which are referred to herein as “Xockets.” In an embodiment, Xockets are high-level sockets that connect wimpy cores and brawny cores on, for example, commodity x86 platforms. Xockets creates high-performance, in-memory appliances by re-purposing virtualization. This approach eliminates the need to change software codebases or hardware architecture.

Xockets addresses a growing architectural gap in computing systems such as, for example, x86 systems. For example, a server load requires complex transport, high memory bandwidth, extreme amounts of data bandwidth (randomly accessed, parallelized, and highly available), but often with light touch processing: HTML, video, packet-level services, security, and analytics. Software sockets allow a natural partitioning of these loads between processors such as, for example, ARM and x86 processors. Light touch loads with frequent random-accesses, can be kept behind the socket abstraction on the ARM cores, while high-power number crunching code can use the socket abstraction on the x86 cores. Many servers today employ sockets for connectivity, and so using new application level sockets, Xockets, can be made plug and play in several different ways, according to an embodiment of the present invention.

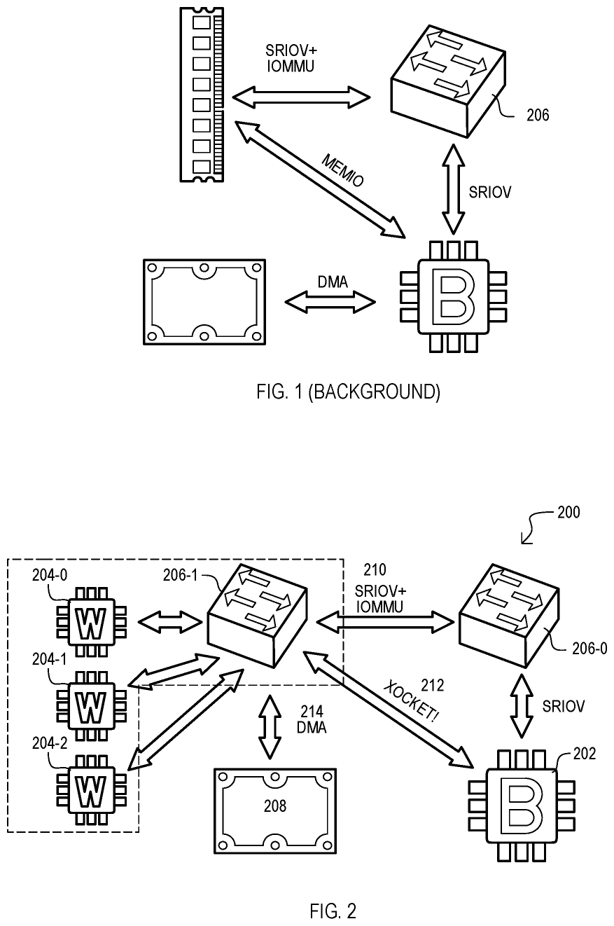

Referring to FIG. 1, typically, a virtual switch 206 running Openflow (or any alternative virtual switch) directs ingressing packets to either a logical core (single root input/output virtualization, SRIOV) or to main memory (SRIOV and input-output memory management unit, SRIOV+IOMMU). Any cache fills of memory (e.g., solid state drives, SSDs) into main memory must be computed by Brawny cores (only one of which is shown with a “B”) with periodic direct memory accesses (DMAs).

In embodiments, Xockets can introduce one or more additional virtual switches connected to a typical virtual switch, via SRIOV+IOMMU, as but one example. Then, a series of wimpy cores, each with their own independent memory channel, can be managed with any suitable virtualization framework. In an embodiment, remote RDMAs can extend this framework by allowing the same virtual switch to handle complex transport and the parsing of other data sources on the rack. In this way, otherwise underutilized socket IO blocks can be driven and processed by wimpy cores, and otherwise underutilized intra-rack communication can integrate the rack tightly.

FIG. 2 shows a system 200 according to an embodiment that includes a “brawny” core 202, first virtual switch 206-0, a second virtual switch 206-1, a number of wimpy cores 204-0 to 204-2, and storage 208. First and second virtual switches 206-0/1 can be connected by SRIOV+IOMMU 210. Second virtual switch 206-1 can enable management of wimpy cores 204-0. In the example shown, second virtual switch 206-1 can also enable transport and parsing of data to data storage 208, e.g., via DMA 214, which can be an RDMA as noted herein. Brawny core 202 can have its own communication path 212 with second virtual switch 206-1.

### Discussion on Xockets Simulation Results

Traditionally, sessions are identified at the application layer and only when termination at a logical core has occurred. By this time, a software scheduler controls the fetching of session-specific data and the selection of packet threads.

Given the abilities of typical virtual switches, such as Openflow, to identify sessions, does prefetching the cache context through a hardware scheduler lead to large improvements in computational efficiencies? If the HW scheduler can accommodate embedded OpenSSL and classification hardware as well as zero-overhead context switching for this logic, is the power per byte served significantly reduced? How much parallelism can be injected by an array of wimpy cores, disintermediating the brokerage of data by x86 cores connecting content and IO subsystems (and the brokerage of metadata by the transport code connection application code and IO)? If memory can network amongst itself, can it transparently share common data to give every connected processor a much larger in-memory caching layer?

In an embodiment, using the Xockets architecture discussed below, a number of major improvements follow. These improvements, among others, include the following:

The number of random accesses increases two orders of magnitude, given the use of BL=2 memory and 16 banks as well as two memory channels shared for every dual-core ARM A9, and common large prefetch buffer.

A new switching layer is formed by using SRIOV and IOMMU to ingress and egress packets within a parallel mid-plane formed from Xockets dual in-line memory modules (DIMMs).

The effective cache size of, for example, hundreds of wimpy cores can be made an order of magnitude bigger by pre-fetching isochronously with queue management and by engineering zero-overhead context switches. By integrating the queue state with the thread state, virtual networks can integrate with virtual cores with engineered latency.

New infrastructure services can be provided transparently to x86 cores: security layers can be added, an in-memory storage network can be added, interrupts to the brawny core can be traffic managed at the session level, and every level of the memory hierarchy can automatically be prefetched after each session detection in the Xockets virtual switch.

Many applications can be accelerated over an order of magnitude using a Xockets driver for the application running on the x86's Operating System. Open Source applications like Hadoop, OpenMAMA, and Cloud Foundry can be cleanly partitioned across both sides of Xockets, tightly coupling, for example, hundreds of ARM cores to x86 processors (and coupling the full bandwidth of PCI-express 3.0 and independent memory access to the ARM cores).

The performance characteristics of a market-valuable set of applications running in a new layer of transport and computation between IO and CPU are measured via simulations. A gateway mechanism and/or virtual switch controller are assumed to manage the authentication of and mapping of users to cores externally, so that sessions can be identified by the Xockets DIMM. In rough terms with this identification, a single Xockets DIMM performs like a Xeon 5500 series processor with a 128 MB cache (or better when HW acceleration is needed as in encryption and IPS), on a 13.5 W average packet-size power budget.

The diagrams depicted below illustrate the change in architecture conferred by using one or more Xockets, according to embodiments of the present invention. Further, as would be understood by a person skilled in the relevant art based on the description herein, Xockets can be used in computing platforms with ARM and x86 processors as well as in computing platforms with other types of processors. These computing platforms with the other types of processors are within the spirit and scope of the embodiments disclosed herein.

### Reference Architecture

In an embodiment, two Xockets architectures are considered: (1) Xocket MIN for low-end public cloud servers; and, (2) Xocket MAX for enterprise and high computation density markets. When Xocket MIN 1U can be used, the minimal benefit per Watt is seen, with, for example, only 20 ARM cores embedded, according to an embodiment of the present invention. In an embodiment, when Xockets Max 2U can be used, the maximum benefit per Watt is seen as the system power is paid once for many cores: 160 when provisioned across 50% of the available DIMM slots leaving 75% of the original peak memory capacity but leaving most common memory configurations unchanged.

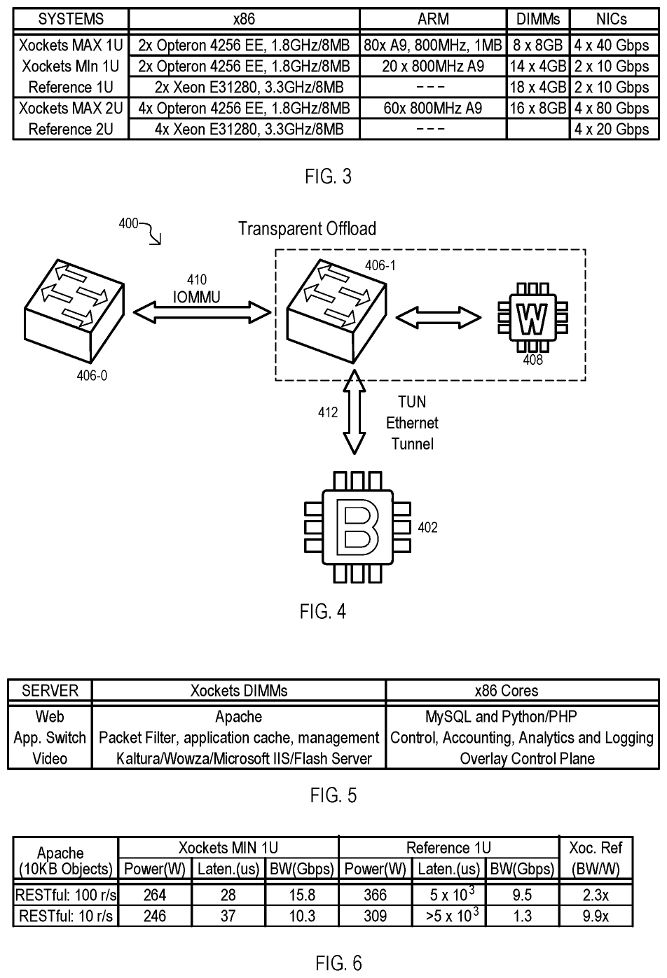

FIG. 3 is table showing examples of such reference architectures (SYSTEMS), a type of (Brawny) processor (x86), number of wimpy processors (ARM), DIMMs, and network interface cards (NICs). In FIG. 3, The most efficient Intel architecture in terms of service per watt is used as a reference, the Intel Xeon E31280 is Intel's most advanced energy efficient Xeon released in late 2011. Larger caches are needed to support the service of many concurrent users, and so 8 MB is a minimum cache (e.g., Intel's “SmartCache” dynamically allocates between instantiated virtual machines) size acceptable when accommodating a large number of sessions.

### Results

Pure x86 systems have two systematic deficits: (1) system power is amortized over a small number of processors; and (2) an idle processor still consumes >50% of its maximum power. Given the super-linear inefficiency of processors when loaded, in the following comparisons we take a conservative approach. Instead of considering one x86 processor running at 100% power, the performance of two x86 processors consuming 50% maximum power are considered but use the power cost of a single processor consuming maximum power.

### Transparent Server Offload: HTML, Application Switch, and Video Server

Server applications that are session-limited and require only lightweight processing can be served entirely on ARM cores located on Xockets DIMMs, according to an embodiment of the present invention. In particular, the complete offload of Apache, video routing overlays and a rack-level application cache (or application switch) are considered. In these scenarios, an ethernet connection is tunneled over the DDR bus to between the virtual switch the x86 processors require communication with the ARM cores.

FIG. 4 is a diagram of a transparent offload system according to an embodiment 400. A system 400 can include a first virtual switch 406-0, a brawny core 402 and an offload module 404. An offload module 404 can include a wimpy core 408 and a second virtual switch 406-1. First virtual switch 406-0 can communicate with offload module 404 via IOMMU 410. Brawny core 402 can communicate with offload module via and Ethernet tunnel 412.

The servers can be partitioned between the wimpy cores and the brawny cores. For example, the following software stacks can be deployed in Linux-Apache-MySQL-Python/PHP (LAMP), overlay routing and streaming, and logging and packet filtering. Examples of such arrangements are shown in FIG. 5. In an embodiment like that of FIG. 5, Apache and a MySQL client CAN run on one or more the Xockets DIMM, while MySQL and Python/PHP run one or more x86 cores. Ethernet, tunneled over the DDR interface, can connect the MySQL clients on each Xockets DIMM to the MySQL server on x86 cores.

The Web API type can have a significant impact on performance. Virtually all public Web APIs are RESTful, requiring only HTML processing, and on most occasions require no persistent state. In these cases, each wimpy core can serve data from local memory, and request a DMA (memory to memory or disk to memory) when data is missing through the SessionVisor. In the enterprise and private datacenter, simple object access protocol (SOAP) is dominant, and the ability to context switch with sessions is performance critical, but the variance of APIs makes estimating performance difficult.

Given the sensitivities of public clouds, two Xockets per DIMM can be used, according to an embodiment of the present invention. This scenario shows the minimal benefit from a Xockets approach in that a minimal number of DIMMs (2) are installed. Average length packets are assumed, though 40B would increase the relative performance of Xockets substantially as sessions increase.

FIG. 6 shows simulation results between an architecture according to an embodiment (Xockets MIN 1U) and a reference architecture (Reference 1U). The notations “100 r/s” and “10 r/s” refer to the number of requests per sessions for a constant number of requests per second. So, the second row refers to many more sessions initiating and disconnecting per second with fewer requests per sessions.

In an embodiment with SOAP based APIs, Xockets can further increase the performance over ordinary ARM cores by context-switching session data given the stateful nature of the service. As Xockets create a much larger effective L2 cache, the performance gains vary heavily.

In another embodiment, when equipped with many Xockets DIMMs, these systems can be placed architecturally near the top of the rack (TOR). Here they can create one or more of: a cache for data and a processing resource for rack hot content or hot code, a mid-tier between TOR switches and second-level switches, rack-level packet filtering, logging, and analytics, or various types of rack-level control plane agents. Simple passive optical mux/demux-ing can separate high bandwidth ports on the x86 system into many lower bandwidth ports as needed.

Since commodity x86 systems cannot drive such bandwidths, the Arista Application Switch is used as a reference system. The Arista Application Switch (7124FX) was recently released (April 2012) to bolster equity trading systems, in-line risk analysis, market data feed normalization, deep packet inspection and signals intelligence, transcoding, and flow processing. They have partnered with Impulse Accelerated Technologies to integrate a C-to-FPGA compiler for customer written applications. In this way, they provide a vendor-specific platform for writing custom applications on an FPGA in the packet-flow path, however no post-termination services can be provided. Instead, different transport layers can be offloaded at high speeds and low latencies within the switch. As would be understood by a person skilled in the relevant art, it is therefore difficult to make an apples-to-apples comparison, as the use cases for the Xockets system is much higher. Therefore, only flow-level context switching and processing are considered, where 2000 cycles or work, for example, are required. Also, adding an application cache like Apache terminating viral content is considered, offloading servers in their entirety. Given that routers and switches account for less than 15% of data-center electricity and that both switches would ostensibly be controlled by Openflow, the figure of merit is bandwidth per dollar.

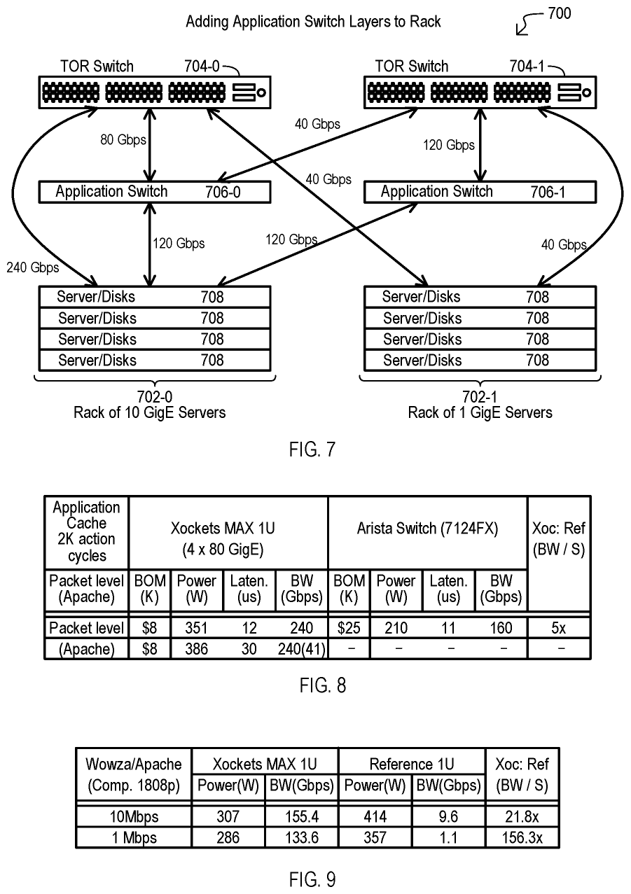

FIG. 7 is a diagram of system 700 with application switches according to an embodiment. A system 700 can include a first rack of servers (706-0, rack of 10 GigE servers) and a second rack of servers (706-0, rack of 1 GigE servers). Each rack 702-0/1 can have a TOR switch 704-0/1, application switch 706-0/1 and servers/disks 708. A speed of data transfer speeds between various components of the system are shown in gigabits per second (Gbps). An application switch 706-0/1 can take the form of Xockets systems as described herein.

FIG. 8 is table comparing application switch performance between a system with a Xockets based application switch (Xockets MAX 1U) and an Arista Switch 7124FX as an application cache.

A BOM cost of Arista is estimated based on the components used. The assumptions used are 2000 cycles of work take the C-to-FPGA compiler 10 μs to process, that average length packets are used, and that 20 requests per session of 10 KB objects. The Xockets architecture commands an intrinsic 5× bandwidth/BOM$ benefit by using the commodity x86 platform, according to an embodiment of the present invention.

In the above simulations, 99% of the data being served is assumed to fit on one or more 8 GB Xockets DIMMs. In another case, video and routing overlays, this is not the case. However, the data contents of the DIMM can be prefetched before they are needed. In this case, real-time transport protocol transfers (RTP) can be processed before packets enter traffic management, and their corresponding video data can be pre-fetched to match the streaming. This interlocking of video service with data streams can include a Video Xockets software package, according to an embodiment of the present invention. So, the gateway mechanism setting up video sessions also provisions the pre-fetch. Simulations assume 5% overlap in video data requests by independent streams and show that enough prefetch bandwidth exists. Prefetches can be physically issued as (R)DMAs to other (remote) local DIMMs/SSDs as described below. For enterprise applications the number of the videos are limited and can be kept in local Xockets memory anyway, according to an embodiment of the present invention. For public cloud/content delivery network (CDN) applications, this can allow a rack to provide a shared memory space for the corpus of videos. A profiling of Wowza (streaming engine) informs the Apache performance.

FIG. 9 is a table comparing video overlay/routing between a Xockets system (Xockets MAX 1U) and a reference system (Reference 1U) as described herein. The corpus of videos is limited to be in-memory, not necessarily on the Xockets DIMMs. The BW number for the reference system for 10K streams is estimated from the performance of Apache, but for 1K sessions the number is from Wowza testing. The prefetching may be set up from any memory DIMM on any machine. Prefetching can be balanced against peer-to-peer distribution protocols (e.g., provider portal for peer-to-peer (P2P) applications, P4P) so that blocks of data can be efficiently sourced from all relevant servers. The bandwidth metric indicates how many streams can be sustained when using 10 Mbps (1 Mbps) streams. As the stream bandwidth goes down the number of streams goes up and the same session limitation becomes manifest in the RTP processing of the server. In an embodiment, the Xockets architecture allows, for example, over 10,000 high definition streams to be sustained in a 1U form factor.

### Rack-Level Computer: Memory-Networked Disk and Hadoop Xockets

Business analytics technologies face a new obstacle to real-time processing and fast queries. Traditional structured SQL queries must now be combined with a growing set of unstructured Big Data queries. Business analytics companies (e.g., SAP and Oracle) rely on in-memory processing for speed as well as a storage area network (SAN) like architecture (e.g., SAP's HANA platform and Oracle's Exalytics platform) for availability. This is the architectural opposite of BigData platforms that use shared-nothing, commodity architectures and lack any high-availability shared storage.

In an embodiment, using Xockets DIMMs, the advantages of both architectures, supporting structure and unstructured queries, can be simultaneously realized. An additional benefit, among others, with a Xockets architecture is the acceleration of Map-Reduce algorithms by an order of magnitude, making them suitable for business analytics. The mid-plane defined by Xockets DIMMs can drive and receive the entire PCI-e 3.0 bandwidth (e.g., 240 Gbps) connecting Map steps with Reduce steps within a rack and outside of the rack. The addition of 160 ARM cores offloads the Collector and Merge sub-steps of Map and reduce. This mechanism is detailed in the following figures.

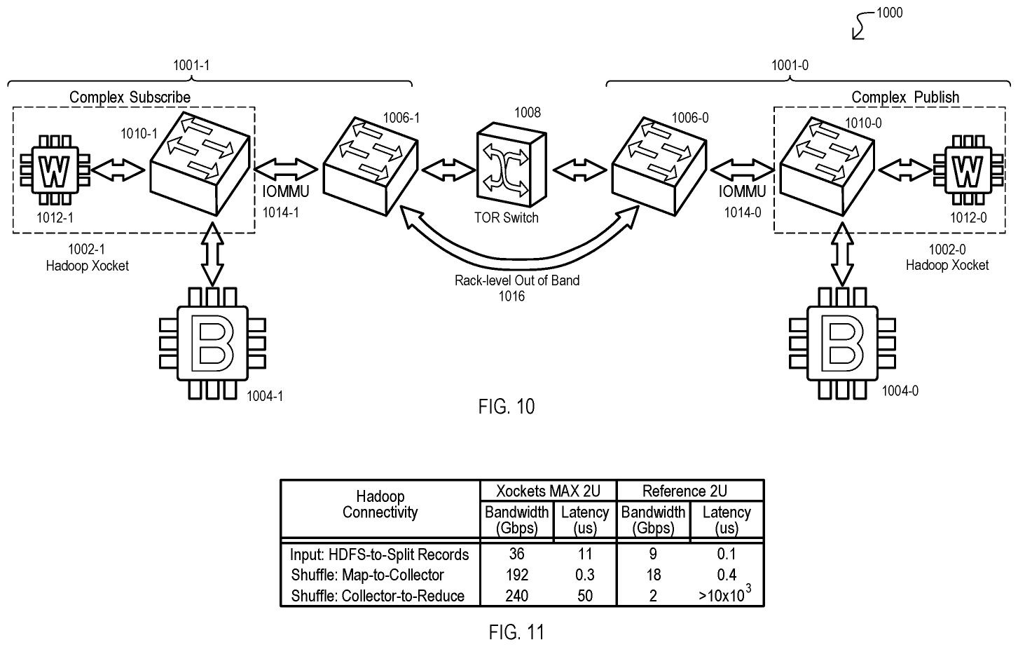

FIG. 10 shows a system 1000 that can include a first server (e.g., rack unit) 1001-0 and second server 1001-1 connected to a TOR switch 1008 and connected to each other via a rack-level out of band communication path 1016. Each server 1001-0/1 can include a first virtual switch 1006-0/1, brawny core 1004-0 and offload processor 1002-0/1. Each offload processor 1002-0/1 can include a second virtual switch 1010-0/1 and wimpy core 1012-0/1. Offload processors 1002-0/1 can connect with corresponding first virtual switches 1008-0/1 with IOMMU 1014-0/1. One offload processor 1002-0 can perform a complex publish in a publish subscribe map reduce model/architecture (e.g., Hadoop). Another offload processor 1002-1 can perform a complex subscribe in a publish subscribe map reduce model/architecture.

Hadoop is built with rack-level locality in mind, and so communication between servers directly (out-of-band from the TOR switch) through the intelligent virtual switching of the Xockets DIMMs, can tightly connect all the processing within a rack. If even further bandwidth is needed, LZO compression can be placed transparently in-line in the Xockets DIMM, according to an embodiment of the present invention. The specifications below are calculated, or referenced, in FIG. 11, but not Xockets simulated due to the complexities of rack-level simulation.

Hadoop problems are typically classified as CPU or IO bound after a thorough tuning of Hadoop parameters, not the least of which is the number of “Reducers” and the number of “Mappers” per node. Because the shuffle step is often the bottleneck, the number of reducers is kept to a minimum so that CPUs are not overwhelmed with having to filter keys. With the Xockets traffic-managed approach, the number of Reducers can rival the number of Mappers, according to an embodiment of the present invention. By using RDMAs to avoid writing Map outputs to disk (due to the latency of transferring data from Map to Reduce steps), many Hadoop programs speed up by 100%, while simultaneously reducing the CPU load by 36%. FIG. 10 evolves that concept to another level by having the memory actively publish and subscribe its data from any location it has been stored. These architectured means of pipelining Map-Reduce can change the bound of the problem, the tuning, and the performance.

Hadoop queries are estimated to run between 5.4× to 12× faster depending on the Hadoop problem. Details of this estimate are discussed below.

In an embodiment, separately and simultaneously, Xockets can provide an available, high-performance, and virtual shared disk for structured queries. Traditionally, disk storage is physically accessed following a kernel miss, searching its page cache for requested data. Subsequently, a page frame (or “view” in Windows) of data is requested from disk into a newly allocated entry in the page cache. The requesting process either memory maps (mmap) that file with pointers in its heap to the page cache or duplicates it outright into the processes buffer. The latter being inefficient for mostly read-only data. In an embodiment, Xockets exploits the memory-mapped file paradigm to create rack-level disks.

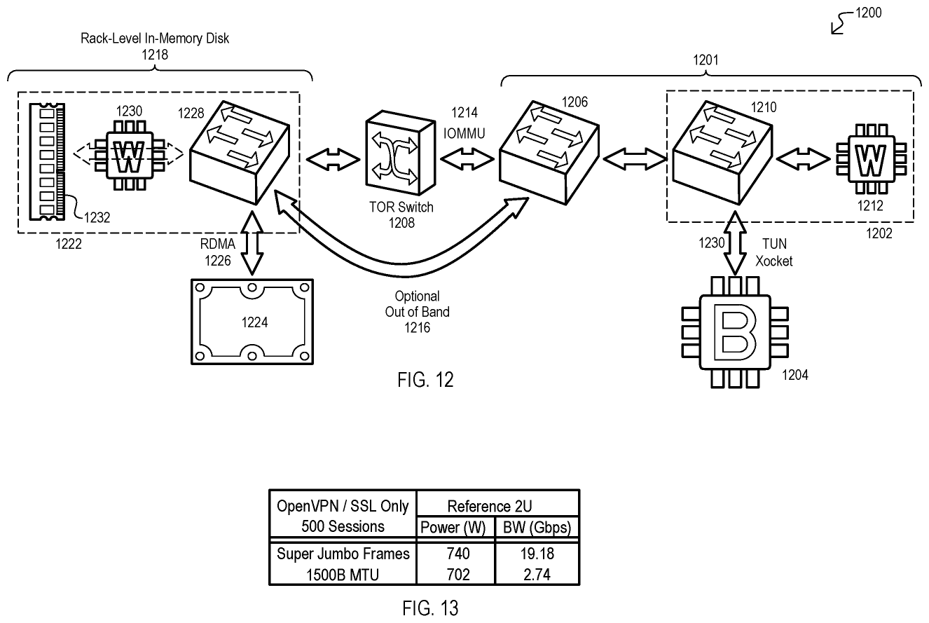

FIG. 12 shows a system 1200 that can include a server 1201 and rack-level in-memory disk 1218 connected to a TOR switch 1208 and, optionally, connected to each other via an out of band communication path 1216. Server 1201 can include a first virtual switch 1206, a brawny core 1204 and offload processor 1202. Offload processor 1202 can include a second virtual switch 1210 and wimpy core 1212. Offload processors 1202 can connect with first virtual switch 1206 with IOMMU 1214. In-memory disk 1218 can include a memory offload processor 1222 and external storage 1224. Memory offload processor 1222 can include a virtual switch 1228, wimpy core 1230 and local memory 1232.

Illustrated in the FIG. 12, Xockets can effectively unify all of the contents on the Xockets DIMMs on the rack to every x86 processor socket (e.g., brawny core). Additional DIMMs (e.g., 1232) and SSDs (e.g., 1224) can be integrated efficiently with RDMA capable NICs. This is done seamlessly by exploiting the mmap abstraction (built into every major operating system) to address the local Xockets DIMM upon requesting a certain address range, according to an embodiment of the present invention. The mmap routine can trap and execute the code of the Xockets driver, which in turn can issue the correct set of write and read commands to Xockets Memory 1222 to produce and return the sought after data, to the requesting user process.

This architecture can extend to include transparent de-duplication for availability, and proprietary synchronization techniques for moving data to places of locality. High-end Open Source file systems such as GPFS, Lustre, or even HBase, which offer fantastic data availability and performance, can be layered on top of the abstraction. In this way, the Xockets DIMM can allow quick access to all the other stores on the rack that may contain the sought after data. DIMMs operate at 64 Gbps, and so they are primed for sharing across a rack more than any other storage medium. Hive (i.e., a general-purpose soft processor core) can be placed on each ARM processor to federate querying across several processors through the rack.

A rack-level 2-4 TB shared in-memory disk can be created with a maximum 11-16 μs random access time. A rack hosting 3600 ARM cores can query across this disk using SQL at speeds orders of magnitude faster than a single server.

Because the utility of a shared cache increases with a greater number of users, at the rack-level the concept of page-sharing provides incredible statistical-gain. Excess memory on one server can serve as backup storage for least-recently used main memory pages. Xockets can target the ability to share pages across a rack, according to an embodiment of the present invention.

### Hierarchical Transport: IDS/IPS and VPN as a Virtual Switch Service

A reason enterprises do not make better use of the cloud is security. Cloud-bursting and server cloning dramatically increase exposure to identity theft, denial of service, and loss of sensitive data (e.g. see http://www.cloudpassage.com/resources/firewall.html?iframe=true&width=600&height=400). Additionally, intrusion prevention security (IPS) and virtual private network VPN are notorious for getting in each other's way, often preventing simultaneous deployment. IPS requires the assembly of data for signature detection before traffic is allowed access to the server, but VPNs mandate decryption on the server to produce the actual data for signature detection. The traditional way out of this conundrum is to integrate VPNs with IDS on a single appliance like Palo Alto Networks' offering, but such heterogeneous appliances are difficult to include in a cloud data center (public or private). For this reason, public clouds like Amazon only allow use of Internet Protocol Security (IPSec) services between the enterprise router and their gateway, but not to their logical core.

Grossly, there are two types of VPNs: (1) packet-layer tunnels, like IPSec, that operate strictly within the confines of networking protocols and can be made transparent to the endpoints; and (2) socket-layer tunnels, like secure socket layer (SSL)/transport layer security (TLS), that operate at the socket layer. Usually, the former is set up between specialized enterprise equipment like firewalls, or a remote client's personal system, and a datacenter's gateway, which houses the server. Usually, the latter tunnels through the former from end-point systems, to provide the client a session-level VPN service as is needed for Secure Web, Secure Media, Secure File, etc. The latter, relevant to servers, works by setting up independent SSL/TLS encryptions streams for the meta-data control and data exchanged, to handshake ciphers and possible certificates.

Traditionally, socket layer tunnels require execution in application space, but use a driver in kernel space. Therefore, as packets get smaller this transfer back and forth between the two spaces (detailed below) dominates the processor efficiency. Speed-testing of OpenVPN extrapolates to the results shown in FIG. 13. The number of sessions is estimated to be 125 for each of the sockets, with Super Jumbo Frames being approximately 60 KB each.

Even if application-level VPNs are tractable at high bandwidths, the aforementioned problem of simultaneous Intrusion Prevention Systems (IPS) is a significant complication. This “catch-22” has given rise to inefficient “cloud-in-cloud” hacks like CloudPassage to create an artificial transport hierarchy. These services move the trusted perimeter to yet another multi-tenant cloud systems and with the same security risks.

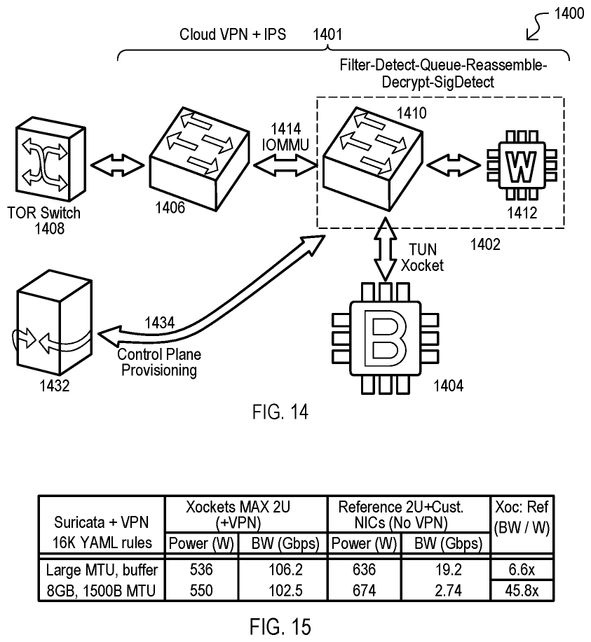

In an embodiment, a Xockets VPN approach can solve this problem in one of two ways depending on the deployment: either reuse existing Open Source technology such as OpenVPN; or provide a VPN application in the management layer or Flowvisor (porting OpenVPN to Openflow). The Openflow virtual switch has been shown to work on VMware's ESX, as well as Hyper-V and XenServer where it is already the default virtual switch. Additionally, IPS can be inserted here before a virtual machine receives any data. This separate control plane provisioning is illustrated in FIG. 14.

FIG. 14 shows a system 1400 that can include a server 1401 connected to a TOR switch 1408 and a control server 1432. A server 1401 can provide cloud VPN and IPS services. Server 1401 can include a first virtual switch 1406, a brawny core 1404 and offload processor 1402. Offload processor 1402 can include a second virtual switch 1410 and wimpy core 1412. Offload processor 1402 can receive control plane provisioning from a control server 1432. Offload processor 1402 can connect with first virtual switch 1406 with IOMMU 1414.

With this approach, the Xockets VPN/IPS firmware can coordinate the acceleration of signature detection with encryption/decryption of communicated data, according to an embodiment of the present invention. Then, a trusted perimeter exists only between communicating machines, and IPS can actually prevent malicious data from ever reaching the target machines. Because AES (e.g., encryption) cores can be implemented in the FPGAs included in the offload processor, because Xockets commodity classifications techniques can accelerate signature detections, and because all connections are traffic managed, Xockets DIMMs perform as ground-breaking performance, next-generation firewall repeaters. Embodiments can terminate traffic, provide transparent services, and then virtually inject the traffic back to the intended target. The details of this simulation are discussed below.

FIG. 15 is a table showing security simulation results bandwidth per watt for a threat detection software (Suricata) with a VPN, where threat detection is based on 16K YAML rules. Results for a large maximum transfer unit (MTU) and 1500B MTU are shown. FIG. 15 compares a Xockets system (Xockets MAX 2U) to a reference system (Reference 2U+Cust. NICs (No VPN)).

### Discussion on Xockets Simulation Elements

### Simulation System

Packet traffic ingressing and egressing from a network interface card (NIC) through a Xockets service path (or Xockets switch path), that may include x86 processing time are simulated.

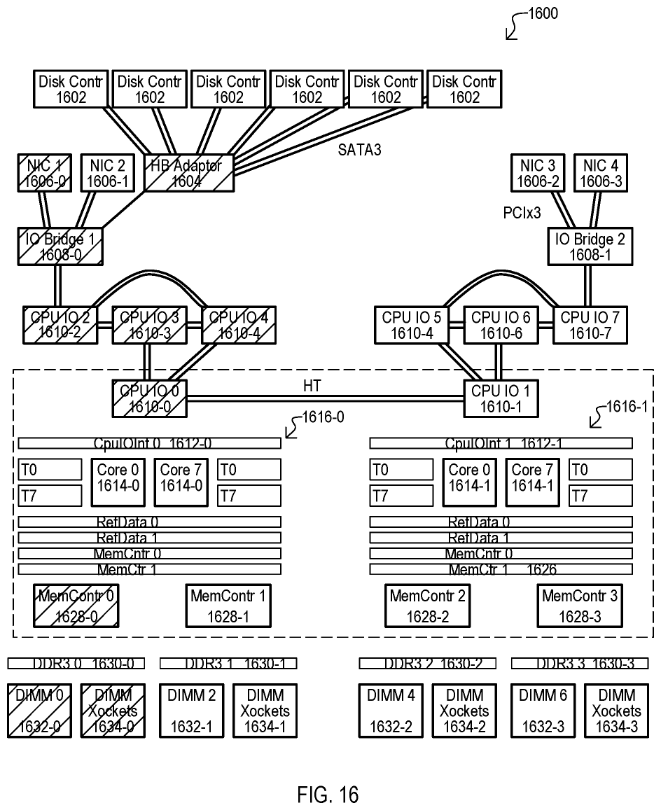

FIG. 16 shows a system 1600 having sections that can be simulated. A system 1600 can include two CPUs includes disk controllers 1602, which may include a SATA3 interface connected to a host bus (HB) adaptor 1604. NICs 1606-0/1 and HB adaptor 1604 can be connected to IO bridge 1608-0. IO Bridge 1608-0 can be connected to CPU IO 1610-2. CPU IOs 1610-2/3/4 can be connected to CPU IO 1610, which can communicate with a first CPU 1616-0 via CPU IO interface 1612-0. First CPU 1616-0 can include cores 1614 and related circuits and can include memory controllers 1628-0/1. Memory controller 1628-0 can be connected to a DDR3 interface 1630 which can access a DIMM 1632-0 and Xockets DIMM 1634-0. A CPU IO 1610-0 can communicate with CPU IO 1610-1 to enable hyperthreading. A second CPU 1616-1 can be connected to memory and IO devices in the same fashion as first CPU 1616-0, but not include a HB adaptor.

In this section, the hardware components that compose the simulation and how they are simulated are discussed. By simulating one Xockets DIMM, it is assumed that we can effectively extrapolate the simulation of the entire system with single root I/O virtualization (SRIOV) arbitrating between Xockets without deprecation of performance. The NIC-based virtual switch arbitrates between the Xocket DIMMs, while the Xocket DIMMs have a second large virtual switch that arbitrates between sessions (or switches packets without service), according to an embodiment of the present invention. The blocks included in the simulation are hatched in FIG. 16. The simulation is coded in Python using the Open source Discrete-time simulation framework, SimPy.

Based on the description herein, a person skilled in the relevant art will recognize that other hardware components can be used for the Xockets DIMM. These other hardware components are within the spirit and scope of the embodiments described herein.

### 2. DIMM Xockets Simulation Elements

In an embodiment, the Xocket DIMM is composed of the lowest-power, lowest-cost parts in their class. The lowest end reduce latency (RLDRAM3) component is placed in four instances connected to four computational FPGAs. The four FPGAs are connecting to a fifth arbitrating FPGA. These are the lowest end Zynq-based parts (save the 7010), or the equivalent Altera part may be used.

The layout maximizes the memory resource available while not violating the number of pins.

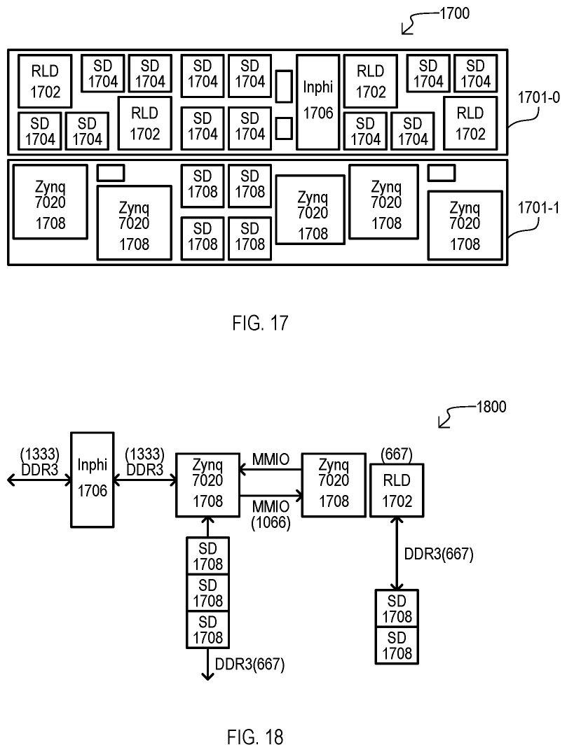

FIG. 17 is a diagram of a Xockets DIMM, showing a first side 1701-0 and a second side 1701-1. The sides 1701-0/1 include RLDRAM (RLD) 1702, synchronous DRAM (SD) 1704, a memory buffer 1706 and FPGAs 1708.

Voltage conversion is required for the IO connecting the RLDRAM with the FPGAs (e.g., Zynq). This is assumed to be a down-conversion, for example, from 3.3V to 2.5V sourced from the Serial Presence Detect (SPD) Voltages. The connectivity of the other parts is given in FIG. 18. FIG. 18 shows various connection types between components of a Xockets DIMM 1800 (DDR3, MMIO) as well as speeds of such connections (1333 MHz, 667 MHz, 1066 MHz).

The arbiter (i.e., arbitrating FPGA) can provide a memory cache for the computational FPGAs and for effective Peer-2-Peer sharing of data though formalisms like memcached or ZeroMQ, or the Xockets driver for applications like video. The arbiter can be controlled by the ARM processors and may perform on-demand, local data manipulation such as transcoding. Traffic departing for the computational FPGAs can be controlled through memory-mapped IO. The arbiter queues session data for use by each flow processor. Upon the computational FPGA asking for address outside of the session provided, the arbiter can be a first level of retrieval, processed externally, and new predictors set.

### 3. Power Analysis

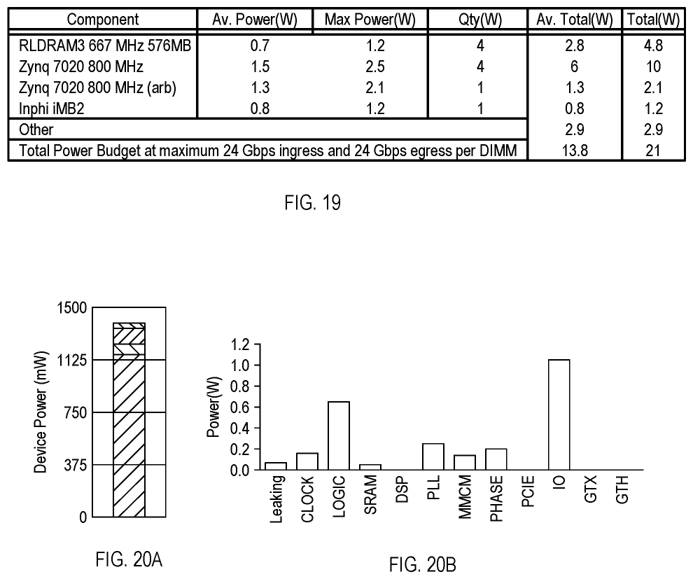

In an embodiment, the power budget is 21 W worst case and 14 W average. But by limiting the packets processed per second, any worst case power profile can be achieved between the average total and the total power. This budget is composed as shown in FIG. 19.

The worst case Xockets power is used when all packets are at 40B and all require serving, classification acceleration, as well as encryption and decryption, and using all 128K queues available for scheduling, according to an embodiment of the present invention. The worst case power loads are used for every case in the summary, even though power will scale commensurately with the average packet load. Given the speed, data input bus width, termination, and IO voltages, as well as the worst case read and write profiles of this design, the worst case power of the RLDRAM3 with 18DQs, −125 speed grade is shown in FIG. 20A.

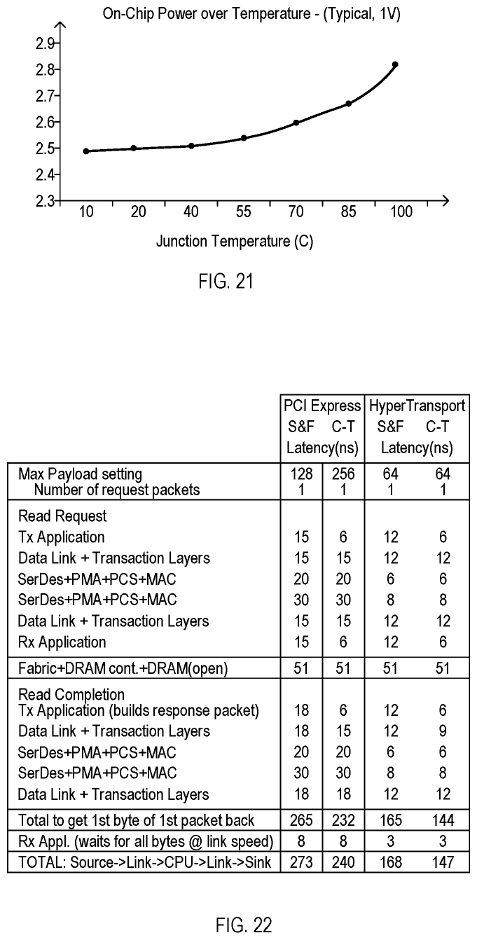

The Computational FPGA can consume similar power on average, but more in the worst case. Given the logic, interfaces and activity, the worst case power of the Computational FPGA given typical temperature is given in FIG. 20B. If the airflow on the DIMM drops and the temperature increases, the FPGA still has enough margin before resistance severely affects power. This is shown in FIG. 21.

In total, on a Xockets DIMM, these power numbers are approximately twice as large as a traditional set of DDR3 components, but these levels are reached by DDR2 devices. The DIMM pins are more than sufficient to power the device given 22 VDD pins per DIMM (and additional 3.3V VSPD pins that easily down-convert for miscellaneous 2.5V IOs). Even in the worst case, there is less than 1A per pin. In order to catalyze heat movement, a conductive spreader can be attached to both sides of the Xockets DIMM. Digital thermometers can also be implemented and used to dynamically reduce the performance of the device to reduce heating and power dissipation if needed.

Because the majority of power is IO based, on the Xockets DIMM, when average packet sizes are used of˜1 KB, a very low average power budget is obtained.

### 4. Interface Timing

To simulate the latencies of PCI-express and HyperTransport, the numbers directly from the HyperTransport Consortium (provided in FIG. 22) are used. The numbers correspond to Store-and-Forward (S&F) and Cut-Through (C-T) as labeled.

The bandwidths for PCI-e 3.0 and HyperTransport 3.1 are used. The overhead metadata for HyperTransport only requires 4 bytes, while PCI-express uses 12 or 16 bytes.

### 5. Network Interface and Stimulus and Application Load

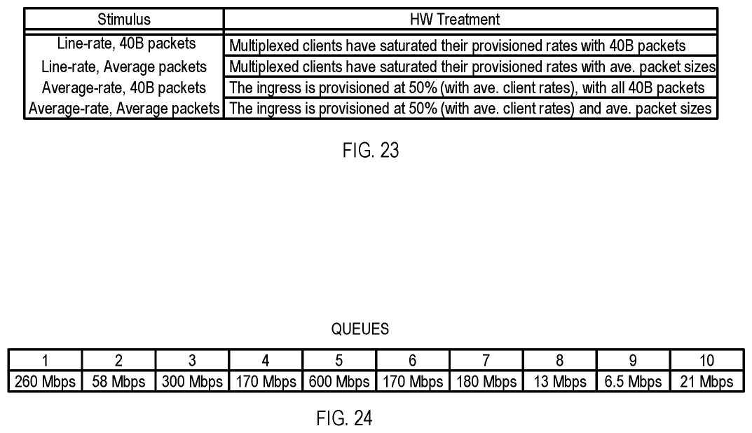

We use a standard set of network loads (packet sizes and rates) to stimulate and stress the hardware. This is shown in FIG. 23.

To parameterize packet inter-arrival times and bursting, 200 terminating client connections per Xockets DIMM and several thousand switched flows per DIMM are assumed.

Assuming each DIMM services 24 Gbps, each computational FPGA is responsible for servicing 6 Gbps and 50 terminated sessions. This is possible if the computational workload is light and resembles network processing more than application processing. In an embodiment, this is a design objective of a Xocket: keep easily parallelized workloads that require large random accesses off x86 processors and provide a socket connection to the results.

For the various stimuli, both large variations in consumption are assumed: 40 Mbps down to 128 Kbps, as well as uniform traffic across the clients. Again, the majority of connections are locally, intelligently switched using Openflow, while the minority are classified into queues for local termination and service.

All results are calculated with the above 200 terminating client connections per DIMM; however for purposes of visualization and simplicity, the number of queues is kept at 10 in the simulated charts below. The random provisioning shown in FIG. 24 is used for the charted simulations (keeping two digits of significance).

The queue arrangement of FIG. 24 keeps the line roughly a third provisioned, as is done in practice. The rate limiting allows bursting to consume buffer space, but not bandwidth. Certain queues will drive packets above their provisioned rates like queue 5, while queue 1 will stay in profile in the average case. When the inter-packet delays go to zero, all the queues go to out-of-profile for this configuration.

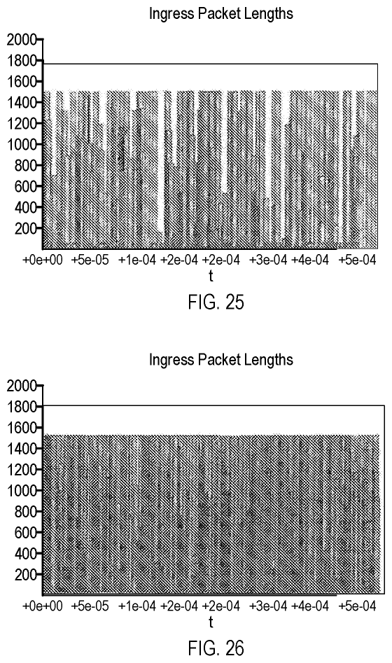

Charted simulations are shown in FIGS. 25 and 26. Bars indicate a packet arriving at the centered time, of the given length (as so consuming the time division necessary to transport that packet at such time). The chart on the last in the table above with an average distributed inter-arrival time and packet length. The chart on the right in line-rate, average packets.

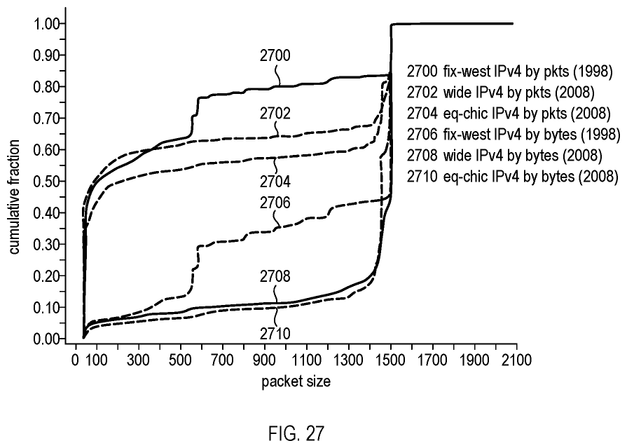

The packet size profiles are very bimodal between ACKs (40B packets) and MTUs (1500 packets) with a smooth exponential switch between the two, to directly reflect the research at http://www.caida.org, which is shown in FIG. 27:

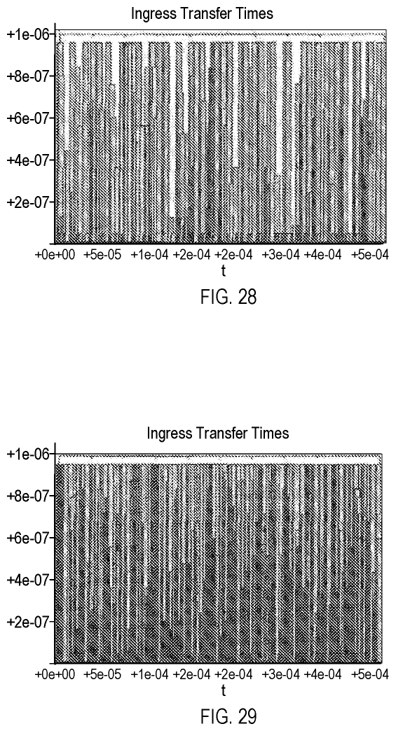

In an embodiment, after the packet is classified with Xockets virtual switch (where approximately 2000 cycles of processing are assumed, which is detailed below) and any packet level services delivered, the entire packet enters the queue. The data gets reassembled along with possible metadata generated by aforementioned services (such as Suricata detection filter subset). This data transfer requires a certain amount of time accommodated by the 800 MHz AMBA/AXI switch plane offered by the ARM architecture. Each of these packets gets quantized to a cell size (64B), and so the transfer time increases (with a worst case of 65B packets+metadata). Simulated data transfer times are shown in FIGS. 28 and 29.

### 6. Zero-Overhead Context Switching, Memory Compression and CPI

An ingredient to decreasing the latency of services and engineering computational availability is hardware context switching synchronized with network queuing. In this way, there is a one to one mapping between threads and queues

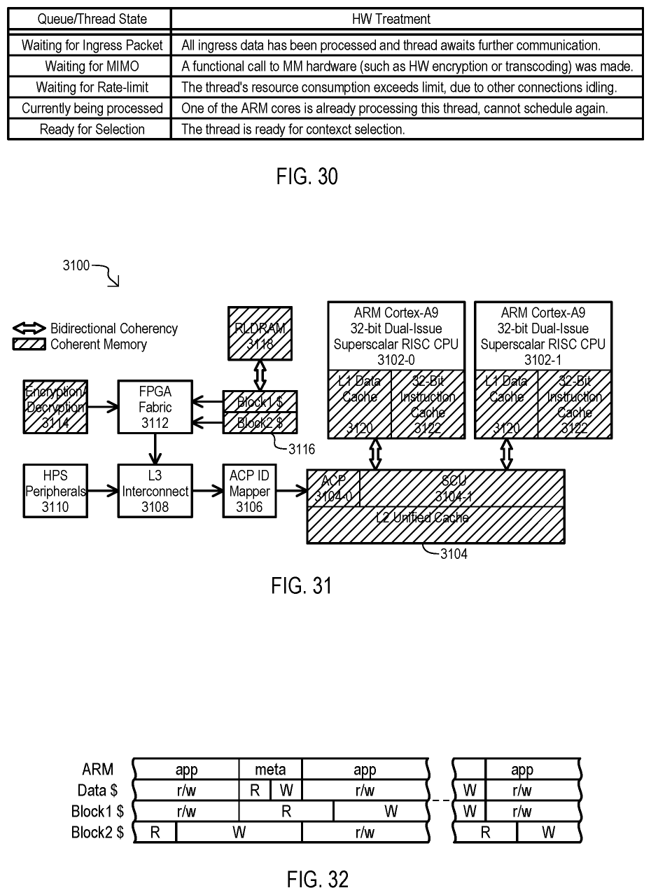

The states shown in FIG. 30 can exist in the scheduling of queues/threads to processors and memory-mapped hardware resources.

The states shown in FIG. 30 help coordinate the complex synchronization between processes, network traffic, and memory-mapped hardware. When a queue is selected by a traffic manager, a pipeline coordinates swapping in his L2 cache occurs, transferring the reassembled IO data into the memory space of the executing process. In certain cases, no packets are pending in the queue, but computation is still pending to service previous packets. Once this process makes a memory reference outside of the data swapped, the scheduler will require queued data from the NIC to continue scheduling the thread. To provide fair queuing to a process not having data, the maximum context size is assumed as data processed. In this way, a queue must be provisioned as the greater of computational resource and network bandwidth resource, each as a ratio of an 800 MHz A9 and 3 Gbps of bandwidth. Given the lopsidedness of this ratio, the ARM core is only worthwhile for computation having many parallel sessions (such that the hardware's prefetching of session-specific data and TCP/reassembly offloads a large portion of the CPU load) and requiring minimal general purpose processing of data. A video server like Kaltura, easily fits such a load and will max out the bandwidth when HD-streams are considered. Otherwise, the CPU will max out as shown in initial results section.

Zero-overhead context switching can be accomplished in embodiments because, per packet processing has minimum state associated with it, and represents inherent engineered parallelism, and minimal memory access is needed, aside from packet buffering. On the other hand, after packet reconstruction, the entire memory state of the session is possibly accessed, and so requires maximal memory utility. By using the time of packet-level processing to prefetch the next hardware scheduled application-level service context in two different processing passes, the memory can always be available for prefetching. Additionally, the FPGA can hold a supplemental “ping-pong” cache that is read and written with every context switch, while the other is in use.

To accomplish this, the ARM A9 architecture is equipped with a Snoop Control Unit (SCU) as illustrated in the FIG. 31. This unit allows one to read out and write in memory coherently. Additionally, the Accelerator Coherency Port (ACP) allows for coherent supplementation of the cache throughout the FPGA.

FIG. 31 shows a system 3100 that can be included in embodiments. A system 3100 can have CPUs (two shown as 3102-0/1). L2 cache subsystem 3104, ACP mapper 3106, L3 interconnect, hard processor system (HPS) peripherals 3110, FPGA fabric 3112, encryption/decryption circuits 3114, ping-pong cache supplement 3116 and RLDRAM 3118. In the example shown, CPUs 3102-0/1 can include ARM Cortex-A9 RISC CPUs having a data cache 3120 and instruction cache 3122. L2 cache subsystems can include an ACP 3104-0 and SCU 3104-1. Coherent memory is shown by hashing, as well as bi-directional coherency between memory elements.

In the FIG. 31, the RLDRAM 3118 can provides auxiliary bandwidth to read and write the ping-pong cache supplement 3116: Block!$ and Block2$, and the original SDRAM in the system (not shown) can provide similar operations during packet-level meta-data processing. Only locally terminating queues can prompt context switching.

Metadata transport code can relieve the CPU 3102-0/1 from fragmentation and reassembly, and checksum and other metadata services (e.g., accounting, IPSec, SSL, Overlay, etc.). IO data can stream in and out, filling L1 and other memory during the packet processing. The timing of these processes is illustrated in FIG. 32 and includes random reads and writes (r/w) as well as reading out a cache (R) and writing in a cache (W) to facilitate context switches.

During a context switch, the lock-down portion of the translation lookaside buffer (TLB) is rewritten with the addresses. The following four commands can be executed for the current memory space. This a small 32 cycle overhead to bear. Other TLB entries are used by the HW stochastically.
MRC p15, 0, r0, c10, c0, 0; read the lockdown register
BIC r0, r0, #1; clear preserve bit
MCR p15, 0, r0, c10, c0, 0; write to the lockdown register
; write to the old value to the memory mapped Block RAM

All of the bandwidths and capacities of the memories can be precisely allocated to support context switching as well as Openflow processing, billing, accounting, and header filtering programs. This can be verified in the simulation inspecting the scheduling decisions of the queue manager, as processes require MMIO resources.

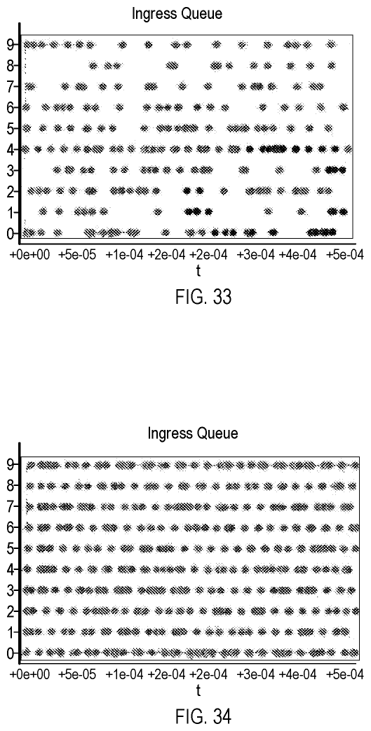

FIGS. 33 and 34 indicate the timing of packets arriving at the ingress and their associated queue for both cases. It can be observed how the traffic manager selects the queue (several selections of the same queue sequentially appear as a dark line given the short time resolution).

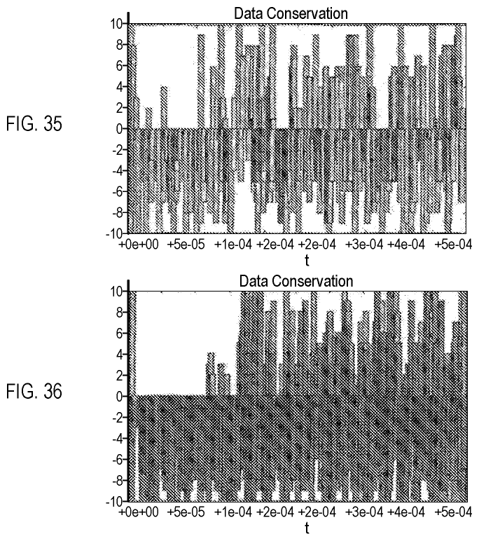

FIGS. 35 and 36 following charts place a negative bar for incoming packets, whose height is the queue number as they enter the traffic manager. Queue selections are shown on the top. Note that bars do not indicate the size of the data.

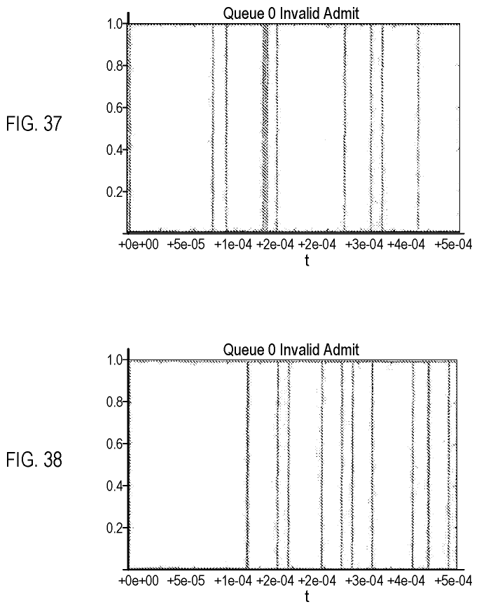

FIGS. 37 and 38 are charts showing rate-limiting in effect as queues temporally exceed their profile. In the over-use case of FIG. 38, after each queue is served, they are immediately out of profile and must wait for their next service. Traffic management synchronization follows shortly after, but “invalid admission” remains high for larger durations.

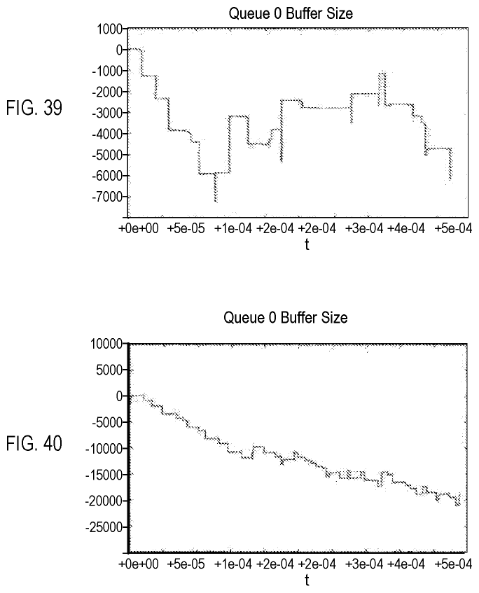

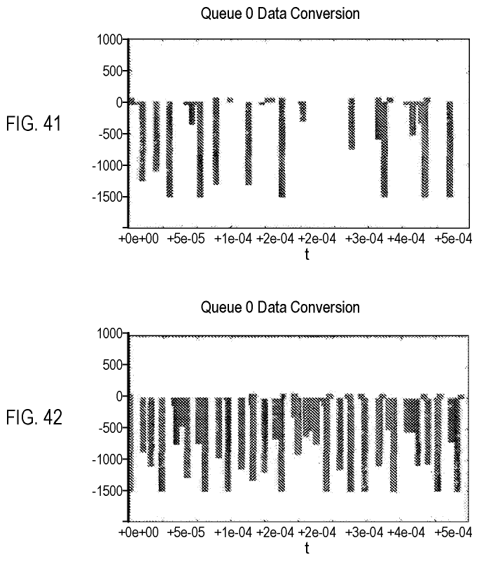

In FIG. 39, in-profile queue/thread is dynamically stable requiring a very small amount of buffering, preventing tail drops. However, for FIG. 40, when the utilization goes way above profile to 599 Mbps, the buffer size rapidly grows, until tail dropping is necessary. This isolates the misbehaving flow and can prevent any other flow or their allocated buffer from being affected. The bar charts of FIGS. 41 and 42 mark the points of service by the ARM processor by a series of 64B cell transfers. Given the timescale of these transfers, versus packet inter-arrival times, they are not resolved individually and look like darker lines

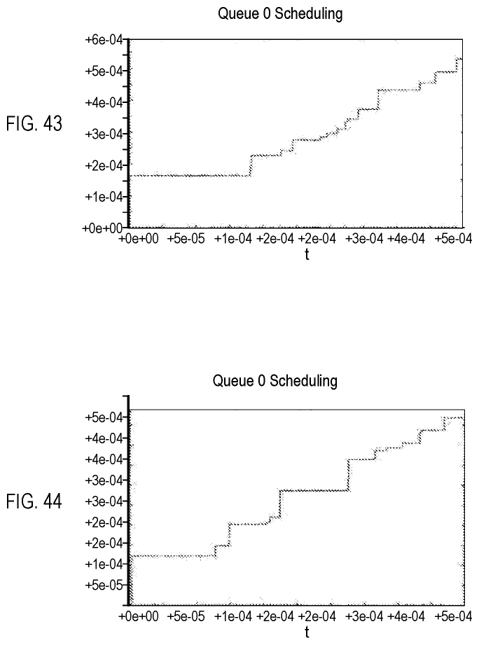

The application considered in the simulations herein includes memory-mapped hardware (HW) acceleration (OpenVPN+SNORT). As such, a given queue is often invalid as their payload is decrypted after reassembly by mapping the OpenSSL library as described in the next section. In total, this leads to the scheduling shown in FIGS. 43 and 44.

If a diagonal line (slope=1) is drawn on these diagrams, we can see how often a particular queue is out-of-profile (rate-limited) due to the granularity of packets. FIG. 44 shows this is more often the case than FIG. 43, but the moving average is well constrained to obey the rate-limiting.

### 7. Using Memory-Mapped IO for SSL and Signature Detection Acceleration

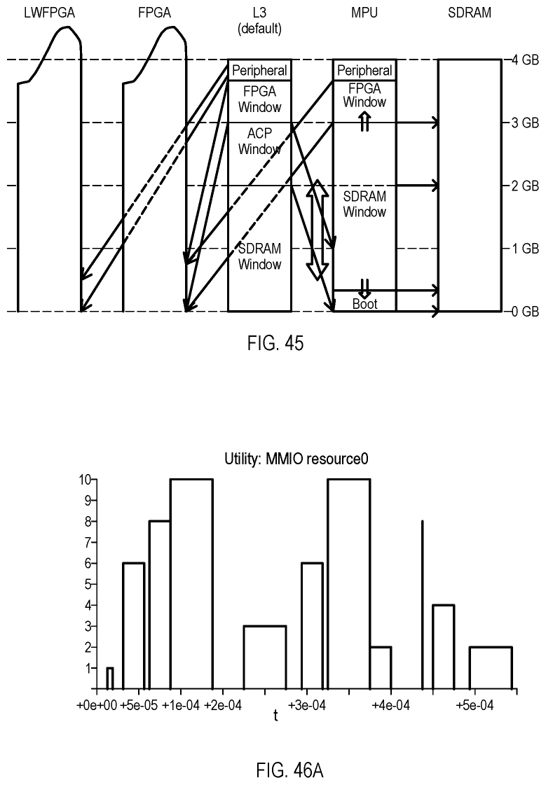

In order to use the ACP, not just for cache supplementation, but hardware functionality supplementation, the memory space allocation is exploited. An operand is written to memory and the new function called, through customizing specific Open Source libraries, so putting the thread to sleep and the hardware scheduler validates it for scheduling again once the results are ready. For example, OpenVPN uses the OpenSSL library, where the encrypt/decrypt functions can turn memory mapped. Large blocks are then exported without delay, or consuming the L2 cache, using the ACP. Hence, a minimum number of calls are needed within the processing window of a context switch. FIG. 45 shows the name space dedicated for these interactions—note the addressing is 64-bit, though the ARM is currently 32-bit. This is also applicable to an ARM that is 64-bit.

The architecture readily supports memory-mapped HW while live in case resource allocation run on the FPGA: Pinning a memory region prohibits the pager from stealing pages from the pages backing the pinned memory region. Memory regions defined in either system space or user space may be pinned. After a memory region is pinned, accessing that region does not result in a page fault until the region is subsequently unpinned. While a portion of the kernel remains pinned, many regions are pageable and are only pinned while being accessed.

Even when run upon the low-price Xilinx Artix FPGAs, 131 slices will provide approximately 2 Gbps of encryption/decryption bandwidth. Encryption and decryption resources can be arrayed as a set of six per computational FPGA.

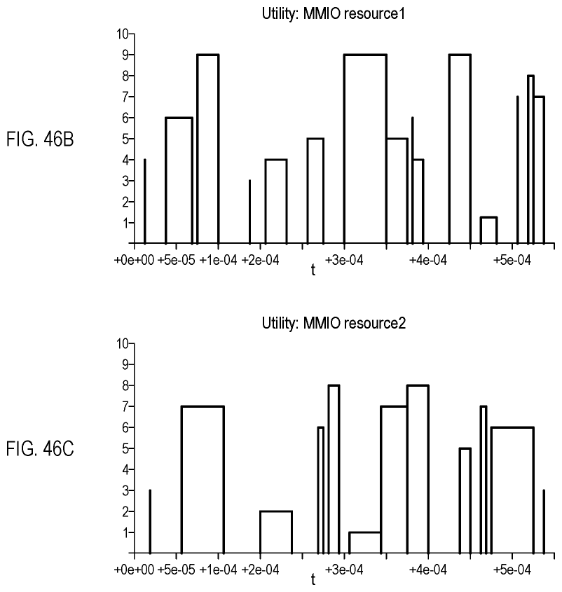

The decryption resource utilization for the three resources dedicated to the ingress is shown in FIGS. 46A to 46C under the same conditions as above. The y-axis indicates which of the 10 queues/threads is utilizing one of three encryption blocks, and the x-axis indicates the duration of use. Because decryption happens at the application layer, after TCP reassembly, resource utilization times vary greatly depending on the reassembled size. A queue can only use one-resource at a time and is appropriately scheduled.

An alternative means of VPN according to an embodiment, can be complete transparency through the Xockets tunnel with all provisioning by a Xockets application creating and deleting connections upon provisioning. In this way the control plane of the VPN is exported to software like vSphere Control Center, Openflow control, or Hyper-V, and the forwarding plane are in one or more Xockets DIMM.

8. Environment of ARM cores

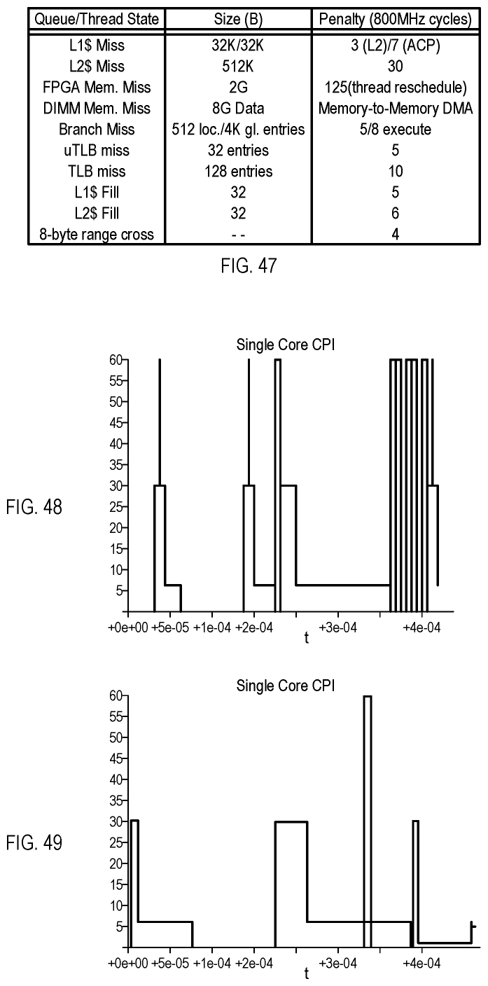

The ARM cores incur a standard set of penalties in the simulation upon cache, TLB, and branch misses. The only interrupts to the system are controlled by the hardware thread/queue scheduler described in the previous section. To simulate instructions, we use the penalties in conjunction with profiled data of various programs shown in FIG. 47

With data profiling, the load with the correct percentage of misses given the data and clients of the application is parameterized. The cycles per instruction (CPI) of a given program (i.e., a single queue) running on a single ARM core is shown in FIGS. 48 and 49. A set of FPGA memory misses, L2 misses, and L1 misses can be seen for a video server by the CPI, while a zero CPI represents either no instructions processed due to a context switch of the thread (due to traffic profile) or memory-mapped hardware for decryption of the stream.

A streaming video server must constantly transport new data and so the ability of the Arbiter FPGA to prefetch data in response to RTP header processing data, is important to limiting FPGA memory misses. The bandwidth of the DIMM can be matched to the DDR3 channel for fully supporting a video server: 24 Gbps of egress bandwidth and 24 Gbps of prefetch bandwidth leaves 16 Gbps for scheduling read to write transitions, and RTP ingress traffic. Given the asymmetry of video processing, this budget conservatively satisfies needs. This application, long strides through a giant multi-gigabyte corpus, is the case of minimum benefit for the Xockets' context switching mechanism (but showcases the Arbiter FPGA's prefetch mechanism).

### 9. Switch-to-Server-to-Switch Latency Analysis

With these simulation results, the length of time for a queue to be selected by the scheduler when it is not out of profile and deserves the arbitration cycle can be observed. It is largely determined by the packet granularity of the packet proceeding and so its distribution largely follows packet distribution. The pipeline to introduce the scheduled queue into an ARM core is very small. If the application requires a cache context switch and is not entirely packet-level processing, this pipeline largely consists of reading the queue context from the RLDRAM (e.g., 7.6 μs).

Oftentimes, network performance is measured as server egress-switch-server-ingress, which may be in μs. By contrast, traditional applications level service is measured in milliseconds for all commodity equipment. Some specialized hardware may be placed at the NIC in order to reduce latency, but in the end these solutions compete (not cooperate) with x86 processors.

In an embodiment, Xockets change that paradigm and allow Switch-to-Server-to-Switch latencies to become a figure of merit. In this way, if a particular session has not exhausted its bandwidth, traffic management (e.g., through SRIOV on the NIC and Xockets on the DIMM) can minimize the latency to processing while providing fairness throughout.

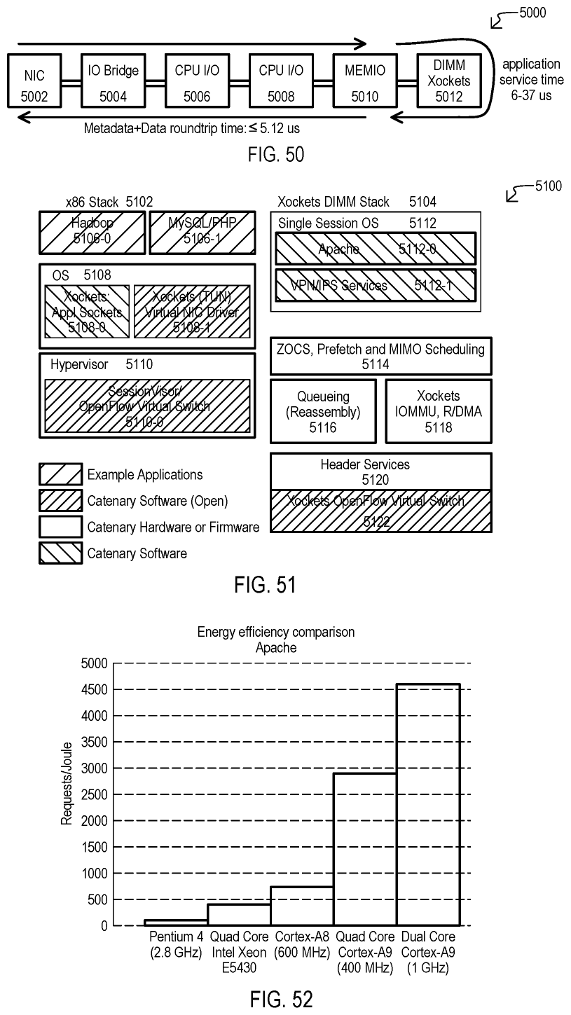

The aggregate latency is composed of the SRIOV scheduler on the NIC, the PCI bus, the CPU's IO block, and Memory Controller writing to the Xockets DIMM, according to an embodiment of the present invention. Such an embodiment is shown in FIG. 50. FIG. 50 shows a system 5000 can corresponding processing latency, including a NIC 5002, an IO Bridge 5004, a first CPU I/O 5006 (e.g., from IO Bridge), a second CPU I/O 5008 (e.g., to memory IO), memory I/O 5020 and a Xockets DIMM 5012. An application service time can be 6-37 μs, and a metadata+data roundtrip time can be less than or equal to 5.12 μs. The Xockets DIMM, while not congested, can process metadata, such as overlays or accounting that don't require context switches, in less than, for example, 6 μs. This provides a Switch-to-Server-to-Switch minimum latency of, for example, less than or equal to 11.12 μs.

The best latencies achieved otherwise by x86 (non-commodity) HW is in the financial community. The NYSE boasts a latency of 100 μs for simple stock exchange events, on x86 systems with incredibly specialized and expensive hardware

### Simulated Software Stack

Although the example below discusses a Xockets DIMM Stack in communication with an x86 Stack, based on the description herein, a person skilled in the relevant art will recognize that other stacks can be in communication with the Xockets DIMM Stack. These other stacks are within the spirit and scope of the embodiments disclosed herein.

### Repurposing Virtualization Hardware

While the use of IOMMU and SRIOV as an independent, arbitrated channel to every DIMM is necessary, it is not sufficient for transparency. Hence, in an embodiment, two computational stacks are used to seamlessly coordinate brawny and wimpy computation through widely deployed abstractions: virtual switching, sockets, DMA and RDMA. Second generation virtualization hooks (extended page tables, EPT, rapid virtualization indexing, RVI) can allow Xockets access to Guest and Kernel memory spaces without needing to engage a CPU, according to an embodiment of the present invention.

Additionally, the adoption of cloud platforms and virtual networks allows an Openflow or management application to coordinate all of the provisioning of Xockets computational layers through existing management layers, according to an embodiment of the present invEntion.

### 2. Dual Software Stacks (+Openflow Management Application)

FIG. 51 is a diagram showing software stacks 5100 according to embodiments. Software stacks 5100 can include a x86 stack 5102 and Xockets DIMM Stack 5104. The x86 stack 5102 shows sample applications, shown as Hadoop 5106-0 and MySQL/PHP 5106-1; operating system (OS) software, which can include application sockets 5108-0 and virtual NIC driver 5108-1; Hypervisor 5110 which can include a SessionVisor/OpenFlow Virtual Switch 5110-0. A Xockets DIMM Stack 5104 can include single session OS software 5112, which can include Apache 5112-0 and/or VPN/IPS Services 5112-1; zero overhead context switching (ZOCs), prefetch and MIMO scheduling 5114; queueing (reassembly) 5116 and IOMMU, R/DAM functions 5118; header services 5120 and a Xockets OpenFlow Virtual Switch 5122. The various software stack levels can include, be implemented as, example applications, catenary software (open source), catenary hardware or firmware, or catenary software.

x86 software stack 5102 shows how the pieces of Xockets software can fit transparently into deployed machines, according to an embodiment of the present invention. The Xockets virtual switch 5102 can be selected (it is a simple derivative of Openflow) by the hypervisor 5110. It can function in a similar manner as the standard Openflow forwarding agent release in Xen, but a portion of the SRIOV traffic management tables of relevant NICs and a portion of the EPT or RVI table can be reserved to forward incoming packets to the memory.

The Xocket's DIMM stack 5104 shows the processing that can take place on each Xockets DIMM. This processing can be very different depending on the source of the data reads or writes. When the source is ingressing data from or egressing data to one of the NICs, a virtual switch 5122 further classifies the headers for session identification and packet-level applications (billing and accounting, signature detection preprocessing, IPSec, etc.). When the source is an application socket (e.g., 5108-0) from one or more of the logical cores, the address used to access the memory identifies which socket (and application servers) is involved, according to an embodiment of the present invention. For example, as discussed in the Hadoop case, these sockets can act to stream records to map steps, to reduce steps, or to collect the results of each for write-back or publishing.

In this way two TLB page addresses are used in each socket: one set of addresses (for the same page) are used for each NIC and one set of addresses are used for each server or application socket. In an embodiment, the management of the Xockets resources should be manageable from the Flowvisor and/or from the Hypervisor management tool (e.g. Xen Cloud Platform, vSphere, Hyper-V).

### 3. Xockets Open Source Software Stack

Xockets SessionVisor 5110-0. SessionVisor 5110-0 can be a simple derivative of the standard virtual switch available from Citrix, Microsoft, and VMware: Openflow and Network Distributed Switch. In an embodiment, the only change can be that a queue to each Xockets DIMM can be pre-configured as virtualized IO and as memory-mapped at the NIC. The SessionVisor can allow connectivity with the Xockets DIMMs virtual switches.

Xockets TUN 5108-1. TUN 5108-1 can be an Open Source driver that simulates a network layer device driving a virtual IO and is available for FreeBSD, Linux, Mac OS X, NetBSD, OpenBSD, Solaris Operating System, Microsoft Windows 2000/XP/Vista/7, and QNX. When deployed for, the driver would be configured to reference a memory mapped IO device. The driver would be customized for certain applications by using the POSIX-compliant mmap configuration such that reads and writes to a particular address are resolved through a trap handler. Such a device can be setup through the configuration of the virtual switch in the Hypervisor, which can advertise the virtual IO to the operating system.

Customer Application Xockets. Customers may create their own application Xockets using Google's Open Source “Protocol Buffers,” according to an embodiment of the present invention. Protocol Buffers allow abstraction of the physical representation of the fields encoded into any protocol from the program and programming language using the protocol. Upon publishing a protocol, it may define the communication between the ARM core program and the x86 program, where the information is automatically placed in ARM cache during a context switch and assembled into the fields required for the x86.

Single Session OS 5112. A barebones Linux OS 5112 can be crafted to have only one processor, one memory module, and one memory-mapped network interface. Only one session can connect to the applications running on the OS. In an embodiment, the entire context of the single session then can be switched when served on the Xockets DIMM. Automatic page remapping can allow all sessions to share the same kernel without actively swapping memory.

### 4. Xockets Licensed Software and Firmware

Application Sockets. For any application that connects to the Xockets DIMM by means other than the networking layer, an application level socket can be formed, according to an embodiment of the present invention. Many servers have pluggable sockets, for example one can customize the socket type for Hadoop with the environmental parameters: hadoop.socks.server, hadoop.rpc.socket.factory.class, ClientProtocol, hadoop.rpc. socket.factory.class.default. Then an application can be offered infrastructure, connectivity, and processing services through this higher order socket, or Xocket. That said, Xockets can craft a Hadoop-specific application socket to partition processing as described below, according to an embodiment of the present invention.

Queuing (Reassembly) 5116. Because the Xockets DIMM can separate every session into independent queues, session packets can be reassembled into their original content in the Xocket while performing any packet-layer services in DIMM, according to an embodiment of the present invention.

UDP/TCP Offload and Reassembly. The DIMM can offload the TCP (or UDP in the case of RTP traffic) control with a standard HW accelerated Linux stack. Once reassembly occurs, packet level services are no longer possible, and so they are all executed within this kernel as well. These include the following two tasks:

Accounting, logging, and diagnostic scripts. Owners of particular connections can probe the functioning and statistics of their socket independently. Providers may log and account for the services they provide exploiting the fast random access of the RLDRAM.

Suricata Header Detection Engine. Xocket's based classification can perform a header match in the same way an Openflow match type (OFMT) is performed at line-rate. In this case, a filtering of possible signatures is performed at the header level for Suricata, having hooks already in place for HW acceleration.

Xocket IOMMU, DMA. After the Xockets DIMMs differentiate between various input streams to the device with reads and writes, it can convert requests and protocols, according to an embodiment of the present invention. Requests sourced from the NIC can be processed as previously described. Requests sourced from an x86 core can be presented through a read and write DDR interface. The arbiter locally buffers data to be transmitted from the computational FPGAs. Responses to read requests referencing a NIC can be interpreted through the Xockets TUN driver to produce requests sourced from an x86 core referencing a particular application socket.

### Simulated Applications

In addition to the simulated applications discussed below, based on the description herein, a person skilled in the relevant art will recognize that other applications can be simulated and used in conjunction with the Xockets embodiments disclosed herein. These other applications are within the scope and spirit of the embodiments disclosed herein.

### LAMP and Video Reference Performance

As an example of transparent offload, the provisioning of Apache and a MySQL client on the Xockets DIMM and MySQL and Python/PHP on one or more x86 cores is considered. In an embodiment, ethernet, tunneled over the DDR interface, can connect the MySQL clients on each Xocket DIMM to the MySQL server on x86 cores.

The type of Web API has a significant impact on performance. Virtually all public Web APIs are RESTful, the transfer of application code and data does not need complex processing or, on most occasions, any persistent state. In these cases, each wimpy core can serve data from local memory, and requests a DMA (memory to memory or disk to memory) when data is missing through the SessionVisor. In the enterprise and private datacenter, SOAP is dominant, and the ability to context switch with sessions is performance critical, but the variance of APIs makes estimated performance difficult.

The performance of Apache is typically session-limited, while the performance of complex MySQL queries is typically “join”-limited (in the select-project-join paradigm). Web requests are then modeled as establishing a connection and then making parallel requests for objects within that connection. The power efficiency of processors of ARM versus x86 can be inferred. For example, the graph of FIG. 52 shows power efficiency for various processors that assume a RESTful interface.

Large egress networks like Limelight serve 700M objects per second in aggregate from approximately 70K 2U servers, or 10K objects per second per server. Typical web-servers serve around 1000 web sessions and several 10s of objects per page. Therefore, we simulate going from 200 sessions serving 100 objects per session to 2000 sessions serving 10 objects per session. In an embodiment, the intrinsic traffic management of sessions on the Xockets DIMM can allow context switching without overhead between several thousand sessions and allows for the turning off the NIC's otherwise on interrupt limiting. Video servers either use a finite number of media servers and some associated formats: Adobe Flash Media Server, Microsoft IIS, Wowza, Kaltura, or a CDN may elect to produce its down delivery platform. In all cases, one or more common data formats must be tailored to the clients' stream types and connectivities. This is minimal processing (with the notable exception of transcoding) but a very high number of random accesses as the streams are all independently striding through large video files. Given the constant rate of data consumption, each file can be prefetched with finer granularity directly to the processing cache and main memory layer for each ARM core.

HD streams of 4 Mbps, with I-frame to interpolated frame ratio of 1 to 10, are simulated and the number of concurrent streams can be processed before IO exhaustion is determined. The number of streams is detailed in the initial results section.

RIP is a transmission layer protocol for real-time content and stream synchronization. Although it is a Layer 4 protocol, RTP isn't processed until the Application layer since no hardware can offload it. In an embodiment, the Xockets architecture eliminates that kludge, processing the traffic and producing general socket data for the server. For reference, the protocol is simulated at 200B of overhead per 30 ms frame rate. Underlying transport (e.g., UDP) holds the number of padding bytes at the end, by using its defined length.

### 2. Business Analytics

### Converting Big Data Queries to Fast Data Queries

In an embodiment, Xockets can improve the performance of Hadoop in two major ways: (1) by allocating intrinsically parallel computational tasks to the Xockets DIMMs, leaving the brute number crunching tasks to the x86 cores; and (2) by being able to drive the IO backplane to its capacity, rather than the 10% used today.

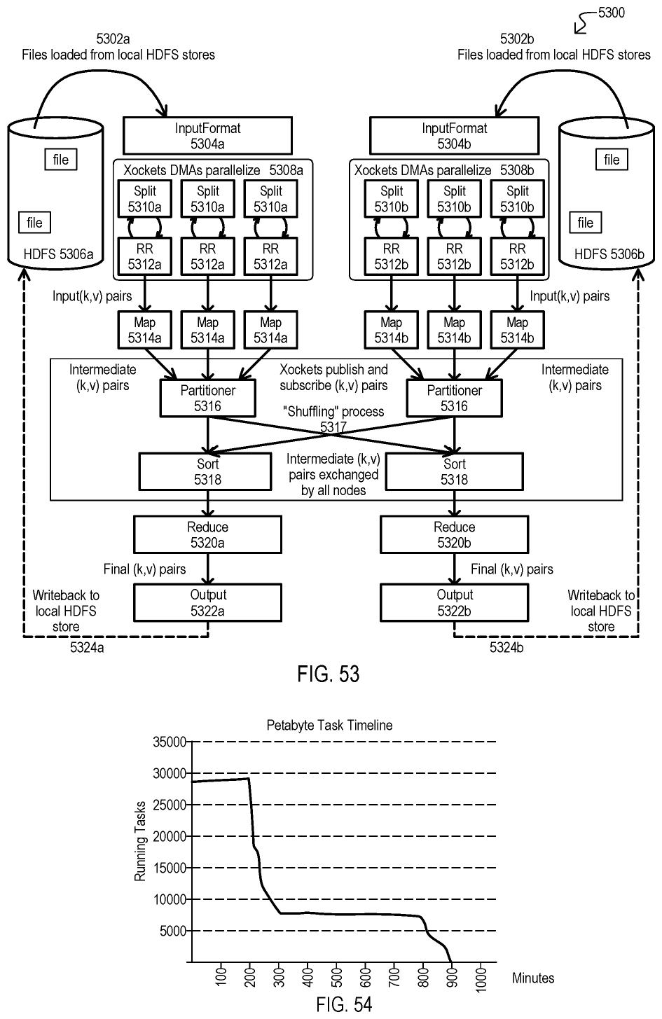

FIG. 53 illustrates these two architectural changes. FIG. 53 shows a system 5300 that includes data storage (HDFS) 5306a/b, input format functions 5304a/b, operations that can be parallelized by Xockets DMA 5308a/b, which include split functions 5310a/b, record read (RR) functions 5312a/b and mapping functions 5314a/b. Split and RR functions (5310a/b, 5312a/b) can generate input key/value (k,v) pairs for mapping functions 5314a/b, which generate intermediate (k,v) pairs for partitioners 5316. Xockets can implement a publish and subscribe model for intermediate (k,v) pairs. A shuffling process can result in the exchange of intermediate (k,v) pairs between different, parallel map processes, to sorters 1318. Sorters 1318 can provide intermediate (k,v) pairs to appropriate reducers 5320a/b. Reducers 5320a/b can output 5322a/b final (k,v) pairs in a writeback operation 5324a/b to data storage 5306a/b.

In the first capacity, the Xockets DIMM interposes ARM based parsing in an ordinary DMA (5308a/b/5314a/b) producing the records consumed by map step on the x86 cores. Because all DMAs can be traffic engineered, all parallel Map steps 5314a/b can be equitably served with data. In the second, very significant capacity, Xockets can solve the intrinsic bottleneck of most Hadoop workloads: data shuffling.

Instead of using HTTP to communicate Map results to Reduce inputs, shuffling 5317 can be built off a publish-subscribe model similar to ZeroMQ. The results from the map step are already residing in main memory and can be “collected” by a single DMA to the Xockets. The key and value are parsed in the Xockets DIMM, and the key is published through the massively parallel Xockets' mid-plane, with, as but one example, 160 ARM cores driving and receiving the full 240 Gbps capacity of the PCI-3.0 bus, according to an embodiment of the present invention. The identification of keys is remapped to HW accelerated CAM-ing, and upon subscriptions receiving data, it is traffic engineered back to the x86-hosted Reducers 5320a/b via virtual interrupts.

This can eliminate not just the issue of shuffling bandwidth, but the latency of collecting keys. This latency is responsible for the massive idling of x86 processors. To ensure the correctness of two-phase MapReduce protocol, ReduceTasks may not start reducing data until all intermediate data has been merged together. This results in a serialization barrier that significantly delays the reduce operation of ReduceTasks.

To configure this rack-level computer, 6 Xockets DIMMs and 16 ordinary DIMMs per 2U server are assumed. These servers accommodate four 80 Gbps ethernet NICs. The large DRAM buffer on each Xockets DIMM allows the results to be stored while reduce steps gather results. Neighboring TOR switches have forty 10GigE links to the servers on a rack and eight GigE links uplinks to the secondary switch are also assumed. In an embodiment, one petabyte of data can occupy each rack. By connecting servers' ethernet ports to one another directly, capitalizing on the virtual switching of the Xockets given limited bandwidth on the top of rack switch, a very tightly interconnected rack emerges, according to an embodiment of the present invention.

Within a rack, even if the Mappers 5314a/b shuffled 100 TB of data to the Reducers 5320a/b, it would only take less than, for example, 3 mins. To scale further, inter-rack connectivity or second-level switches may be scalable. To cycle-accurately simulate the performance for a storage disk created out of Xockets' memory on a rack, too many components would need to be modeled for the task to be tractable. Instead, manual calculation is performed. In considering how one test-piece of Hadoop would run: 1PB sorting via the “Terrasort” algorithm. FIG. 54 shows illustrates a breakdown of the Hadoop run for 1PB Terrasort. FIG. 54 shows a number of running tasks over time (minutes).

3200 ARM cores and 640 x86 cores (20 servers of four 8-core processors) can process a Hadoop Terrasort (80,000 Mappers and 20,000 Reducers), virtually eliminating collecting, shuffling, and merging, at 3.4× acceleration (3.4 sorts per the traditional 1), If the number of reducers is simultaneously increased to the same order as the number of mappers, the total speed can be increased by, for example, 5.4×. This speedup holds in Terrasort for even small jobs. For example, FIG. the figure below for 500 GB exhibits the same ratio of shuffle and reduce. In other applications, where merge is significant, removing disk writes in the map steps will also significantly increase the speed. Other applications have a wide variance in resources and times but share the common bottleneck. Shuffle is what makes Hadoop, Hadoop; it is a step that turns local computing into clustered computing and hence is often described as the bottleneck.

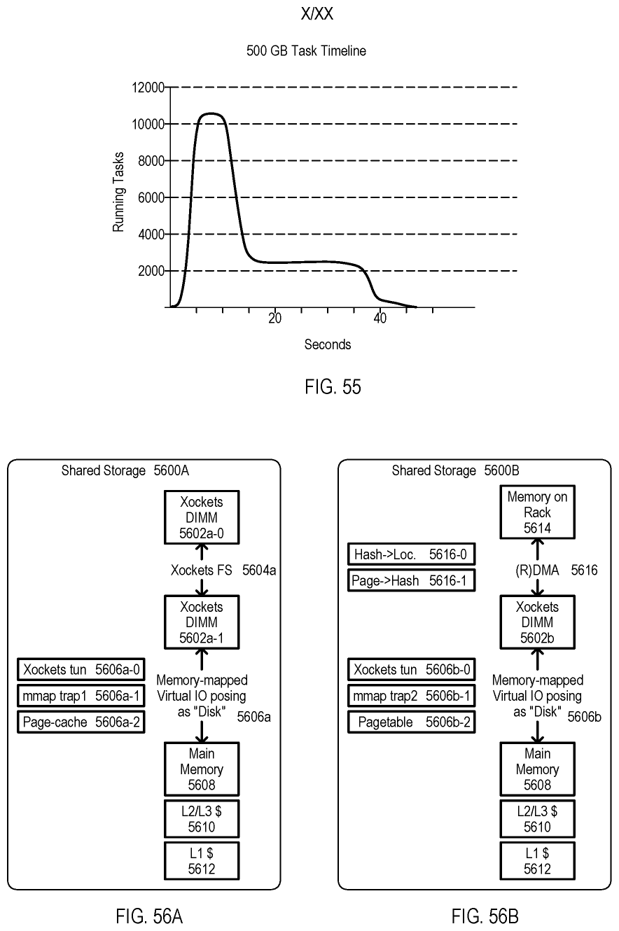

FIG. 55 is a graph showing a 500 GB task timeline, with running tasks over time.

b. Distributed Structure Queries on Shared-Nothing Architectures

As explained above, a purpose of this architecture, among others, is to run structured queries in concert with fast and big data analytics on the same platform. To accomplish the former, a distributed query system on all the ARM cores for the effective data disk formed from the DRAM on the Xockets DIMMs is run. Commercial software packages such as SAP or a set of Open Source tools such as Apache Hive and MySQL, can be run on this effective rack-level in-memory disk and distributed ARM querying system.

In an embodiment, a request to a particular memory address representing the disk creates a trap executing code from the Xockets' OS driver. The latency of requests is minimally defined by: an interrupt sequence, followed by twice the response time of the Xockets DIMM and the NIC's queue management, and finally the latency of the TOR switch, according to an embodiment of the present invention.

One of the prominent, differentiating features of VMware is better memory utilization with: (1) transparent page-sharing (virtual machines with common memory data are shared instead of duplicated); and (2) a memory compression cache (a portion of the main memory is dedicated to being a cache of compressed pages, swapping fewer out to disk). This is a limited solution, given minimal compression due to software performance and minimal sharing across VMs, still worthwhile given the value of VM density. This is advertised by VMware as a new layer of bandwidth/latency between main memory and disk.

To support fast structured queues, in an embodiment, a common storage is constructed from metadata communicated between Xockets DIMMs. Server-to-server connections can be mediated by Xockets DIMMs acting as intelligent switches to offload the TOR switch.

FIG. 56A shows a common storage 5600A according to an embodiment. Xockets DIMMs (5602a-0/1) can provide access through a file system 5604a. Memory-mapped virtual IO posing as a memory destination (disk) 5606a. Common storage 5600A can include using a Xockets tunnel 5606a-0, memory trap 5606a-1 and page-cache 5606a-2. Common storage can also include main memory 5608, level2/level3 cache 5610 and level 1 cache 5612.

The ability of NICs to process RDMA headers allow Xockets DIMMs to extend this memory network to other DIMMs with low latency, without any participation from x86 cores, according to an embodiment of the present invention.

FIG. 56B shows a common storage 5600B according to another embodiment. Xockets DIMMs (5602b) can access memory on rack 5614 with RDMA 5616. This can include hash to location 5616-0 and page to hash 5616-1. Memory-mapped virtual IO posing as a memory destination 5606b. Common storage 5600A can include using a Xockets tunnel 5606b-0, memory trap 5606b-1 and page table 5606b-2. Common storage can also include main memory 5608, level2/level3 cache 5610 and level 1 cache 5612.

This possibility can be explored in the future as RDMA is deployed more widely, and the need for intra-rack page-sharing (rather than intra-server) arrives. Tens of TBs of main memory and hundreds of TBs of SSD can be stored on a rack. In an embodiment, Xockets provides a transparent framework to share this capacity on the entire, otherwise shared-nothing, rack with delay measured in microseconds, not milliseconds by attracting away RDMAs for capable NICs or accomplish the same means through local Xockets DIMMs

Also, the parallelism of Xockets can be used to create a high-performance name-node master which maps blocks in a file-system to physical machine spaces.

### 3. Intrusion Prevention System and Virtual Private Networks

While intrusion-detection (IDS) is necessary, it is insufficient and of diminished value compared to intrusion-prevision, IPS. To use a system like Snort for IPS, it must be configured to run inline, where its performance and rule formation is lacking. Instead, Suricata is the Open Source choice for IPS. Many inline Snort developers have defected to the Suricata community given its clean multithreaded design and clean abstraction between different portions of the functional pipeline. As explained above, VPN must be coordinated with IPS on the same platform for them to coexist.

In an embodiment, the Xockets hardware classifies incoming packets to reduce signature consideration down to a small subset. Meta-data is stored per queue, for when the corresponding thread is scheduled. The packets are stored in the queue. Upon queue selection, the data is reassembled, and memory-mapped. OpenSSL HW is activated by the OpenVPN code reforming the reassembled data. Upon reassembly, the queue is deemed ready for scheduling again and decrypted data is pipelined for reissue into the context switch. Upon rescheduling, the data is processed by the Suricate signature detection code for the subset indicated. If the data is deemed valid, the data is written to a MMIO address of the x86's memory space that represents the virtual IO of the Guest. The TUN driver interacts with this MMIO space seamlessly.

### Suricata Performance

In an embodiment, such a simulation plays very well with Xockets architecture since there is intrinsic session level parallelism that is often not realized. The program is coded for external HW acceleration (the normal use is in the CUDA framework of graphics providers such as Nvidia) and coded for a configurable number of threads. Each micro-engine can then work with thread signature detection separately.

As the number of threads increased, performance decreased when waiting for concurrency locks, and subsequent simulations in other work (RunModeFilePcapAuto) showed an initial increase, then a continued decrease in performance as measured by packets per second processed. The price of the context switch as the number of the threads exceeds the number of cores, and the unavailability of unique threads as more packet buffer depth is needed for reassembled content limits the performance of Suricata. The Xockets architecture can directly address these problems, among others, and show remarkable throughput. The simulation is configured to hold the signatures and state on every Xockets DIMM. Empirically, it has been shown a maximum of 3.3 GB of memory is required to store the Suricata signature information and detection state for the many thousands of sessions composing a 20 Gbps link using the VRT and ET rules (in aggregate currently about 30K rules). However, on average, only 300 rules are active for any given session. There is a direct correlation between the number of sessions and the packet buffer size for reassembly to make statistical use of the independent processing channels. Empirically, a 10× increase in the buffer size is needed for a 2× increase in the packet processing rate. This is a serious problem for finite-overhead x86 CPUs. The max-pending-packets value determines the maximum number of packets the detection engine will process simultaneously. There is a tradeoff between caching and CPU performance as this number is increased. While increasing this number will more fully use multiple CPUs, it will also increase the amount of caching required within the detection engine. The number of threads that can be used within the detection engine is minimal and by default is set to 1.5 per logical CPU, with no point increase beyond 2.0. However, for the ARM cores, they can context switch between each of the queues representing a different signature with zero overhead. This speeds up the detection by orders of magnitude as shown in the initial summary. Additionally, IPS alerts can automatically traffic manage queues

Because IPS solutions (e.g., the Suricata) allow HW acceleration of signatures and header processing to offload processors from inefficient matching, the reference system is taken to be customized high performance signature detection engines on the PCI-express bus. They have empirically shown 9+Gbps of detection performance for a smaller set of YAML rules (˜16K) per NIC.

### OpenVPN Performance

There are two dimensions that determine performance on a Socket VPN server: (1) the number of clients; and (2) the total bandwidth of all the encrypted connections. The second dimension is limited in several ways: (1) the checksum (chksum) calculation of the packet; (2) packetization of socket data; and (3) interrupt load on the CPU and NIC and the pure encryption bandwidth of Intel's encryption instruction set. The first dimension is limited by the interrupt rate of the processor and the size of the caches preserving encryption state. To achieve high bandwidths in a traditional server, large packets must be fed to AES instructions to accelerate the task of SSL encryption/decryption, and packetization must be offloaded to downstream NICs (or specialized switches) though TCP offload. If the MTU is set to 1500 at the x86 processor, Gigabit rates cannot be achieved for reasons noted herein. Given Intel's AES-N1 infrastructure, AES256 has become the cipher of choice on such systems. AES instructions double the speed of encryption/decryption difference for AES256 cypher (for Blowfish however, there is little difference). There is a huge benefit to offloading TCP at high data, and for all practical purposes necessary for rates at or above 10 Gbps

According to OpenVPNs performance testing and optimization, the burden of smaller packets is enormous on socket sub-systems. Given that even Super-Jumbo packets fit in the cache of modern processors, gigabit level connections require leaving packet fragmentation to HW instead of SW.

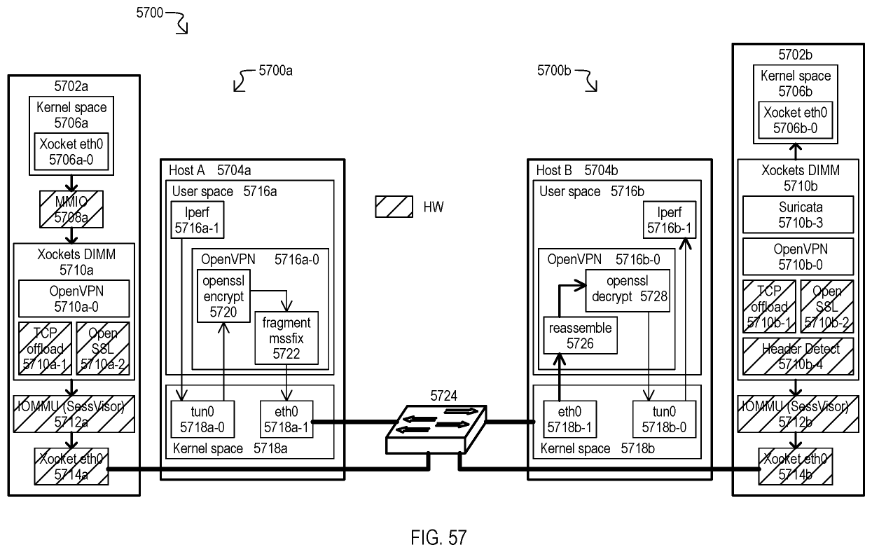

FIG. 57 is a block diagram of a system 5700 that includes an encrypting server 5700a and decrypting server 5700b in communication via one or more switches 5724. Encrypting server 5700a can include an encrypting Xockets DIMM stack 5702a and encrypting host device stack 5704a. A Xockets DIMM stack 5702a can include a kernel space 5706a, MMIO function 5708a, Xockets DIMM 5710a, IOMMU 5712a and Xockets ethernet 5714a. Kernel space 5706a can include ethernet processing 5706a-0. Xockets DIMM 5710a can include open VPN function 5710a-0, TCP offload function 5710a-1 and open SSL protocol function 5710a-2. An encrypting host device stack 5704a can include a user space 5716a and kernel space 5718a. A user space 5716a can include a network performance tool (Iperf) 5716a-1 and OpenVPN application 5716a-0, which can include an encryption function 5720 and packet sizing function (fragment/mssfix) 5722. A kernel space 5718a can include a tunneling driver 5718a-0 and ethernet driver 5718a-1. Decrypting server 5700b can include a decrypting Xockets DIMM stack 5702b and decrypting host device stack 5704b. A Xockets DIMM stack 5702a can include a kernel space 5706b, MMIO driver 1708a, Xockets DIMM 5710b, IOMMU 5712b and Xockets ethernet 5714b. Kernel space 5706b can include ethernet processing 5706b-0. Xockets DIMM 5710b can include an IPS application (Suricata) 5710b-3, open VPN function 5710b-0, TCP offload function 5710b-1, open SSL protocol function 5710b-2 and header detect function 5170b-4. An encrypting host device stack 5704b can include a user space 5716b and kernel space 5718b. A user space 5716b can include a network performance tool 5716b-1 (and OpenVPN application 5716b-0, which can include a reassemble function 5726 and decryption function 5728. A kernel space 5718b can include a tunneling driver 5718b-0 and ethernet driver 5718b-1.

By increasing the MTU size of the tun adapter and by disabling OpenVPN's internal fragmentation routines the throughput can be increased quite dramatically. The reason behind this is that by feeding larger packets to the OpenSSL encryption and decryption routines the performance will go up. The second advantage of not internally fragmenting packets is that this is left to the operating system and to the kernel network device drivers. For a LAN-based setup this can work, but when handling various types of remote users (e.g., road warriors, cable modem users, etc.) this is not always a possibility.

FIG. 57 shows why this is the case, and why Application layer software sockets are ordinarily convoluted. Transitioning back and forth between the user and kernel space (as in Host A and Host B) when setting up a virtual tunnel to the physical ethernet adapter is an operation that runs in software and requires the use of large blocks of data in each exchange so as not to be interrupt limited. An embodiment of the Xockets paradigm is shown on the extreme left and ride side in FIG. 57, with hatching denoting the HW blocks. The straight line from user to the virtual NIC driver can require no interrupts to handshake, and the virtual tunnel is the physical tunnel for all purposes, since IOMMU and Xockets relieves the kernel 5716a from involvement in the egressing of traffic, according to an embodiment of the present invention. Additionally, in an embodiment, the entire flow can be traffic engineered from the point the MMIO driver's 5708a asserts a packet from delivery on a particular channel. This driver can either appear as a NIC or as a Socket depending on the layer of abstraction and application used.

### Exemplary Computer System

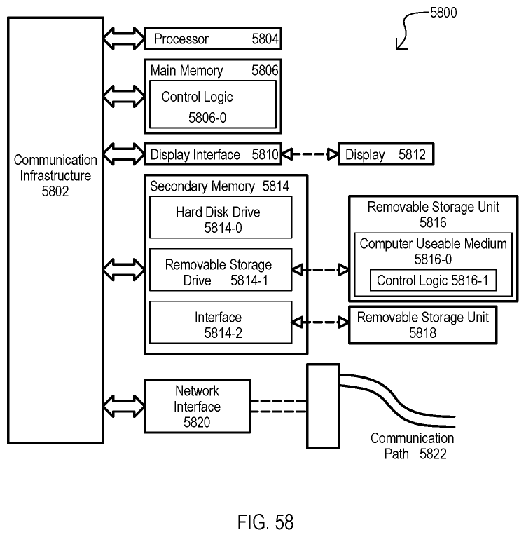

Various aspects of the embodiments described herein, or portions thereof, may be implemented in software, firmware, hardware, or a combination thereof. FIG. 58 is an illustration of another example computer system 5800 in which embodiments described herein, or portions thereof, can be implemented as computer-readable code. Various embodiments are described in terms of this example computer system 5800. After reading this description, it will become apparent to a person skilled in the relevant art how to implement embodiments described herein using other computer systems and/or computer architectures.

Computer system 5800 can be any commercially available and well known computer capable of performing the functions described herein, such as computers available from International Business Machines, Apple, Sun, HP, Dell, Compaq, Cray, etc.

Computer system 5800 includes one or more processors, such as processor 5804. Processor 5804 may be a special purpose or a general-purpose processor. Processor 5804 is connected to a communication infrastructure 5802 (e.g., a bus or network).

Computer system 5800 also includes a main memory 5806, preferably random access memory (RAM), and may also include a secondary memory 5814. Main memory 5806 has stored therein a control logic 5806-0 (computer software) and data. Secondary memory 5814 can include, for example, a hard disk drive 5814-0, a removable storage drive 5814-1, and/or a memory stick. Removable storage drive 614 can comprise a floppy disk drive, a magnetic tape drive, an optical disk drive, a flash memory, or the like. The removable storage drive 5814-1 can read from and/or write to a removable storage unit 5816 in a well-known manner. Removable storage unit 5816 can include a floppy disk, magnetic tape, optical disk, etc. which is read by and written to by removable storage drive 5814-1. As will be appreciated by persons skilled in the relevant art, removable storage unit 5816 can include a computer-usable storage medium 5816-0 having stored therein a control logic 5816-1 (e.g., computer software) and/or data.

In alternative implementations, secondary memory 5814 can include other similar devices for allowing computer programs or other instructions to be loaded into computer system 5800. Such devices can include, for example, a removable storage unit 5818 and an interface 5814-2. Examples of such devices can include a program cartridge and cartridge interface (such as those found in video game devices), a removable memory chip (e.g., EPROM or PROM) and associated socket, and other removable storage units 5818 and interfaces 5814-2 which allow software and data to be transferred from the removable storage unit 5818 to computer system 5800.

Computer system 5800 also includes a display 5812 that can communicate with computer system 5800 via a display interface 5810. Although not shown in computer system 5800 of FIG. 58, as would be understood by a person skilled in the relevant art, computer system 5800 can communicate with other input/output devices such as, for example and without limitation, a keyboard, a pointing device, and a Bluetooth device.

Computer system 5800 can also include a communications interface 5820. Communications interface 5820 can allow software and data to be transferred between computer system 5800 and external devices. Communications interface 5820 can include a modem, a network interface (such as an Ethernet card), a communications port, a PCMCIA slot and card, or the like. Software and data transferred via communications interface 5820 are in the form of signals, which may be electronic, electromagnetic, optical, or other signals capable of being received by communications interface 5820. These signals are provided to communications interface 5820 via a communications path 5822. Communications path 5822 carries signals and may be implemented using wire or cable, fiber optics, a phone line, a cellular phone link, a RF link or other communications channels.

In this document, the terms “computer program medium” and “computer-usable medium” are used to generally refer to media such as removable storage unit 5816, removable storage unit 5818, and a hard disk installed in hard disk drive 5814-0. Computer program medium and computer-usable medium can also refer to memories, such as main memory 5806 and secondary memory 5814, which can be memory semiconductors (e.g., DRAMs, etc.). These computer program products provide software to computer system 5800.

Computer programs (also called computer control logic) are stored on memory 5806 and/or secondary memory 5814. Computer programs may also be received via communications interface 5822. Such computer programs, when executed, enable computer system 5800 to implement embodiments described herein. In particular, the computer programs, when executed, enable processor 5804 to implement processes described herein, such as the steps in the methods discussed above. Accordingly, such computer programs represent controllers of the computer system 5800. Where embodiments are implemented using software, the software can be stored on a computer program product and loaded into computer system 5800 using removable storage drive 5814-1, interface 5814-2, hard drive 5814-0 or communications interface 5820.

Based on the description herein, a person skilled in the relevant art will recognize that the computer programs, when executed, can enable one or more processors to implement processes described above. In an embodiment, the one or more processors can be part of a computing device incorporated in a clustered computing environment or server farm. Further, in an embodiment, the computing process performed by the clustered computing environment such as, for example, the steps in the methods discussed above may be carried out across multiple processors located at the same or different locations.

Based on the description herein, a person skilled in the relevant art will recognize that the computer programs, when executed, can enable multiple processors to implement processes described above. In an embodiment, the computing process performed by the multiple processors can be carried out across multiple processors located at a different location from one another.

Embodiments are also directed to computer program products including software stored on any computer-usable medium. Such software, when executed in one or more data processing devices, causes a data processing device(s) to operate as described herein. Embodiments employ any computer-usable or -readable medium, known now or in the future. Examples of computer-usable mediums include, but are not limited to, primary storage devices (e.g., any type of random access memory), secondary storage devices (e.g., hard drives, floppy disks, CD ROMS, ZIP disks, tapes, magnetic storage devices, optical storage devices, MEMS, nanotechnological storage devices, etc.), and communication mediums (e.g., wired and wireless communications networks, local area networks, wide area networks, intranets, etc.).

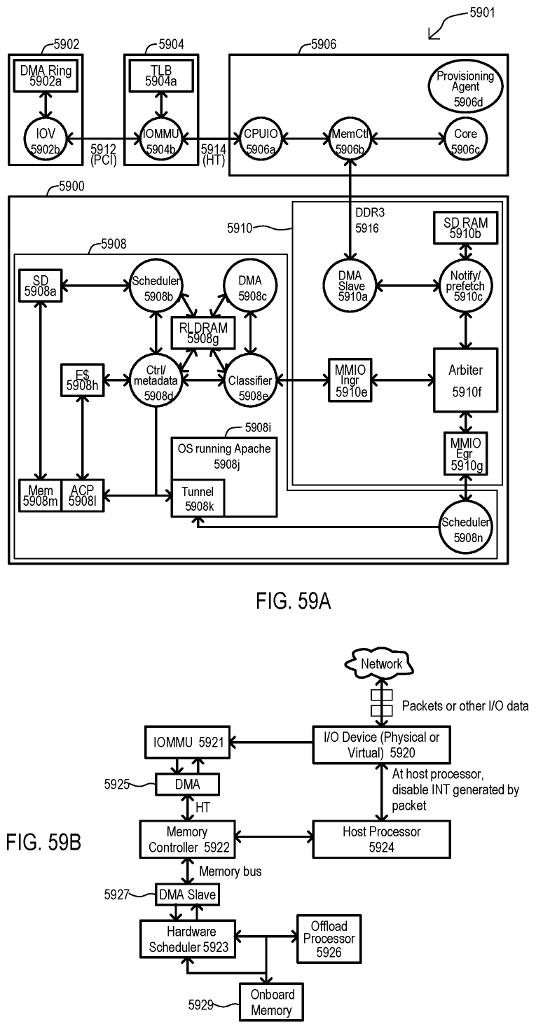

FIG. 59A shows a system 5901 that can transport packet data to one or more computational units (one shown as 5900) located on a module, which in particular embodiments, can include a connector compatible with an existing memory module. In some embodiments, a computational unit 5900 can include a processor module as described in embodiments herein, or an equivalent. A computational unit 5900 can be capable of intercepting or otherwise accessing packets sent over a memory bus 5916 and carrying out processing on such packets, including but not limited to termination or metadata processing. A system memory bus 5916 can be a system memory bus like those described herein, or equivalents.

According to some embodiments, packets corresponding to a particular flow can be transported to a storage location accessible by, or included within, computational unit 5900. Such transportation can occur without consuming resources of a host processor module 5906c, connected to memory bus 5916. In particular embodiments, such transport can occur without interrupting the host processor module 5906c. In such an arrangement, a host processor module 5906c does not have to handle incoming flows. Incoming flows can be directed to computational unit 5900, which in particular embodiments, can include a general purpose processor 5908i. Such general purpose processors 5908i can be capable of running code for terminating incoming flows.

In one very particular embodiment, a general purpose processor 5908i can run code for terminating particular network flow session types, such as Apache video sessions, as but one example.

In addition or alternatively, a general purpose processor 5908i can process metadata of a packet. In such embodiments, such metadata can include one or more fields of a header for the packet, or a header encapsulated further within the packet.

Referring still to FIG. 59A, according to embodiments, a system 5901 can carry out any of the following functions: 1) transport packets of a flow to a destination occupied by, or accessible by, a computational unit 5900 without interrupting a host processor module 5906c; 2) transport packets to an offload processor 5908i capable of terminating session flows (i.e., the offload processor is responsible for terminating session flows); 3) transport packets to midplane switch that can process the metadata associated with a packet and make a switching decision; 4) provide a novel high speed packet terminating system.

Conventional packet processing systems can utilize host processors for packet termination. However, due to the context switching involved in handling multiple sessions, conventional approaches require significant processing overhead for such context switching and can incur memory access and network stack delay.

In contrast to conventional approaches, embodiments as disclosed herein can enable high speed packet termination by reducing context switch overhead of a host processor. Embodiments can provide any of the following functions: 1) offload computation tasks to one or more processors via a system memory bus, without the knowledge of the host processor, or significant host processor involvement; 2) interconnect servers in a rack or amongst racks by employing offload processors as switches; or 3) use I/O virtualization to redirect incoming packets to different offload processors.

Referring still to FIG. 59A, a system 5901 can include an I/O device 5902 which can receive packet or other I/O data from an external source. In some embodiments I/O device 5902 can include physical or virtual functions generated by the physical device to receive a packet or other I/O data from the network or another computer or virtual machine. In the very particular embodiment shown, an I/O device 5902 can include a network interface card (NIC) having input buffer 5902a (e.g., DMA ring buffer) and an I/O virtualization function 5902b.

According to embodiments, an I/O device 5902 can write a descriptor including details of the necessary memory operation for the packet (i.e. read/write, source/destination). Such a descriptor can be assigned a virtual memory location (e.g., by an operating system of the system 5901). I/O device 5902 then communicates with an input output memory management unit (IOMMU) 5904 which can translate virtual addresses to corresponding physical addresses. In the particular embodiment shown, a translation look-aside buffer (TLB) 5904a can be used for such translation. Virtual function reads or writes data between I/O device and system memory locations can then be executed with a direct memory transfer (e.g., DMA) via a memory controller 5906b of the system 5901. An I/O device 5902 can be connected to IOMMU 5904 by a host bus 59592. In one very particular embodiment, a host bus 59592 can be a peripheral interconnect (PCI) type bus. IOMMU 5904 can be connected to a host processing section 5906 at a central processing unit I/O (CPUIO) 5906a. In the embodiment shown, such a connection 5914 can support a HyperTransport (HT) protocol.

In the embodiment shown, a host processing section 5906 can include the CPUIO 5906a, memory controller 5906b, processing core 5906c and corresponding provisioning agent 5906d. In particular embodiments, a computational unit 5900 can interface with the system bus 5916 via standard in-line module connection, which in very particular embodiments, can include a DIMM type slot. In the embodiment shown, a memory bus 5916 can be a DDR3 type memory bus, however alternative embodiments can include any suitable system memory bus. Packet data can be sent by memory controller 5906b to via memory bus 5916 to a DMA slave interface 5910a. DMA slave interface 5910a can be adapted to receive encapsulated read/write instructions from a DMA write over the memory bus 5916.

A hardware scheduler (5908b/c/d/e/h) can perform traffic management on incoming packets by categorizing them according to flow using session metadata. Packets can be queued for output in an onboard memory (5910b/5908a/5908m) based on session priority. When the hardware scheduler determines that a packet for a particular session is ready to be processed by the offload processor 5908i, the onboard memory is signaled for a context switch to that session. Utilizing this method of prioritization, context switching overhead can be reduced, as compared to conventional approaches. That is, a hardware scheduler can handle context switching decisions thus optimizing the performance of the downstream resource (e.g., offload processor 5908i).

As noted above, in very particular embodiments, an offload processor 5908i can be a “wimpy” core” type processor. According to some embodiments, a host processor 5906c can be a “brawny core” type processor (e.g., an x86 or any other processor capable of handling “heavy touch” computational operations). While an I/O device 5902 can be configured to trigger host processor interrupts in response to incoming packets, according to embodiments, such interrupts can be disabled, thereby reducing processing overhead for the host processor 5906c. In some very particular embodiments, an offload processor 5908i can include an ARM, ARC, Tensilica, MIPS, Strong/ARM or any other processor capable of handling “light touch” operations. Preferably, an offload processor can run a general purpose operating system for executing a plurality of sessions, which can be optimized to work in conjunction with the hardware scheduler in order to reduce context switching overhead.

Referring still to FIG. 59A, in operation, a system 5901 can receive packets from an external network over a network interface. The packets are destined for either a host processor 5906c or an offload processor 5908i based on the classification logic and schematics employed by I/O device 5902. In particular embodiments, I/O device 5902 can operate as a virtualized NIC, with packets for a particular logical network or to a certain virtual MAC (VMAC) address can be directed into separate queues and sent over to the destination logical entity. Such an arrangement can transfer packets to different entities. In some embodiments, each such entity can have a virtual driver, a virtual device model that it uses to communicate with virtual network interfaces it is connected to.

According to embodiments, multiple devices can be used to redirect traffic to specific memory addresses. So, each of the network devices operates as if it is transferring the packets to the memory location of a logical entity. However, in reality, such packets are transferred to memory addresses where they can be handled by one or more offload processors. In particular embodiments such transfers are to physical memory addresses, thus logical entities can be removed from the processing, and a host processor can be free from such packet handling.

Accordingly, embodiments can be conceptualized as providing a memory “black box” to which specific network data can be fed. Such a memory black box can handle the data (e.g., process it) and respond back when such data is requested.

Referring still to FIG. 59A, according to some embodiments, I/O device 5902 can receive data packets from a network or from a computing device. The data packets can have certain characteristics, including transport protocol number, source and destination port numbers, source and destination IP addresses, for example. The data packets can further have metadata that is processed (5908d) that helps in their classification and management. I/O device 5902 can include, but is not limited to, peripheral component interconnect (PCI) and/or PCI express (PCIe) devices connecting with host motherboard via PCI or PCIe bus 9 (e.g., 59592). Examples of I/O devices include a network interface controller (NIC), a host bus adapter, a converged network adapter, an ATM network interface etc.

In order to provide for an abstraction scheme that allows multiple logical entities to access the same I/O device 5902, the I/O device may be virtualized to provide for multiple virtual devices each of which can perform some of the functions of the physical I/O device. The IO virtualization program, according to an embodiment, can redirect traffic to different memory locations (and thus to different offload processors attached to modules on a memory bus). To achieve this, an I/O device 5902 (e.g., a network card) may be partitioned into several function parts; including controlling function (CF) supporting input/output virtualization (IOV) architecture (e.g., single-root IOV) and multiple virtual function (VF) interfaces. Each virtual function interface may be provided with resources during runtime for dedicated usage. Examples of the CF and VF may include the physical function and virtual functions under schemes such as Single Root I/O Virtualization or Multi-Root I/O Virtualization architecture. The CF acts as the physical resources that set up and manage virtual resources. The CF is also capable of acting as a full-fledged IO device. The VF is responsible for providing an abstraction of a virtual device for communication with multiple logical entities/multiple memory regions.

The operating system/the hypervisor/any of the virtual machines/user code running on a host processor 5906c may be loaded with a device model, a VF driver and a driver for a CF. The device model may be used to create an emulation of a physical device for the host processor 5906c to recognize each of the multiple VFs that are created. The device model may be replicated multiple times to give the impression to a VF driver (a driver that interacts with a virtual IO device) that it is interacting with a physical device of a particular type.

For example, a certain device module may be used to emulate a network adapter such as the Intel® Ethernet Converged Network Adapter(CNA) X540-T2, so that the I/O device 5902 believes it is interacting with such an adapter. In such a case, each of the virtual functions may have the capability to support the functions of the above said CNA, i.e., each of the Physical Functions should be able to support such functionality. The device model and the VF driver can be run in either privileged or non-privileged mode. In some embodiments, there is no restriction with regard to who hosts/runs the code corresponding to the device model and the VF driver. The code, however, has the capability to create multiple copies of device model and VF driver so as to enable multiple copies of said I/O interface to be created.

An application or provisioning agent 5906d, as part of an application/user level code running in a kernel, may create a virtual I/O address space for each VF, during runtime and allocate part of the physical address space to it. For example, if an application handling the VF driver instructs it to read or write packets from or to memory addresses Oxaaaa to Oxffff, the device driver may write I/O descriptors into a descriptor queue with a head and tail pointer that are changed dynamically as queue entries are filled. The data structure may be of another type as well, including but not limited to a ring structure 5902a or hash table.

The VF can read from or write data to the address location pointed to by the driver. Further, on completing the transfer of data to the address space allocated to the driver, interrupts, which are usually triggered to the host processor to handle said network packets, can be disabled. Allocating a specific I/O space to a device can include allocating said IO space a specific physical memory space occupied.

In another embodiment, the descriptor may comprise only a write operation, if the descriptor is associated with a specific data structure for handling incoming packets. Further, the descriptor for each of the entries in the incoming data structure may be constant so as to redirect all data writes to a specific memory location. In an alternate embodiment, the descriptor for consecutive entries may point to consecutive entries in memory so as to direct incoming packets to consecutive memory locations.

Alternatively, said operating system may create a defined physical address space for an application supporting the VF drivers and allocate a virtual memory address space to the application or provisioning agent 5906d, thereby creating a mapping for each virtual function between said virtual address and a physical address space. Said mapping between virtual memory address space and physical memory space may be stored in IOMMU tables 5904a. The application performing memory reads or writes may supply virtual addresses to say virtual function, and the host processor OS may allocate a specific part of the physical memory location to such an application.

Alternatively, VF may be configured to generate requests such as read and write which may be part of a direct memory access (DMA) read or write operation, for example. The virtual addresses are translated by the IOMMU 5904 to their corresponding physical addresses and the physical addresses may be provided to the memory controller for access. That is, the IOMMU 5904 may modify the memory requests sourced by the I/O devices to change the virtual address in the request to a physical address, and the memory request may be forwarded to the memory controller for memory access. The memory request may be forwarded over a bus 5914 that supports a protocol such as HyperTransport 5914. The VF may in such cases carry out a direct memory access by supplying the virtual memory address to the IOMMU.

Alternatively, said application may directly code the physical address into the VF descriptors if the VF allows for it. If the VF cannot support physical addresses of the form used by the host processor 5906c, an aperture with a hardware size supported by the VF device may be coded into the descriptor so that the VF is informed of the target hardware address of the device. Data that is transferred to an aperture may be mapped by a translation table to a defined physical address space in the system memory. The DMA operations may be initiated by software executed by the processors, programming the I/O devices directly or indirectly to perform the DMA operations.

Referring still to FIG. 59A, in particular embodiments, parts of computational unit 5900 can be implemented with one or more FPGAs. In the system of FIG. 59A, computational unit 5900 can include FPGA 5910 in which can be formed a DMA slave device module 5910a and arbiter 5910f. A DMA slave module 5910a can be any device suitable for attachment to a memory bus 5916 that can respond to DMA read/write requests. In alternate embodiments, a DMA slave module 5910a can be another interface capable of block data transfers over memory bus 5916. The DMA slave module 5910a can be capable of receiving data from a DMA controller (when it performs a read from a ‘memory’ or from a peripheral) or transferring data to a DMA controller (when it performs a write instruction on the DMA slave module 1590a). The DMA slave module 5910a may be adapted to receive DMA read and write instructions encapsulated over a memory bus, (e.g., in the form of a DDR data transmission, such as a packet or data burst), or any other format that can be sent over the corresponding memory bus.

A DMA slave module 1590a can reconstruct the DMA read/write instruction from the memory R/W packet. The DMA slave module 5910a may be adapted to respond to these instructions in the form of data reads/data writes to the DMA master, which could either be housed in a peripheral device, in the case of a PCIe bus, or a system DMA controller in the case of an ISA bus.

I/O data that is received by the DMA device 5910a can then be queued for arbitration. Arbitration is the process of scheduling packets of different flows, such that they are provided access to available bandwidth based on a number of parameters. In general, an arbiter provides resource access to one or more requestors. If multiple requesters request access, an arbiter 1590f can determine which requestor becomes the accessor and then passes data from the accessor to the resource interface, and the downstream resource can begin execution on the data. After the data has been completely transferred to a resource, and the resource has completed execution, the arbiter 5910f can transfer control to a different requester and this cycle repeats for all available requestors. In the embodiment of FIG. 59A, arbiter 15910 can notify other portions of computational unit 5900 (e.g., 5908) of incoming data.

Alternatively, a computation unit 5900 can utilize an arbitration scheme shown in U.S. Pat. No. 7,813,283, issued to Dalal on Oct. 12, 2010, the content of which are incorporated herein by reference. Other suitable arbitration schemes known in art could be implemented in embodiments herein. Alternatively, the arbitration scheme of the current invention might be implemented using an OpenFlow switch and an OpenFlow controller.

In the very particular embodiment of FIG. 59A, computational unit 5900 can further include notify/prefetch circuits 5910c which can prefetch data stored in a buffer memory 5910b in response to DMA slave module 5910a, and as arbitrated by arbiter 5910f. Further, arbiter 5910f can access other portions of the computational unit 5900 via a memory mapped I/O ingress path 5910e and egress path 5910g.

Referring to FIG. 59A, a hardware scheduler can include a scheduling circuit 5908b/n to implement traffic management of incoming packets. Packets from a certain source, relating to a certain traffic class, pertaining to a specific application or flowing to a certain socket are referred to as part of a session flow and are classified using session metadata. Such classification can be performed by classifier 5908e.

In some embodiments, session metadata 5908d can serve as the criterion by which packets are prioritized and scheduled and as such, incoming packets can be reordered based on their session metadata. This reordering of packets can occur in one or more buffers and can modify the traffic shape of these flows. The scheduling discipline chosen for this prioritization, or traffic management (TM), can affect the traffic shape of flows and micro-flows through delay (buffering), bursting of traffic (buffering and bursting), smoothing of traffic (buffering and rate-limiting flows), dropping traffic (choosing data to discard so as to avoid exhausting the buffer), delay jitter (temporally shifting cells of a flow by different amounts) and by not admitting a connection (e.g., cannot simultaneously guarantee existing service (SLAs) with an additional flow's (SLA).

According to embodiments, computational unit 5900 can serve as part of a switch fabric, and provide traffic management with depth-limited output queues, the access to which is arbitrated by a scheduling circuit 5908b/n. Such output queues are managed using a scheduling discipline to provide traffic management for incoming flows. The session flows queued in each of these queues can be sent out through an output port to a downstream network element.

It is noted that a conventional traffic management circuit doesn't take into account the handling and management of data by downstream elements except for meeting the SLA agreements it already has with said downstream elements.

In contrast, according to embodiments a scheduler circuit 5908b/n can allocate a priority to each of the output queues and carry out reordering of incoming packets to maintain persistence of session flows in these queues. A scheduler circuit 5908b/n can be used to control the scheduling of each of these persistent sessions into a general purpose operating system (OS) 5908j, executed on an offload processor 5908i. Packets of a particular session flow, as defined above, can belong to a particular queue. The scheduler circuit 5908b/n may control the prioritization of these queues such that they are arbitrated for handling by a general purpose (GP) processing resource (e.g., offload processor 5908i) located downstream. An OS 5908j running on a downstream processor 5908i can allocate execution resources such as processor cycles and memory to a particular queue it is currently handling. The OS 5908j may further allocate a thread or a group of threads for that particular queue, so that it is handled distinctly by the general purpose processing element 5908i as a separate entity. The fact that there can be multiple sessions running on a GP processing resource, each handling data from a particular session flow resident in a queue established by the scheduler circuit, to tightly integrate the scheduler and the downstream resource (e.g., 5908i). This can bring about persistence of session information across the traffic management and scheduling circuit and the general purpose processing resource 5908j.

Dedicated computing resources (e.g., 5908i), memory space and session context information for each of the sessions can provide a way of handling, processing and/or terminating each of the session flows at the general purpose processor 5908i. The scheduler circuit 5908b/n can exploit this functionality of the execution resource to queue session flows for scheduling downstream. The scheduler circuit 5908b/n can be informed of the state of the execution resource(s) (e.g., 5908i), the current session that is run on the execution resource, the memory space allocated to it, and the location of the session context in the processor cache.

According to embodiments, a scheduler circuit 5908b/n can further include switching circuits to change execution resources from one state to another. The scheduler circuit 5908b/n can use such a capability to arbitrate between the queues that are ready to be switched into the downstream execution resource. Further, the downstream execution resource can be optimized to reduce the penalty and overhead associated with context switch between resources. This is further exploited by the scheduler circuit 5908b/n to carry out seamless switching between queues, and consequently their execution as different sessions by the execution resource.

A scheduler circuit 5908b/n according to embodiments can schedule different sessions on a downstream processing resource, wherein the two are operated in coordination to reduce the overhead during context switches. An important factor to decreasing the latency of services and engineering computational availability can be hardware context switching synchronized with network queuing. In embodiments, when a queue is selected by a traffic manager, a pipeline coordinates swapping in of the cache (e.g., L2 cache) of the corresponding resource and transfers the reassembled I/O data into the memory space of the executing process. In certain cases, no packets are pending in the queue, but computation is still pending to service previous packets. Once this process makes a memory reference outside of the data swapped, the scheduler circuit can enable queued data from an I/O device 5902 to continue scheduling the thread.

In some embodiments, to provide fair queuing to a process not having data, a maximum context size can be assumed as data processed. In this way, a queue can be provisioned as the greater of computational resources and network bandwidth resources. As but one very particular example, a computation resource can be an ARM A9 processor running at 800 MHz, while a network bandwidth can be 3 Gbps of bandwidth. Given the lopsided nature of this ratio, embodiments can utilize computation having many parallel sessions (such that the hardware's prefetching of session-specific data offloads a large portion of the host processor load) and having minimal general purpose processing of data.

Accordingly, in some embodiments, a scheduler circuit 5908b/n can be conceptualized as arbitrating, not between outgoing queues at line rate speeds, but arbitrating between terminated sessions at very high speeds. The stickiness of sessions across a pipeline of stages, including a general purpose OS, can be a scheduler circuit optimizing any or all such stages of such a pipeline.

Alternatively, a scheduling scheme can be used as shown in U.S. Pat. No. 7,760,715 issued to Dalal on Jul. 20, 2010, incorporated herein by reference. This scheme can be useful when it is desirable to rate limit the flows for preventing the downstream congestion of another resource specific to the over-selected flow, or for enforcing service contracts for particular flows. Embodiments can include an arbitration scheme that allows for service contracts of downstream resources, such as general purpose OS that can be enforced seamlessly.

Referring still to FIG. 59A, a hardware scheduler according to embodiments herein, or equivalents, can provide for the classification of incoming packet data into session flows based on session metadata. It can further provide for traffic management of these flows before they are arbitrated and queued as distinct processing entities on the offload processors.

In some embodiments, offload processors (e.g., 5908i) can be general purpose processing units capable of handling packets of different application or transport sessions. Such offload processors can be low power processors capable of executing general purpose instructions. The offload processors could be any suitable processor, including but not limited to: ARM, ARC, Tensilica, MIPS, StrongARM or any other processor that serves the functions described herein. The offload processors have general purpose OS running on them, wherein the general purpose OS is optimized to reduce the penalty associated with context switching between different threads or groups of threads.

In contrast, context switches on host processors can be computationally intensive processes that require the register save area, process context in the cache and TLB entries to be restored if they are invalidated or overwritten. Instruction Cache misses in host processing systems can lead to pipeline stalls and data cache misses lead to operation stalls and such cache misses reduce processor efficiency and increase processor overhead.

Further, in contrast, an OS 5908j running on the offload processors 5908i in association with a scheduler circuit, can operate together to reduce the context switch overhead incurred between different processing entities running on it. Embodiments can include a cooperative mechanism between a scheduler circuit and the OS on the offload processor 5908i, wherein the OS sets up session context to be physically contiguous (physically colored allocator for session heap and stack) in the cache; then communicates the session color, size, and starting physical address to the scheduler circuit upon session initialization. During an actual context switch, a scheduler circuit can identify the session context in the cache by using these parameters and initiate a bulk transfer of these contents to an external low latency memory. In addition, the scheduler circuit can manage the prefetch of the old session if its context was saved to a local memory 5908g. In particular embodiments, a local memory 5908g can be low latency memory, such as a reduced latency dynamic random access memory (RLDRAM), as but one very particular embodiment. Thus, in embodiments, session context can be identified distinctly in the cache.

In some embodiments, context size can be limited to ensure fast switching speeds. In addition or alternatively, embodiments can include a bulk transfer mechanism to transfer out session context to a local memory 5908g. The cache contents stored therein can then be retrieved and prefetched during context switch back to a previous session. Different context session data can be tagged and/or identified within the local memory 5908g for fast retrieval. As noted above, context stored by one offload processor may be recalled by a different offload processor.

In the very particular embodiment of FIG. 59A, multiple offload processing cores can be integrated into a computation FPGA 5908. Multiple computational FPGAs can be arbitrated by arbitrator circuits in another FPGA 5910. The combination of computational FPGAs (e.g., 5908) and arbiter FPGAs (e.g., 1590) are referred to as “XIMM” modules or “Xockets DIMM modules” (e.g., computation unit 5900). In particular applications, these XIMM modules can provide integrated traffic and thread management circuits that broker execution of multiple sessions on the offload processors.

FIG. 59B shows a system flow according to an embodiment. Packet or other I/O data can be received at an I/O device 5920. An I/O device can be a physical device, virtual device or combination thereof. Interrupts generated from the I/O data intended for a host processor 5924 can be disabled, allowing such I/O data to be processed without resources of the host processor 5924.

An IOMMU can map received data to physical addresses of a system address space. DMA master can transmit such data to such memory addresses by operation of a memory controller 5922. Memory controller 5922 can execute DRAM transfers over a memory bus with a DMA Slave 5927. Upon receiving transferred I/O data, a hardware scheduler 5923 can schedule processing of such data with an offload processor. In some embodiments, a type of processing can be indicated by metadata within the I/O data. Further, in some embodiments such data can be stored in an Onboard Memory. According to instructions from hardware scheduler 5923, one or more offload processors 5926 can execute computing functions in response to the I/O data. In some embodiments, such computing functions can operate on the I/O data, and such data can be subsequently read out on memory bus via a read request processed by DMA Slave.

Various embodiments of the present invention will now be described in detail with reference to a number of drawings. The embodiments show processing modules, systems, and methods in which offload processors are included on in-line modules (IMs) that connect to a system memory bus. Such offload processors are in addition to any host processors connected to the system memory bus and can operate on data transferred over the system memory bus independent of any host processors. In particular, offload processors have access to a low latency context memory, which can enable rapid storage and retrieval of context data for rapid context switching. In very particular embodiments, processing modules can populate physical slots for connecting in-line memory modules (e.g., DIMMs) to a system memory bus.

In some embodiments, computing tasks can be automatically executed by offload processors according to data embedded within write data received over the system memory bus. In particular embodiments, such write data can include a “metadata” portion that identifies how the write data is to be processed.

Processor modules according to embodiments herein can be employed to accomplish various processing tasks. According to some embodiments, processor modules can be attached to a system memory bus to operate on network packet data. Such embodiments will now be described.

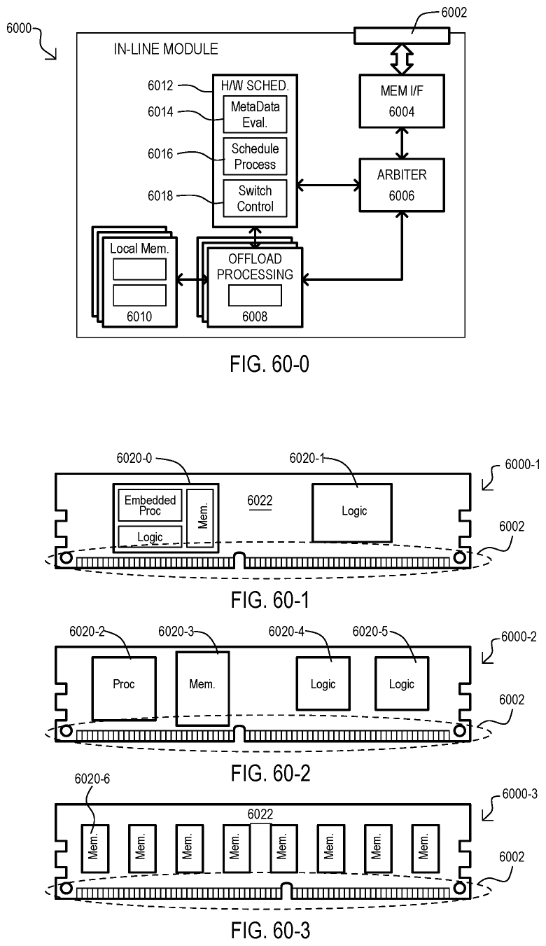

FIG. 60-0 is a block diagram of a processing module 6000 according to one embodiment. A processing module 6000 can include a physical in-line module connector 6002, a memory interface 6004, arbiter logic 6006, offload processor(s) 6008, local memory 6010, and control logic 6012. A connector 6002 can provide a physical connection to the system memory bus. This is in contrast to a host processor which can access a system memory bus via a memory controller, or the like. In very particular embodiments, a connector 6002 can be compatible with a dual in-line memory module (DIMM) slot of a computing system. Accordingly, a system including multiple DIMM slots can be populated with one or more processing modules 6000, or a mix of processing modules and DIMM modules.

A memory interface 6004 can detect data transfers on a system memory bus, and in appropriate cases, enable write data to be stored in the processing module 6000 and/or read data to be read out from the processing module 6000. In some embodiments, a memory interface 6004 can be a slave interface, thus data transfers are controlled by a master device separate from the processing module. In very particular embodiments, a memory interface 6004 can be a direct memory access (DMA) slave, to accommodate DMA transfers over a system memory initiated by a DMA master. Such a DMA master can be a device different from a host processor. In such configurations, processing module 6000 can receive data for processing (e.g., DMA write), and transfer processed data out (e.g., DMA read) without consuming host processor resources.

Arbiter logic 6006 can arbitrate between conflicting accesses data within processing module 6000. In some embodiments, arbiter logic 6006 can arbitrate between accesses by offload processor 6008 and accesses external to the processor module 6000. It is understood that a processing module 6000 can include multiple locations that are operated on at the same time. It is understood that accesses that are arbitrated by arbiter logic 6006 can include accesses to physical system memory space occupied by the processor module 6000, as well as accesses to resources (e.g., processor resources). Accordingly, arbitration rules for arbiter logic 6006 can vary according to application. In some embodiments, such arbitration rules are fixed for a given processor module 6000. In such cases, different applications can be accommodated by switching out different processing modules. However, in alternative embodiments, such arbitration rules can be configurable.

Offload processor 6008 can include one or more processors that can operate on data transferred over the system memory bus. In some embodiments, offload processors can run a general operating system, enabling processor contexts to be saved and retrieved. Computing tasks executed by offload processor 6008 can be controlled by the hardware scheduler. Offload processors 6008 can operate on data buffered in the processor module. In addition or alternatively, offload processors 6008 can access data stored elsewhere in a system memory space. In some embodiments, offload processors 6008 can include a cache memory configured to store context information. An offload processor 6008 can include multiple cores or one core.

A processor module 6000 can be included in a system having a host processor (not shown). In some embodiments, offload processors 6008 can be a different type of processor as compared to the host processor. In particular, offload processors 6008 can consume less power and/or have less computing power than a host processor. In very particular embodiments, offload processors 6008 can be “wimpy” core processors, while a host processor can be a “brawny” core processor. Of course, in alternative embodiments, offload processors 6008 can have equivalent computing power to any host processor.

Local memory 6010 can be connected to offload processor 6008 to enable the storing of context information. Accordingly, an offload processor 6008 can store current context information, and then switch to a new computing task, then subsequently retrieve the context information to resume the prior task. In very particular embodiments, local memory 6010 can be a low latency memory with respect to other memories in a system. In some embodiments, storing of context information can include copying an offload processor 6008 cache.

In some embodiments, the same space within local memory 6010 is accessible by multiple offload processors 6008 of the same type. In this way, a context stored by one offload processor can be resumed by a different offload processor.

Control logic 6012 can control processing tasks executed by offload processor(s). In some embodiments, control logic 6012 can be considered a hardware scheduler that can be conceptualized as including a data evaluator 6014, scheduler 6016 and a switch controller 6018. A data evaluator 6014 can extract “metadata” from write data transferred over a system memory bus. “Metadata”, as used herein, can be any information embedded at one or more predetermined locations of a block of write data that indicates processing to be performed on all or a portion of the block of write data. In some embodiments, metadata can be data that indicates a higher level organization for the block of write data. As but one very particular embodiment, metadata can be header information of network packet (which may or may not be encapsulated within a higher layer packet structure).

A scheduler 6016 can order computing tasks for offload processor(s) 6008. In some embodiments, scheduler 6016 can generate a schedule that is continually updated as write data for processing is received. In very particular embodiments, a scheduler 6016 can generate such a schedule based on the ability to switch contexts of offload processor(s) 6008. In this way, module computing priorities can be adjusted on the fly. In very particular embodiments, a scheduler 6016 can assign a portion of physical address space to an offload processor 6008, according to computing tasks. The offload processor 6008 can then switch between such different spaces, saving context information prior to each switch, and subsequently restoring context information when returning to the memory space.

Switch controller 6018 can control computing operations of offload processor(s) 6008. In particular embodiments, according to scheduler 6016, switch controller 6018 can order offload processor(s) 6010 to switch contexts. It is understood that a context switch operation can be an “atomic” operation, executed in response to a single command from switch controller 6018. In addition or alternatively, a switch controller 6018 can issue an instruction set that stores current context information, recalls context information, etc.

In some embodiments, processor module 6000 can include a buffer memory (not shown). A buffer memory can store received write data on board the processor module. A buffer memory can be implemented on an entirely different set of memory devices or can be a memory embedded with logic and/or the offload processor. In the latter case, arbiter logic 6006 can arbitrate access to the memory. In some embodiments, a buffer memory can correspond to a portion of a system's physical memory space. The remaining portion of the system memory space can correspond to other processor modules and/or memory modules connected to the same system memory bus. In some embodiments buffer memory can be different from local memory 6010. For example, buffer memory can have a slower access time than local memory 6010. However, in other embodiments, buffer memory and local memory can be implemented with memory devices.

In very particular embodiments, write data for processing can have an expected maximum flow rate. A processor module 6000 can be configured to operate on such data at, or faster than, such a flow rate. In this way, a master device (not shown) can write data to a processor module without danger of overwriting data “in process”.

The various computing elements of a processor module 6000 can be implemented as one or more integrated circuit devices (ICs). It is understood that the various components shown in FIG. 60-00 can be formed in the same or different ICs. For example, control logic 6012, memory interface 6014, and/or arbiter logic 6006 can be implemented on one or more logic ICs, while offload processor(s) 6008 and local memory 6010 are separate ICs. Logic ICs can be fixed logic (e.g., application specific ICs), programmable logic (e.g., field programmable gate arrays, FPGAs), or combinations thereof.

FIG. 60-1 shows a processor module 6000-1 according to one very particular embodiment. A processor module 6000-1 can include ICs 6020-0/1 mounted to a printed circuit board (PCB) type substrate 6022. PCB type substrate 6022 can include in-line module connector 6002, which in one very particular embodiment, can be a DIMM compatible connector. IC 6020-0 can be a system-on-chip (SoC) type device, integrated with multiple functions. In the very particular embodiment shown, an IC 6020-0 can include embedded processor(s), logic and memory. Such embedded processor(s) can be offload processor(s) 6008 as described herein, or equivalents. Such logic can be any of controller logic 6012, memory interface 6004 and/or arbiter logic 6006, as described herein, or equivalents. Such memory can be any of local memory 6010, cache memory for offload processor(s) 6008, or buffer memory, as described herein, or equivalents. Logic IC 6020-1 can provide logic functions not included IC 6020-0.

FIG. 60-2 shows a processor module 6000-2 according to another embodiment. A processor module 6000-2 can include ICs 6020-2, -3, -4, -5 mounted to a PCB type substrate 6022, like that of FIG. 60-1. However, unlike FIG. 60-1, processor module functions are distributed among single purpose type ICs. IC 6020-2 can be a processor IC, which can be an offload processor 6008. IC 6020-3 can be a memory IC which can include local memory 6010, buffer memory, or combinations thereof. IC 6020-4 can be a logic IC which can include control logic 6012, and in one very particular embodiment, can be an FPGA. IC 6020-5 can be another logic IC which can include memory interface 6004 and arbiter logic 6006, and in one very particular embodiment, can also be an FPGA.

It is understood that FIGS. 60-1/2 represent but two of various implementations. The various functions of a processor module can be distributed over any suitable number of ICs, including a single SoC type IC.

FIG. 60-3 shows an opposing side of a processor module 6000-3 according to an embodiment. Processor module 6000-3 can include a number of memory ICs, one shown as 6020-6, mounted to a PCB type substrate 6022, like that of FIG. 60-01. It is understood that various processing and logic components can be mounted on an opposing side to that shown. A memory ICs 6020-5 can be configured to represent a portion of the physical memory space of a system. Memory ICs 6020-6 can perform any or all of the following functions: operate independently of other processor module components, providing system memory accessed in a conventional fashion; serve as buffer memory, storing write data that can be processed with other processor module components; serve as local memory for storing processor context information.

FIG. 60-3 can also show a conventional DIMM module (i.e., it serves only a memory function) that can populate a memory bus along with processor modules as described herein, or equivalents.

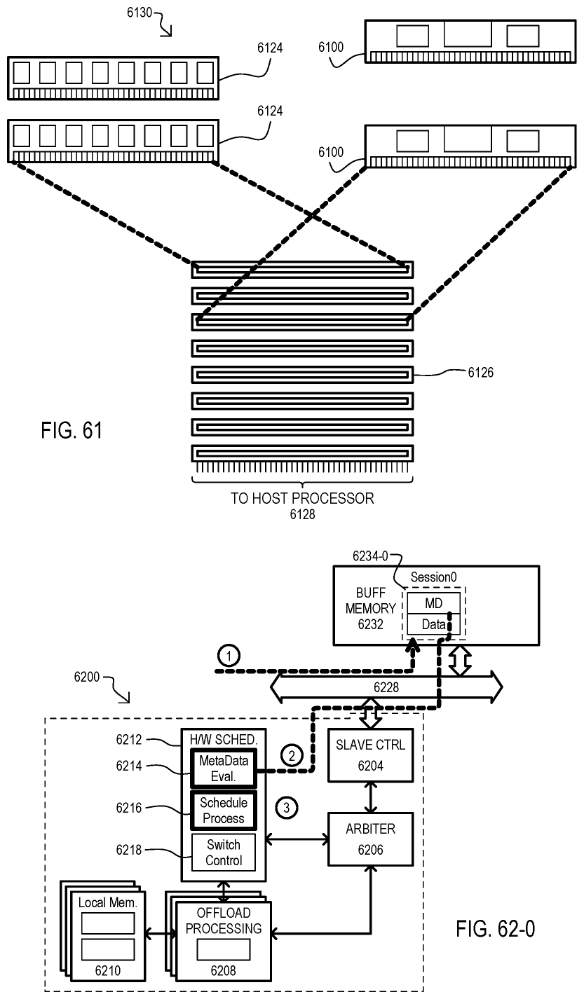

FIG. 61 shows a system 6130 according to one embodiment. A system 6130 can include a system memory bus 6128 accessible via multiple in-line module slots (one shown as 6126). According to embodiments, any or all of the slots 6126 can be occupied by a processor module 6100 as described herein, or an equivalent. In the event all slots 6126 are not occupied by a processor module 6100, available slots can be occupied by conventional in-line memory modules 6124. In a very particular embodiment, slots 6126 can be DIMM slots.

In some embodiments, a processor module 6100 can occupy one slot. However, in other embodiments, a processor module can occupy multiple slots.

In some embodiments, a system memory bus 6128 can be further interfaced with one or more host processors and/or input/output device (not shown).

Having described processor modules according to various embodiments, operations of a processor module according to particular embodiments will now be described.

FIGS. 62-0 to 62-5 show processor module operations according to various embodiments. FIGS. 62-0 to 62-5 show a processor module like that of FIG. 60-0, along with a system memory bus 6228, and a buffer memory 6232. It is understood that a buffer memory 6232 can be part of processor module 6200. In such a case, arbitration between accesses via system memory 6228 and offload processors can be controlled by arbiter logic 6206.

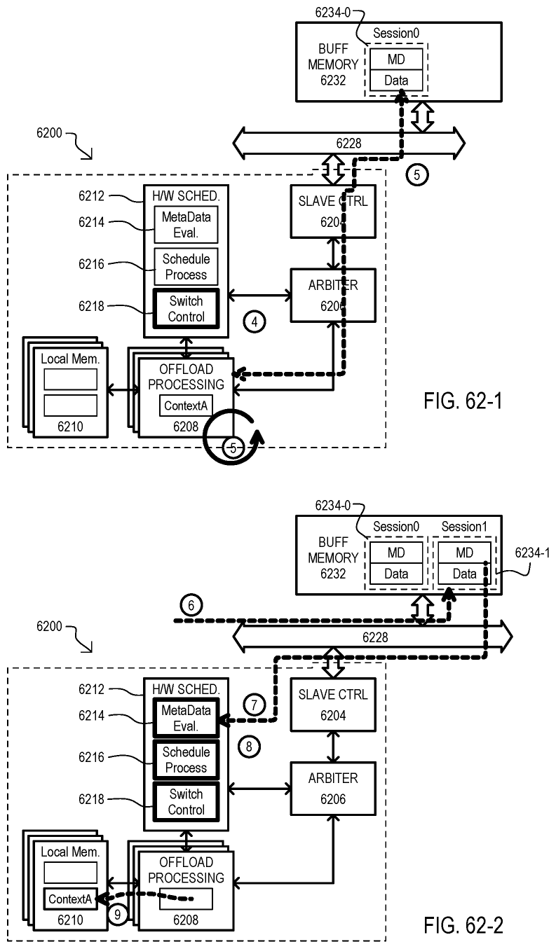

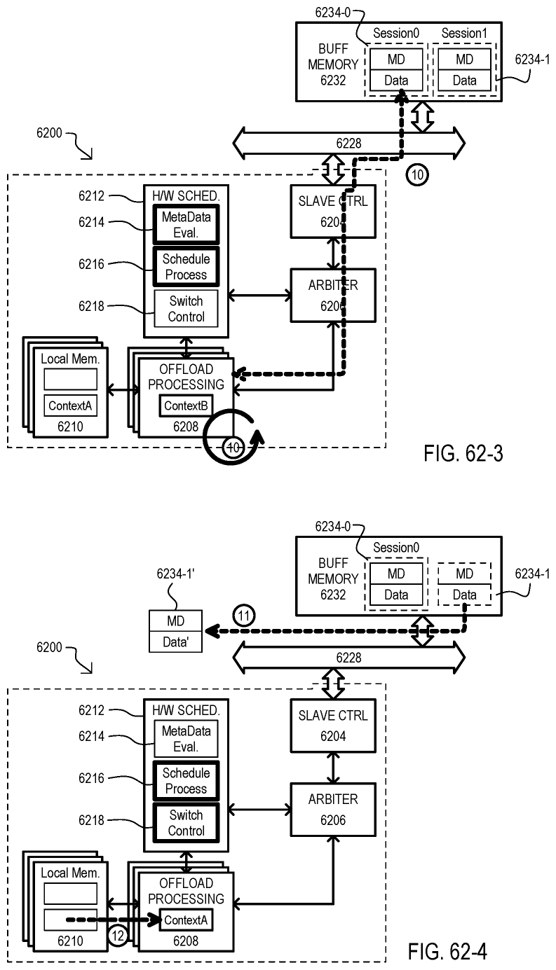

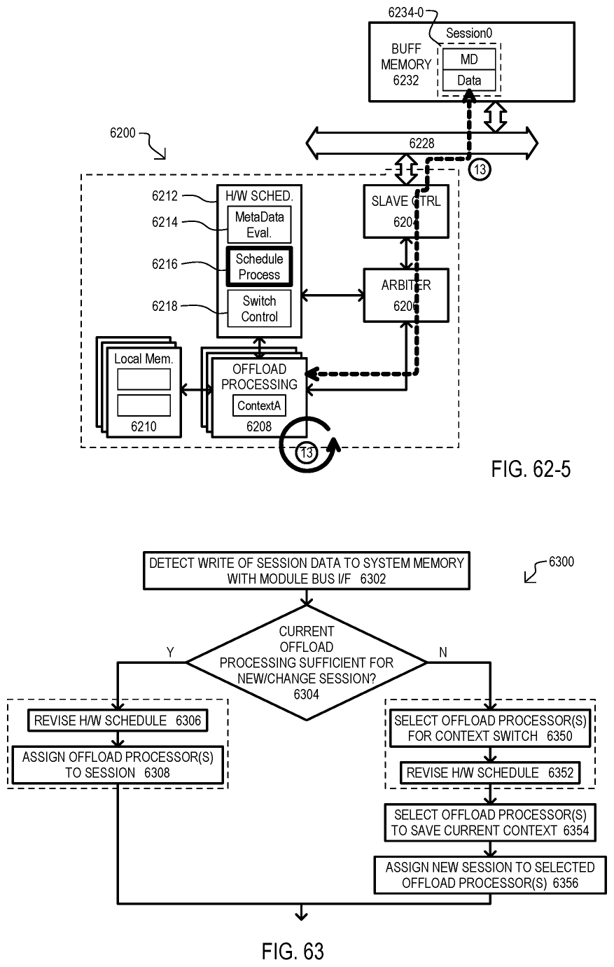

Referring to FIG. 62-0, write data 6234-0 can be received on system memory bus 6228 (circle “1”). In some embodiments, such an action can include the writing of data to a particular physical address space range of a system memory. In a very particular embodiment, such an action can be a DMA write independent of any host processor. Write data 6234-0 can include metadata (MD) as well as data to be processed (Data). In the embodiment shown, write data 6234-0 can correspond to a particular processing operation (Session0).

Control logic 6212 can access metadata (MD) of the write data 6234-0 to determine a type of processing to be performed (circle “2”). In some embodiments, such an action can include a direct read from a physical address (i.e., MD location is at a predetermined location). In addition or alternatively, such an action can be an indirect read (i.e., MD is accessed via pointer, or the like). The action shown by circle “2” can be performed by any of: a read by control logic 6212 or read by an offload processor 6208.

From extracted metadata, scheduler 6216 can create a processing schedule, or modify an existing schedule to accommodate the new computing task (circle “3”).

Referring to FIG. 62-1, in response to a scheduler 6216, switch controller 6218 can direct one or more offload processors 6208 to begin processing data according to MD of the write data (circles “4”, “5”). Such processing of data can include any of the following and equivalents: offload processor 6208 can process write data stored in a buffer memory of the processor module 6200, with accesses being arbitrated by arbiter logic 6206, offload processor 6208 can operate on data previously received, offload processor 6208 can receive and operation on data stored at a location different than the processor module 6200.

Referring to FIG. 62-2, additional write data 6234-1 can be received on system memory bus 6228 (circle “6”). Write data 6234-1 can be MD that indicates a different processing operation (Session1) than that for write data 6234-0. Control logic 6212 can access metadata (MD) of the new write data 6234-1 to determine a type of processing to be performed (circle “7”). From extracted metadata, scheduler 6216 can modify the current schedule to accommodate the new computing task (circle “8”). In the particular example shown, the modified schedule re-tasks offload processor 6208. Thus, switch controller 6218 can direct the offload processor 6208 to store its current context (ContextA) in local memory 6210 (circle “9”).

Referring to FIG. 62-3, in response to switch controller 6218, offload processor(s) 6208 can begin the new processing task (circle “10”). Consequently, offload processor(s) 6208 can maintain a new context (ContextB) corresponding to the new processing task.

Referring to FIG. 62-4, a processing task by offload processor 6208 can be completed. In the very particular embodiment shown, such processing can modify write data 6234-1, and such data can be read out over system memory bus 6228 (circle “11”). In response to the completion of the processing task, scheduler 6216 can update a schedule. In the example shown, in response to the updated schedule, switch controller 6218 can direct offload processor(s) 6208 to restore the previously saved context (ContextA) from local memory 6210 (circle “12”). As understood from above, a restored context (e.g., ContextA) may have been stored by an offload processor different from the one that saved the context in the first place.

Referring to FIG. 62-5, with a previous context restored, offload processor(s) 6208 can return to processing data according to the previous task (Session0) (circle “13”).

FIG. 63 shows a method 6340 according to an embodiment. A method 6340 can include detecting the write of session data to a system memory with an in-line module slave interface 6342. Such an action can include determining if received write data has metadata (i.e., data identifying a particular processing). It is understood that “session data” is data corresponding to a particular processing task. Further, it is understood that MD accompanying (or embedded within) session data can identify sessions having priorities with respect to one another.

A method 6340 can determine if current offload processing is sufficient for a new session or change of session 6344. Such an action can take into account a processing time required for any current sessions.

If current processing resources can accommodate new session requirements (Y from 6344), a hardware schedule (schedule for controlling offload processor(s)) can be revised 6346 and the new session can be assigned to an offload processor 6348. If current processing resources cannot accommodate new session requirements (N from 6344), one or more offload processors can be selected for re-tasking (e.g., a context switch) 6350 and the hardware schedule can be modified accordingly 6352. The selected offload processors can save their current context data 6354 and then switch to the new session 6356.

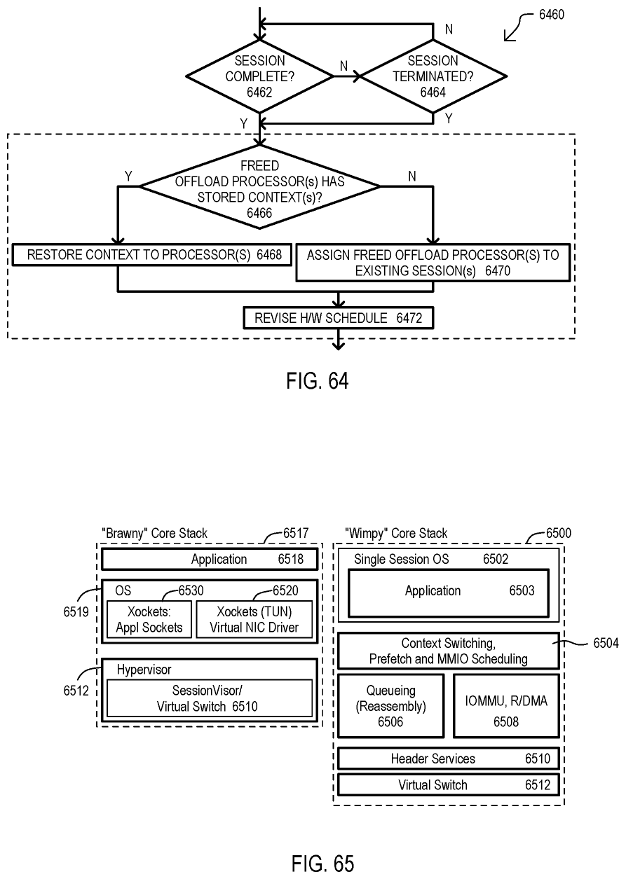

FIG. 64 shows a method 6460 according to another embodiment. A method 6460 can include determining if a computing session for an offload processor is complete 6462 or has been terminated 6464. In such cases (Y from 6462/6464), it can be determined if the freed in-line module offload processor (i.e., an offload processor whose session is complete/terminated) has a stored context 6466. That is, it can be determined if the freed processor was previously operating on a session.

If a free offload processor was operating according to another session (Y from 6466), the offload processor can restore the previous context 6468. If a free offload processor has no stored context, it can be assigned to an existing session (if possible) 6420. An existing hardware schedule can be updated correspondingly 6472.

Parallelization of tasks into multiple thread contexts is well known in art to provide for increased throughput. Processor architectures such as MIPS may include deep instructions pipelines to improve the number of instructions per cycle. Further, the ability to run a multi-threaded programming environment results in enhanced usage of existing processor resources. To further increase parallel execution on the hardware, processor architecture may include multiple processor cores. Multi-core architectures consisting of the same type of cores, referred to as homogeneous core architectures, provide higher instruction throughput by parallelizing threads or processes across multiple cores. However, in such homogeneous core architectures, the shared resources, such as memory, are amortized over a small number of processors.

Memory and I/O accesses can incur a high amount of processor overhead. Further, context switches in conventional general purpose processing units can be computationally intensive. It is therefore desirable to reducing context switch overhead in a networked computing resource handling a plurality of networked applications in order to increase processor throughput. Conventional server loads can require complex transport, high memory bandwidth, extreme amounts of data bandwidth (randomly accessed, parallelized, and highly available), but often with light touch processing: HTML, video, packet-level services, security, and analytics. Further, idle processors still consume more than 50% of their peak power consumption.

In contrast, according to embodiments herein, complex transport, data bandwidth intensive, frequent random access oriented, ‘light’ touch processing loads can be handled behind a socket abstraction created on the offload processor cores. At the same time, “heavy” touch, computing intensive loads can be handled by a socket abstraction on a host processor core (e.g., x86 processor cores). Such software sockets can allow for a natural partitioning of these loads between ARM and x86 processor cores. By usage of new application level sockets, according to embodiments, server loads can be broken up across the offload processing cores and the host processing cores.

FIG. 65 shows protocol stacks that can be included in a system according to embodiments. A host processor (e.g. 5906c) can include a brawny core protocol stack 6517. Such a protocol stack includes one or more applications (Application) 6518 sitting on an operating system (OS) 6519. Unlike conventional host processing stacks, an OS 6519 can include a Xockets Socket 6530 and Xockets Tunneling Driver 6520 which can access XIMMs as described herein or equivalents. A host processor stack can further include a Hypervisor 6512 to supervise sessions and/or enable virtual switches 6510.

An offload processor can include wimpy core protocol stack 6500. In the embodiment shown, such a protocol stack can include a single session OS 6502 which can run an application 6503. Wimpy core protocol stack 6500 can further include context switching, prefetching, and memory mapped I/O scheduling 6504. Further, packet queuing functions 6506 and DMA functions (Xockets IOMMU/RDMA) 6508 are included. Header services 6510 can process header data. In addition, packet switching functions 6512 can also be included (Xockets virtual switch).

Example embodiments of offload processors can include, but are not limited to, ARM A9 Cortex processors, which have a clock speed of 800 MHz and a data handling capacity of 3 GHz. The queue depth for the traffic management circuit can be configured to be the smaller of the processing power and the network bandwidth. Given the lopsided nature of this ratio, in order to handle complete network bandwidth, sessions can be of a lightweight processing nature. Further, sessions can be switched with minimum context switch overhead to allow the offload processor to process the high bandwidth network traffic. Further, the offload processors can provide session handling capacity greater than conventional approaches due to the ability to terminate sessions with little or no overhead. The offload processors of the present invention are favorably disposed to handle complete offload of Apache video routing, as but one very particular embodiment.

Alternatively in another embodiment, when equipped with many XIMMs, each containing multiple “wimpy” cores, systems may be placed near the top of rack, where they can be used as a cache for data and a processing resource for rack hot content or hot code, a means for interconnecting between racks and TOR switches, a mid-tier between TOR switches and second-level switches, rack-level packet filtering, logging, and analytics, or various types of rack-level control plane agents. Simple passive optical mux/demux-ing can separate high bandwidth ports on the x86 systems into many lower bandwidth ports as needed.

Embodiments can be favorably disposed to handle Apache, HTML, and application cache and rack level mid plane functions. In other embodiments, a network of XIMMs and a host x86 processor may be used to provide routing overlays.

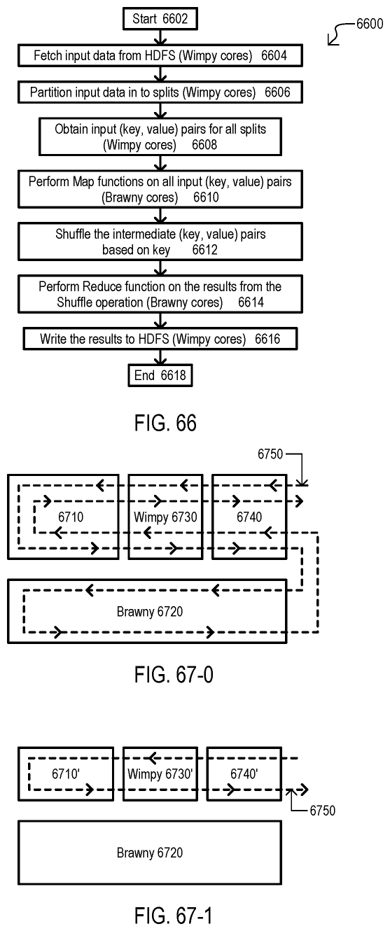

In another embodiment shown in FIG. 66, a complex publish and subscribership model, for handling pipelined computational tasks partitioned across a network of x86 cores and offload processor cores, can be implemented. Each task in the pipeline may be handled by the type of cores that are most favorably disposed for it. For example, Xockets DIMMs may be employed to carry out acceleration of Map-Reduce algorithms by an order of magnitude. The mid-plane defined by Xockets DIMMs can drive and receive the large PCI-e 3.0 bandwidth connecting Map steps with Reduce steps within a rack and outside of the rack. Because the shuffle step is often the bottleneck, the number of reducers is kept to a minimum so that CPUs are not overwhelmed with having to filter keys. With traffic-managed according to embodiments, the number of Reducers can rival the number of Mappers.

FIG. 66 shows a method 6600 which can start 6602 and fetch input data from a file system (e.g., Hadoop Distributed File System) 6604. Such data can be fetched to wimpy core devices (e.g., offload processors as described herein or equivalents) 6606. Such input data can be partitioned into splits by the wimpy core devices. Input pairs (which can include a key and value) for such splits can be obtained 6608. A map function can be performed on all input pairs with brawny core devices (e.g., host processor(s)) 6610. All the mapping operation results can be reduced and sorted based on key values with brawny core devices 6612. Reduce functions on the results from the shuffle operation can be performed (by Brawny cores) for example 6614. Results can be written back to the file system 6614. Such an operation can be accomplished via wimpy core devices. A method may then end 6618.

FIG. 67-0 is a flow schematic wherein a server can receive packets via an interface 6740. Packet loads are partitioned such that packet meta data processing, routing overlays, filtering, packet logging and other hygiene functions are offloaded to the offload processors (6730) mounted with memory devices 6710, while the host processor (6720) implements server sessions. Offload processors 6730 can be wimpy core devices, while host processor 6720 can be a brawny core device.

FIG. 67-1 is a flow schematic wherein network packets 6750 are transferred to offload processors (6730′) mounted with memory device 6710′, which can be wimpy core devices, completely without intervention of the host CPU (6720), which can be a brawny core device. The offload processors 6730′ can act as full-fledged processors hosting server applications. In one embodiment, packets 6750 can be received via an I/O device 6740′ (e.g., NIC).

In another embodiment, a network of XIMMs, each comprising a plurality of said offload processors may be employed to provide video overlays by associating said offload processors with local memory elements, including closely located DIMMs or solid state storage devices (SSDs). The network of XIMM modules may be used to perform memory read or writes for prefetching the data contents before they are serviced. In this case, real-time transport protocol (RTP) can be processed before packets enter traffic management, and their corresponding video data can be pre-fetched to match the streaming. Prefetches can be physically issued as (R)DMAs to other (remote) local DIMMs/SSDs. For enterprise applications, the number of the videos is limited and can be kept in local Xockets DIMMs. For public cloud/content delivery network (CDN) applications, this allows a rack to provide a shared memory space for the corpus of videos. The prefetching may be set up from any memory DIMM on any machine.

It is anticipated that prefetching can be balanced against peer-to-peer distribution protocols (e.g. P4P) so that blocks of data can be efficiently sourced from all relevant servers. The bandwidth metric indicates how many streams can be sustained when using 10 Mbps (1 Mbps) streams. As the stream bandwidth goes down the number of streams goes up and the same session limitation becomes manifest in the RTP processing of the server. The invention's architecture allows over 10,000 high definition streams to be sustained in a 1U form factor.

Alternatively, embodiments can employ the Xocket DIMMs to implement rack level disks using memory mapped file paradigm. Such embodiments can effectively unify all of the contents on the Xockets DIMMs on the rack to every x86 processor socket.

Described embodiments can also relate to network overlay services that are provided by a memory bus connected module that receives data packets and routes them to general purpose offload processors for packet encapsulation, decapsulation, modification, or data handling. Transport over the memory bus can permit higher packet handling data rates than systems utilizing conventional input/output connections.

A method for efficiently providing network tunneling services for network overlay operations is described. Incoming packet data is converted to a memory bus compatible protocol and transferred to offload processors for further modifications. Modified packets are sent back onto the memory bus for transfer to a network, memory unit, or host processor.

A DIMM mountable module configured to provide access to multiple offload processors is described. The DIMM mountable module includes a memory bus in connection with a host processor but does not require operation of the host processor to modify network packets.

A server with a host processor can be connected to an offload processor module capable of handling the routine packet modifications required for network overlay services, with little or no assistance from the host processor.

One or more offload processors used for network overlay services are described. The offload processors are connected via a memory bus to an offload processing module having an associated memory, and do not require operation of the host or server processor for operation.

Modem computing systems can be arranged to support a variety of intercommunication protocols. In certain instances, computers can connect with each other using one network protocol, while appearing to outside users to use another network protocol. Commonly termed an “overlay” network, such computer networks are effectively built on the top of another computer network, with nodes in the overlay network being connected by virtual or logical links to the underlying network. For example, some types of distributed cloud systems, peer-to-peer networks, and client-server applications can be considered to be overlay networks that run on top of conventional Internet TCP/IP protocols. Overlay networks are of particular use when a virtual local network must be provided using multiple intermediate physical networks that separate the multiple computing nodes. The overlay network may be built by encapsulating communications and embedding virtual network address information for a virtual network in a larger physical network address space used for a networking protocol of the one or more intermediate physical networks.

Overlay networks are particularly useful for environments where different physical network servers, processors, and storage units are used, and network addresses to such devices may commonly change. An outside user would ordinarily prefer to communicate with a particular computing device using a constant address or link, even when the actual device might have a frequently changing address. However, overlay networks do require additional computational processing power to run, so efficient network translation mechanisms are necessary, particularly when large numbers of network transactions occur.

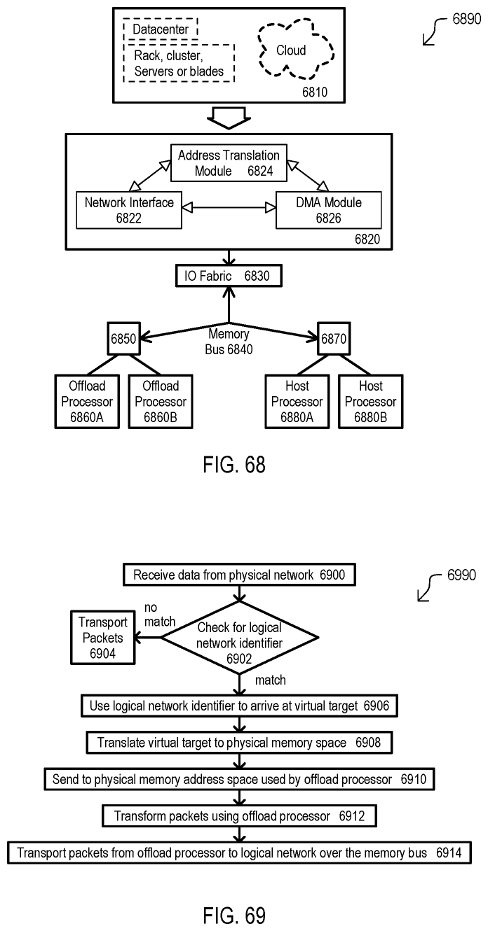

FIG. 68 is a diagram of a system 6890 for providing network overlay services that includes a data source 6810 which may be provided by Internet, cloud, inter- or intra-data center networks, cluster computers, rack systems, multiple or individual servers or personal computers, or the like. Data from data source 6810 can be packet or switch based, although in preferred embodiments non-packet data is generally converted or encapsulated into packets for ease of handling. The data is passed through a data transport module 6820 that includes a network interface 6822, an address translation module 6824, and first direct memory address (DMA) module 6826. Typically, the data is packetized or converted into a particular packet format supported by an input/output (IO) fabric 6830 and a memory bus interconnect 6840. Both an offload processing module 6850 and host processor support module 6870 (generally including a DMA controller) can be connected to the memory bus interconnect 6840. For packets identified by a logical network identifier or other suitable indicator as requiring network overlay services, the address translation module 6824 can direct them to the offload processing module 6850, where offload processors 6860A/B can add or subtract packet metadata, encapsulate or decapsulate, packets, provide hardware address or location conversions, or any required network overlay services. Advantageously, little or no processing is required of the host processor 6880A/B, which is free to continue with its own processing operations.

Data transport module 6820 can be an integrated or separately attached subsystem that includes modules or components such as network interface 6822, address translation module 6824, and a first DMA module 6826. IO Fabric 30 can be based on conventional IO buses such as PCI, Fibre Channel and the like

Memory Bus Interconnect 6840 can be based on relevant JEDEC standards, on DIMM data transfer protocols, on Hypertransport, or any other high speed, low latency interconnection system.

Offload Processing Module 6850 includes memory, logic etc., for a processor. Offload processors 6860A/B can be general purpose processors, including but limited to those based on ARM architecture, IBM Cell architecture, network processors, or the like.

Host processor 6880A/B can be a general purpose processor, including those based on Intel or AMD x86 architecture, Intel Itanium architecture, MIPS architecture, SPARC architecture or the like.

FIG. 69 is a flow chart illustrating an exemplary method 6990 of providing network overlay services. Incoming packets or data can be received from a physical network 100, including but limited to wired, wireless, optical, switched, or packet based networks. Packets without a logical network identifier are transported as required by protocol (6904), while packets with a logical network identifier are segregated for further processing. Such processing can include determination of a particular virtual target (6906) on the network, and the appropriate translation into a physical memory space (6908). The packet is then sent to a physical memory address space using an offload processor (6910). Packets are transformed in some manner (6912) by the offload processor and transported back onto another logical network over the memory bus (6914).

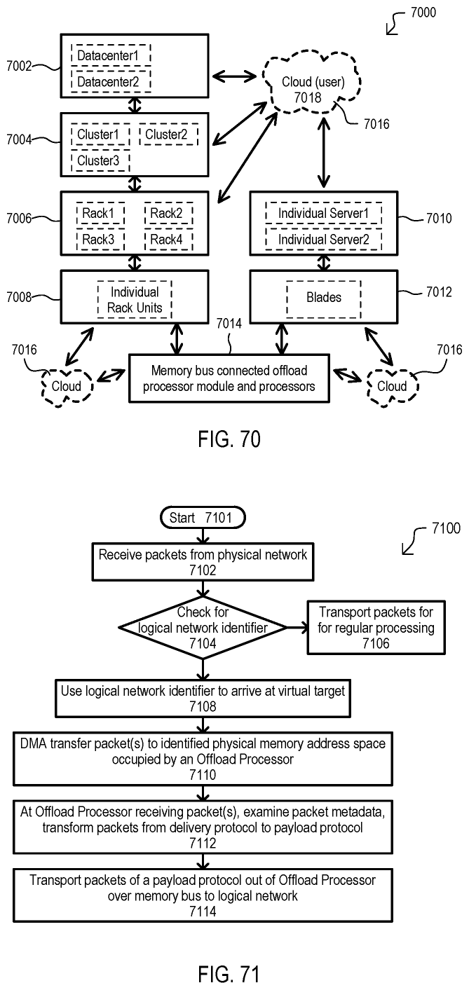

FIG. 70 is a representative data transport system 7000 providing network overlay services for multiple networks, servers, and devices according to an embodiment. The system 7000 accomplishes this in part by utilizing hardware and logic capable of memory bus mediated data modification using offload processors connected to the memory bus via an offload processor module. A system 7000 can include data centers 7002, clusters 7004, racks 7006, individual rack units 7008, individual servers 7010, blades 7012 and offload processor modules 7014. Offload processor modules 7014 can communicate directly with rack units 7008 and/or blades 7012, or via a network 7016.

As seen in FIG. 70, the offload processor module 7014 can reside on individual rack units 7008 or blades 7012, that in turn can reside on racks 7006 or individual servers 7010. These can be further grouped into clusters 7004 and datacenters 7002, which can be spatially located in the same building, in the same city, or even in different countries. Any grouping level can be connected to each other, and/or connected to public or private cloud internets, if desired.

As will be understood, a user 7018 may operate any appropriate device operable to send and receive network requests, messages, or information over an appropriate network and convey information back to a user of the device. Examples of such client devices include personal computers, tablets, cell phones, handheld messaging devices, laptop computers, set-top boxes, personal data assistants, or electronic book readers. The network can include any appropriate network, including an intranet, the Internet, a cellular network, a local area network, or any other such network or combination thereof. Communication over the network can be enabled by wired or wireless connections, and combinations thereof.

The illustrative environment includes plurality of resources, servers, hosts, instances, routers, switches, data stores, and/or other such components capable of interacting with clients or each other. It should be understood that there can be several application servers, layers, or other elements, processes, or components, which perform tasks such as obtaining data from an appropriate data store. Data store can refer to any device capable of storing, accessing, and retrieving data, which may include data servers, databases, data storage devices, and data storage media, alone or in combination.

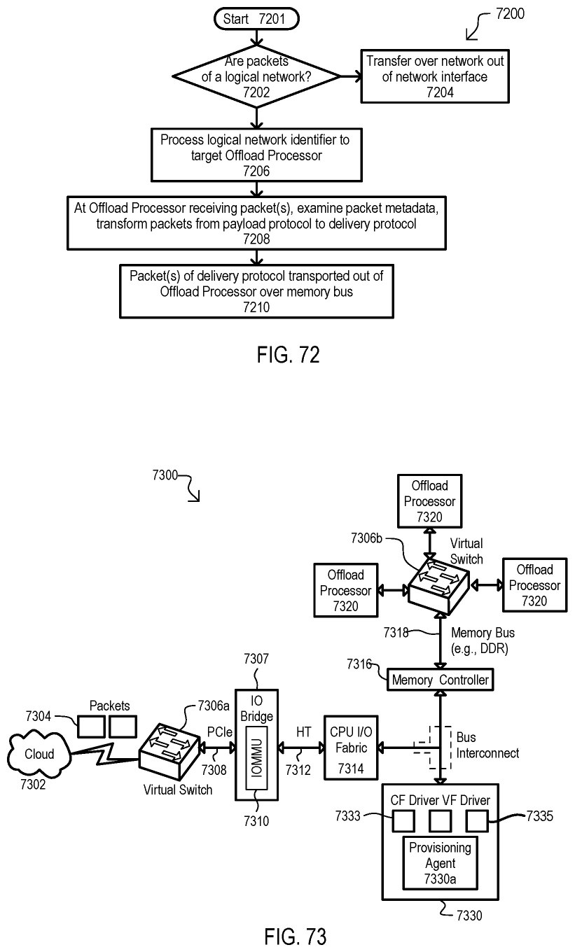

FIGS. 71 and 72 are flow diagrams showing encapsulation and decapsulation operations according to embodiments. Such operations can be useful for IPV4 and IPV6 interconversion. Encapsulation can include converting protocols of IPV6 (which cannot be transported over a IPv4 network) into protocols of IPV4 so that they could be transported over a network. The conversion can include segmenting packets (if they are too large) and adding IPv4 headers and packet identifiers if any. A final packet can be in IPv4 format. Such a final packet can be tunneled over DDR bus to Network interface card for transfer over network.

Decapsulation can include converting protocols of IPV4 (contain IPv6 protocol packets as payload) into protocols of IPv6 so that they could be transported to a host processor that has an IPv6 address. The conversion consists of reassembling packets (if they were segmented) and removing IPv4 headers and packet identifiers if any. A final packet can be in IPv6 format. Such a packet can then be tunneled over a DDR bus to host processor.

Referring to FIG. 71, an operation can start 7101 and receive packets from physical network 7102. A packet can be checked for logical network identifier 7104. For no logical network identifiers or non-applicable logical network identifiers, the packet can be transported for regular processing 7106. For applicable logical network identifiers, the logical network identifier can be used to arrive at a virtual target 7108. One or more DMA transfers can transfer the packet to an identified physical memory address space occupied by an offload processor 7110. At the offload processor(s), the packet metadata can be examined, and packets transformed from a delivery protocol to a payload protocol 7112. Payload protocol packets can be transported out of offload processor(s) over a memory bus to a logical network 7114.

Referring to FIG. 72, an operation can start 7201 and determine if packets are from a logical network 7202. If packets are not from one or more particular logical networks, the packets can be transferred out of a network interface over a network 7204. If packets are from one or more particular logical networks, the logical network identifier can be processed to identify a target offload processor 7206. At an offload processor receiving packets, the packet metadata can be examined, and the packets transformed from a payload protocol to a transport protocol 7208. Packets of the delivery protocol can be transported out of the offload processor over a memory bus 7210.

Embodiments disclosed herein can be related to IO virtualization schemes that enable transfer of data between network interfaces and a plurality of offload processors. The IO virtualization schemes allow a single physical IO device to appear as multiple IO devices. The offload processors can use these multiple IO devices for receiving and transmitting network traffic.

Offload processors can be low power general purpose processors capable of handling network traffic. The offload processors can be embedded and integrated into memory modules such as DIMM modules. The system enables transfer of packets to different offload processors using networking schematics and DMA. By using software defined networks and OpenFlow principles in combination with DMA operations, virtual switches transfer packets to and from the desired destination offload processors. By using virtual switches, characteristics of traffic flow are preserved.

Computing systems conventionally implement memory management to translate addresses from a virtual address space used by each I/O device to a physical address corresponding to the actual system memory. This I/O memory management unit (IOMMU) may include various memory protections and may restrict access to certain pages of memory to particular I/O devices. The use of such memory management techniques help protect the main memory as well as improve system performance. Virtualized IO devices are well known in art to provide IO virtualization functions to multiple VM servers operating on a bare device. The virtualized IO devices, each give the impression of a physical memory device to a VM.

FIG. 73 shows a networked computing system 7300 according to an embodiment. Data packets 7304 can be received from a cloud 7302. A first virtual switch 7306a, which can be interfaced with a network and a peripheral IO bus such as PCIe, can be used for packet transport to a second virtual switch. The network interface of the first virtual switch 7306a can receive the incoming packets. The virtual switch can employ IO virtualization schemes such as SR-IOV to make a single network I/O device appear as multiple devices. Further, the virtual switch can use a scheme such as OpenFlow to abstract out the control plane in the software. The control plane of the first virtual switch performs functions such as route determination, target node identification etc. The forwarding plane of the first virtual switch can transport packets from a physical layer of one kind (Ethernet/IP) to a peripheral IO bus such as PCIe 7308. Using an I/O memory management unit (IOMMU) 7310, the I/O fabric 7314 can interface with one or memory controllers 7316 to transfer the network packets to host processors 7330 or to second virtual switch (7306b). The second virtual switch 7306b, which can be interfaced with a memory bus and a multiple processor modules 7320, can receive and switch traffic originating from the memory bus and from the offload processors. The forwarding plane of the second virtual switch 7306b can transport packets from a memory bus 7318 to an offload processor 7320 or vice versa. Host processor(s) 7330 can include a control function (CF) driver 7333, virtual function (VF) drivers 7333 and provisioning agent 7330a, described below.

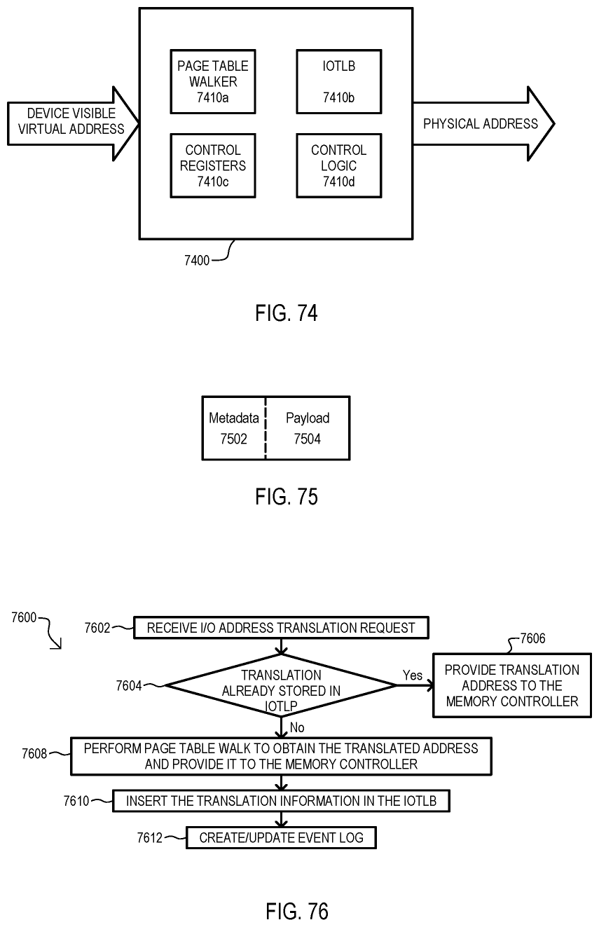

As shown in FIG. 74, an IOMMU 7400 can be configured to translate a virtual address corresponding to an I/O device to its corresponding physical address in the main memory. The IOMMU 7400 may include page table walker 7410a, a translation lookaside buffer 4710b, control registers 4710c and control logic 4710d.

As shown in FIG. 75, a network packet contains metadata 7502 and payload 7504. Metadata 7502 can be used to determine if a given incoming packet is to be forwarded to a host processor or an offload processor.

FIG. 76 shows an exemplary process flow 7600 that an IOMMU may follow to serve input I/O requests according to an embodiment. An I/O request can be received at step 7602. If the address translation is already available in the IOTLB 7604, the information can be provided to a memory controller 7606 and the request can be served. Otherwise, a page table walk (e.g., 7410a) can be invoked at step 7608. IOTLB can be updated with the latest translation information at 7610 and an event log can be created or updated at 7612.

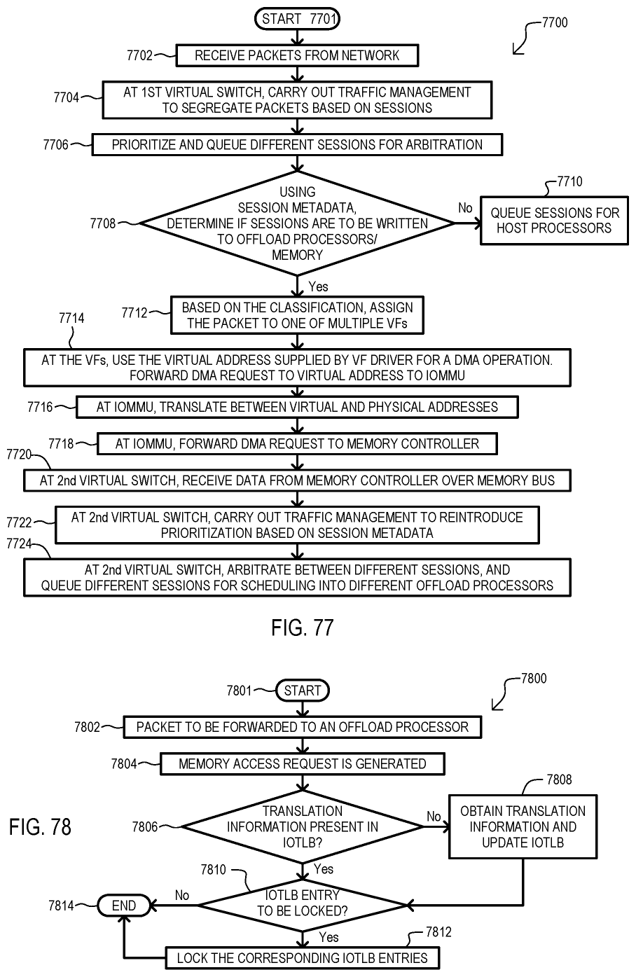

FIG. 77 shows an exemplary process flow 7700 according to an embodiment. A process flow can start 7701 and receive packets from a network 7702. The incoming packets are classified using session metadata by a virtualized network interface (e.g., 7306a) 7704 (Step 306). Sessions can be prioritized and queued by an arbiter circuit at step 7706 and session metadata can be generated. By using both packet metadata and session metadata, the decision is made 7708 as to whether to transport the packet to a host processor or to an offload processor. In one embodiment, the offload processors can be mounted in DIMM slots. If sessions are not to be written to offload processors/memory (No from 7708), sessions can be queued for host processors 7710.

If sessions are to be written to offload processors/memory (Yes from 7708), based on the classification 7712, packets can be transferred to one of a plurality of VFs. The VFs can be supplied with virtual memory addresses by a VF driver. The VFs use the virtual address and other details in its descriptor data structure to generate a DMA request. The DMA request is forwarded to an IOMMU (e.g., 7310) 7714. The IOMMU can perform an address translation to identify the physical address corresponding to the virtual addresses it is supplied with 7716. The IOMMU can forward a DMA request to a memory controller 7718, the DMA request is targeted to the physical address generated in step 7716. Therefore, the packets destined to be processed by the offload processors can be written to the memory location corresponding to the offload processors by performing a DMA operation. The packets written to a memory location are intercepted by a second virtual switch (e.g., 7306b). A second virtual switch can reintroduce traffic management, classification and prioritization to create flow characteristics for packets of a session (7722,7724). A second virtual switch can use session metadata for performing the above steps. Traffic managed flows can be written to various offload processors at step 7720.

Once the packets are written to a main memory using DMA operation, an IOTLB entry can be updated (e.g., 7610 in FIG. 76). In certain embodiments, such entries in the IOTLB may be locked so that they are not erased during subsequent cache flushes. This arrangement improves the instances of “cache hits” thus reducing both the processing time and the interrupts to the host processor.

FIG. 78 illustrates a process that may be followed to lock the TLB entries. Once a process starts 7801 a determination can be made that a packet is to be forwarded to an offload processor 7804. A corresponding memory access request can be generated 7804. Translation information is fetched either from the IOTLB 7806 or through a page table walk 7808. A determination is made if the entry in the IOTLB corresponding to a particular translation information is to be locked 7810. In response, the entries can be locked 7812 or the process can end 7814.

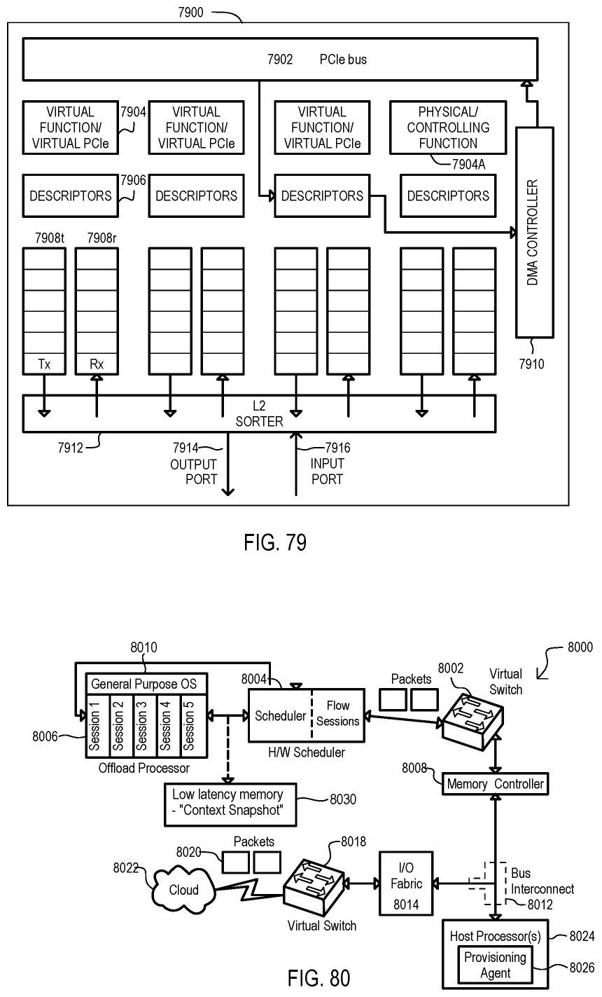

FIG. 79 shows an IO device 7900 implementation for selected embodiments. A network interface device or a similar I/O device 7900 can receive data packets from a network or from a computing device. The data packets can have certain characteristics, including transport protocol number, source and destination port numbers, source and destination IP addresses, and the like. The data packets can further have metadata (e.g., 7502) that helps in their classification and management. An IO device 7900 can include an output port 7914, input port 7916, layer 2 sorter 7912, transmit queues 7908t, receive queues 7908r, descriptors 7906, virtual function interface 7904, controlling function interface 7904A, DMA controller 7910 and communication bus 7902.

An I/O device 7900 can include, but is not limited to, peripheral component interconnect (PCI) and/or PCI express (PCIe) devices connecting with host motherboard via PCI or PCIe bus (e.g., 7312). Examples of I/O include a network interface controller (NIC), a host bus adapter, a converged network adapter, an ATM network interface etc.

In order to provide for an abstraction scheme that allows multiple logical entities to access the same I/O device 7900, the I/O device may be virtualized to provide for multiple virtual devices each of which can perform some of the functions of the physical I/O device. The IO virtualization program provides for a means to redirect traffic to different memory modules (and thus to different offload processors).

To achieve this, a I/O device 7900 (e.g., a network card) may be partitioned into several function parts; including controlling function (CF) 7904, supporting input/output virtualization (IOV) architecture (e.g., single-root IOV) and multiple virtual function (VF) interfaces 7904. Each virtual function interface 7904 may be provided with resources during runtime for dedicated usage. Examples of the CF and VF may include the physical function and virtual functions under schemes such as Single Root I/O Virtualization or Multi-Root I/O Virtualization architecture. The CF can act as the physical resources that sets up and manages virtual resources. The CF can also be capable of acting as a full-fledged IO device. The VF can be responsible for providing an abstraction of a virtual device for communication with multiple logical entities/multiple memory regions.

The operating system, or the user code running on a host processor (e.g., 7330), may be loaded with a device model, a VF driver (e.g., 7335) and a CF driver (e.g., 7333). A device model is used to create an emulation of a physical device for the host processor (e.g., 7330) to recognize each of the multiple VFs that are created. The device model is replicated multiple times to give the impression to VF drivers (a driver that interacts with a virtual IO device) that they are interacting with a physical device. For example, a certain device model may be used to emulate a network adapter such as the Intel® Ethernet Converged Network Adapter (CNA) X540-T2. The VF driver believes it is interacting with such an adapter. The device model and the VF driver can be run in either privileged or non-privileged mode. There is no restriction with regard to which device hosts/runs the code corresponding to the device model and the VF driver. The code, however, must have the capability to create multiple copies of device model and VF driver so as to enable multiple copies of said I/O interface to be created.

Said operating system can create a defined physical address space for an application (e.g., 7330a) supporting the VF drivers. Further, the host operating system can allocate a virtual memory address space to the application or provisioning agent. The provisioning agent brokers with the host operating system to create a mapping between said virtual address and a subset of the available physical address space. This physical address space corresponds to the address space of the plurality of offload processors (e.g., 7320). The provisioning agent (e.g., 7330a) can be responsible for creating each VF driver and allocating it a defined virtual address space. The application or provisioning agent (e.g., 7330a) can control the operation of each of the VF drivers. The provisioning agent supplies each VF driver with descriptors such as the address of the next packet.

The application or provisioning agent (e.g., 7330a), as part of an application/user level code, creates a virtual address space for each VF during runtime. Allocating an address space to a device is supported by means of allocating to said virtual address space a portion of the available physical memory space. This allocates part of the physical address space to the VF. For example, if the application (e.g., 7330a) handling the VF driver instructs it to read or write packets from or to virtual memory addresses Oxaaaa to Oxffff, the device driver may write I/O descriptors (7906) into a descriptor queue (7908) of the VF 7904 with a head and tail pointer that are changed dynamically as queue entries are filled. The data structure may be of another type as well, including but not limited to a ring structure or hash table.

Said mapping between virtual memory address space and physical memory space can be stored in IOMMU tables (e.g., 7310). The application may supply the VF drivers with virtual addresses at which memory read or write is to be performed. The VF drivers supply the virtual addresses to said virtual function. The VF are configured to generate requests such as read and write which may be part of a direct memory access (DMA) read or write operation. The VF can read from or write data to the address location pointed to by the driver. The virtual addresses can be translated by an IOMMU (e.g., 7310) to their corresponding physical addresses and the physical addresses may be provided to the memory controller for access. That is, the IOMMU modifies the memory requests sourced by the I/O devices to change the virtual address in the request to a physical address, and the memory request is forwarded to the memory controller for memory access. Further, on completing the transfer of data to the address space allocated to the driver, the driver employs a means to mask or disable those interrupts, which are usually triggered to the host processor to handle said network packets. The memory request may be forwarded over a bus that supports a protocol such as HyperTransport (e.g., 7312). The VF in such cases carries out a direct memory access by supplying the virtual memory address to the IOMMU.

Alternatively, said application may directly code the physical address into the VF descriptors if the VF allows for it. If the VF cannot support physical addresses of the form used by the host processor, an aperture with a hardware size supported by the VF device may be coded into the descriptor so that the VF is informed of the target hardware address of the device. Data that is transferred to an aperture may be mapped by a translation table to a defined physical address space in the RAM. The DMA operations may be initiated by software executed by the processors, programming the I/O devices directly or indirectly to perform the DMA operations.

The disclosed embodiment can enable direct communication of network packets to the offload processors without interrupting the host processor. Further, packet classification and traffic management techniques can be advantageously incorporated into such data handling systems

In certain embodiments a first virtual switch can be a virtualized NIC, the host processor can be based on Intel x86 architecture, a memory bus is a DDR bus, a device id is the device address of the Physical NIC or the virtual NIC.

A provisioning agent can be an entity on the host processor that initializes and interacts with virtual function drivers. The virtual function driver can be responsible for providing the VF with the virtual address of the memory space where a DMA needs to be carried out. Each device driver might be allocated virtual addresses that map to the physical addresses where the XIMM modules are placed.

In some embodiments, a scheduling circuit can be employed to implement traffic management of incoming packets. Packets from a certain source, relating to a certain traffic class, pertaining to a specific application or flowing to a certain socket are referred to as part of a session flow and are classified using session metadata. Session metadata often serve as the criterion by which packets are prioritized and as such, incoming packets are reordered based on their session metadata. This reordering of packets can occur in one or more buffers and can modify the traffic shape of these flows. Packets of a session that are reordered based on session metadata are sent over to specific traffic managed queues that are arbitrated out to output ports using an arbitration circuit. The arbitration circuit feeds these packet flows to a downstream packet processing/terminating resource directly. Certain embodiments provide for integration of thread and queue management so as to enhance the throughput of downstream resources handling termination of network data through above said threads.

A scheduling circuit can perform the following functions:

The scheduling circuit is responsible for carrying out traffic management, arbitration and scheduling of incoming network packets (and flows).

The scheduling circuit is responsible for offloading part of the network stack of the offload OS, so that the offload OS can be kept free of stack level processing and resources are free to carry out execution of application sessions. The scheduling circuit is responsible for classification of packets based on packet metadata, and packets classified into different sessions are queued in output traffic queues are sent over to the offload OS.

The scheduling circuit is responsible for cooperating with minimal overhead context switching between terminated sessions on the offload OS. The scheduling circuit ensures that multiple sessions on the offload OS can be switched with as minimal overhead as possible. The ability to switch between multiple sessions on the offload sessions makes it possible to terminate multiple sessions at very high speeds, providing packet processing speeds for terminated sessions.

The scheduling circuit is responsible for queuing each session flow into the OS as a different OS processing entity. The scheduling circuit is responsible for causing the execution of a new application session on the OS. It indicates to the OS that packets for a new session are available based on traffic management carried out by it.

The hardware scheduler is informed of the state of the execution resources on the offload processors, the current session that is run on the execution resource and the memory space allocated to it, the location of the session context in the processor cache. The hardware scheduler can use the state of the execution resource to carry out traffic management and arbitration decisions. The hardware scheduler provides for an integration of thread management on the operating system with traffic management of incoming packets. It induces persistence of session flows across a spectrum of components including traffic management queues and processing entities on the offload processors.

Conventional traffic management circuits provided by a switch fabric can consist of depth-limited output queues, the access to which is arbitrated by a scheduling circuit. The input queues are managed using a scheduling discipline to provide a means of traffic management for incoming flows. Conventionally, schedulers may allocate/identify a priority to/of each of the flows and allocate an output port to each of these flows. Given that multiple flows might be competing for the same output port, these flows can be provided time multiplexed access to each of the output ports. Further, multiple flows contending for an output port may be arbitrated by an arbitration circuit before being sent out over an output port. Several queuing schemes are present to provide a fair weighting of the available resources to said flows. A conventional traffic management circuit doesn't take into account the handling and management of data by downstream elements except for meeting the service level agreement (SLA) agreements it already has with said downstream elements. Based on an allocation of priority, incoming packets may be reordered in a buffer to maintain persistence of session flows in these queues. The scheduling discipline chosen for this prioritization, or traffic management (TM), can affect the traffic shape of flows and micro-flows through delay (buffering), bursting of traffic (buffering and bursting), smoothing of traffic (buffering and rate-limiting flows), dropping traffic (choosing data to discard so as to avoid exhausting the buffer), delay jitter (temporally shifting cells of a flow by different amounts) and by not admitting a connection (cannot simultaneously guarantee existing SLAs with an additional flow's SLA).

FIG. 80 presents a schematic of a networked computing system 8000 employing a hardware scheduler according to an embodiment. System 8000 can include a virtual switch 8018, a bus 8016, IO fabric 8014, bus interconnect 8012, host processor 8024, memory controller 8008, second virtual switch 8002, hardware scheduler 8004 and offload processor 8006. An offload processor 806 can include a general purpose OS 8010 and can execute processing on multiple sessions.

A system 8000 is disposed to receive packets 8020 over a network interface from a cloud of devices 8022. Packets can be transferred over to a hardware scheduler 8004 using a virtual switch 8018. A virtual switch 8018 can be capable of examining packets and, using its control plane (that can be implemented in software), examine appropriate output ports for said packets. Based on the route calculation for the network packets or the flows associated with the packets, the forwarding plane of the virtual switch can transfer the packets to an output interface. An output interface of the virtual switch 8018 may be connected with an IO bus/fabric 8014, and the virtual switch may have the capability to transfer network packets to a memory bus for a memory read or write operation (direct memory access operation). The network packets could be assigned specific memory locations based on control plane functionality. A second virtual switch 8002 on the other side of the network bus 8012 may be capable of receiving said packets and classifying them to different hardware schedulers (e.g., 8004)) based on some arbitration and scheduling scheme. The hardware scheduler 8004 can receive packets of a flow. The detailed functions of the hardware scheduler in handling received packets are explained herein.

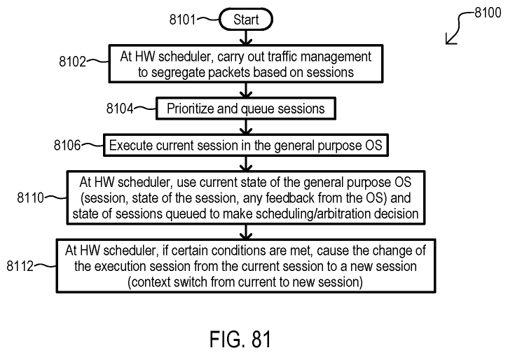

FIG. 81 is a method 8100 according to an embodiment. After starting 8101, at a hardware scheduler traffic can carry out traffic management to segregate packets based on sessions 8102. Sessions can be prioritized and queued 8104. A current session can be executed in a general purpose OS 8106. At a hardware scheduler, a current state of the general purpose OS and state of sessions queued can be used to make scheduling/arbitration decision 8110. A state of a general purpose OS can include session state of session and feedback from the OS. At a hardware scheduler, if certain conditions are met, a change of the execution session from the current session to a new session (context switch from current to new session).

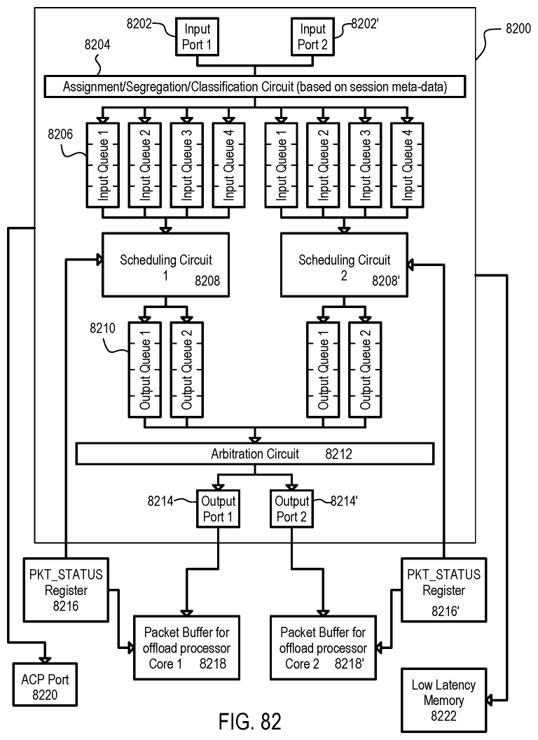

FIG. 82 is a diagram showing a hardware scheduler 8200. A hardware scheduler 8200 can include input ports 8202/8202′, a classification circuit 8204, input queues 8206, scheduling circuit 8208/8208′, output queues 8210, arbitration circuit 8212, and output ports 8214/8214′. Connected to the hardware scheduler 8200 can be common packet status registers 8216, packet buffer 8218, ACP ports 8220 and a low latency memory 8222. Classification circuit 8204 can assign, segregate and classify packets based on session meta-data.

A hardware scheduler 8200 can receive packets externally from an arbiter circuit that is connected to several such hardware schedulers. The hardware scheduler receives data in one or more input ports 8202/8202′. The hardware scheduler can employ classification circuit 8204, which examines incoming packets, and based on metadata present in the packet, classifies packets into different incoming queues. The classification circuit 8204 can examine different packet headers and can use an interval matching circuit of the form explained in U.S. Pat. No. 7,076,615 to carry out segregation of incoming packets. Any other suitable classification scheme may be employed to execute the classification circuit 8204.

Hardware scheduler 8200 can be connected with packet status registers 8216/8216′ for communicating with the offload processors on the wimpy cores. Status registers 8216/8216′ can be operated upon by both the hardware scheduler 8200 and the OS on offload processors. The hardware scheduler 8200 can be connected with a packet buffer 8218/8218′ wherein it stores outgoing packets of a session or for processing to/by the offload OS. A detailed explanation of the registers and packet buffer is given herein. The hardware scheduler 8200 can use an ACP port 8220 or the like to access data related to the session that is currently running on the OS in the cache and transfer it out using a bulk transfer means during a context switch to a different session. The hardware scheduler 8200 can use the cache transfer as a means for reducing the overhead associated with the session. The hardware scheduler 8200 can use a low latency memory 8222 to store the session related information from the cache for its subsequent access.

A hardware scheduler 8200 can receive incoming packets through an arbitration circuit that is interposed between a memory bus and several such scheduler circuits. The scheduler circuit could have more than one input port 8202/8202′. The data coming into the hardware scheduler 8200 may be packet data waiting to be terminated at the offload processors or it could be packet data waiting to be processed, modified or switched out. The scheduler circuit is responsible for segregating incoming packets into corresponding application sessions based on examination of packet data.

The hardware scheduler 8200 can have means for packet inspection and identifying relevant packet characteristics. The hardware scheduler 8200 may offload part of the network stack of the offload processor free from overhead incurred from network stack processing. The hardware scheduler 8200 may carry out any of TCP/transport offload, encryption/decryption offload, segmentation and reassembly thus allowing the offload processor to use the payload of the network packets directly. The hardware scheduler 8200 may further have the capability to transfer the packets belonging to a session into a particular traffic management queue 8206 for its scheduling and transfer to output queues 8210. The hardware scheduler 8200 may be used to control the scheduling of each of these persistent sessions into a general purpose OS. The stickiness of sessions across a pipeline of stages, including a general purpose OS, a scheduler circuit 8200 can be accentuated by optimizations carried out at each of the stages in the pipeline (explained below).

For the purpose of this disclosure, U.S. Pat. No. 7,760,715 is fully incorporated herein by reference. It provides for a scheduling circuit that takes account of downstream execution resources. The session flows queued in each of these queues is sent out through an output port to a downstream network element. The hardware scheduler 8200 may employ an arbitration circuit 8212 to intermediate access of multiple traffic management output queues 8210 to available output ports 8214/8214′. Each of the output ports may be connected to one of the offload processor cores through a packet buffer 8218/8218′. The packet buffer 8218/8218′ may further include a header pool and a packet body pool. The header pool may only contain the header of packets to be processed by offload processors. Sometimes, if the size of the packet to be processed is sufficiently small, the header pool may contain the entire packet. Packets are transferred over to the header pool/packet body pool depending on the nature of operation carried out at the offload processor. For packet processing, overlay, analytics, filtering and such other applications it might be appropriate to transfer only the packet header to the offload processors. In this case, depending on the handling of the packet header, the packet body might either be sewn together with a packet header and transferred over an egress interface or dropped. For applications requiring the termination of packets, the entire body of the packet might be transferred. The offload processor cores may receive the packets and execute suitable application sessions on them to execute said packet contents.

The hardware scheduler 8200 can provide a means to schedule different sessions on a downstream processor, wherein the two are operated in coordination to reduce the overhead during context switches. The hardware scheduler 8200 in a true sense arbitrates not just between outgoing queues or session flows at line rate speeds, but actually arbitrates between terminated sessions at very high speeds. The hardware scheduler 8200 can manage the queuing of sessions on the offload processor. The hardware scheduler 8200 is responsible for queuing each session flow into the OS as a different OS processing entity. The hardware scheduler 8200 can be responsible for causing the execution of a new application session on the OS. It can indicate to the OS that packets for a new session are available based on traffic management carried out by it. A hardware scheduler 8200 can be informed of the state of the execution resources on the offload processors, the current session that is run on the execution resource and the memory space allocated to it, the location of the session context in the processor cache.

A hardware scheduler 8200 can use the state of the execution resource to carry out traffic management and arbitration decisions. The hardware scheduler 8200 can provide for an integration of thread management on the operating system with traffic management of incoming packets. It can induce persistence of session flows across a spectrum of components including traffic management queues and processing entities on the offload processors. An OS running on a downstream processor may allocate execution resources such as processor cycles and memory to a particular queue it is currently handling.

The OS may further allocate a thread or a group of threads for that particular queue, so that it is handled distinctly by the general purpose (GP) processing element as a separate entity. The fact that there are multiple sessions running on a GP processing resource, each handling data from a particular session flow resident in a queue (8210) on the hardware scheduler 8200, tightly integrates the hardware scheduler 8200 and the downstream resource. This can bring an element of persistence within session information across the traffic management and scheduling circuit and the general purpose processing resource. Further, the offload OS is modified to reduce the penalty and overhead associated with context switch between resources. This is further exploited by the hardware scheduler 8200 being able to seamlessly switch between queues, and consequently their execution, as different sessions by the execution resource.

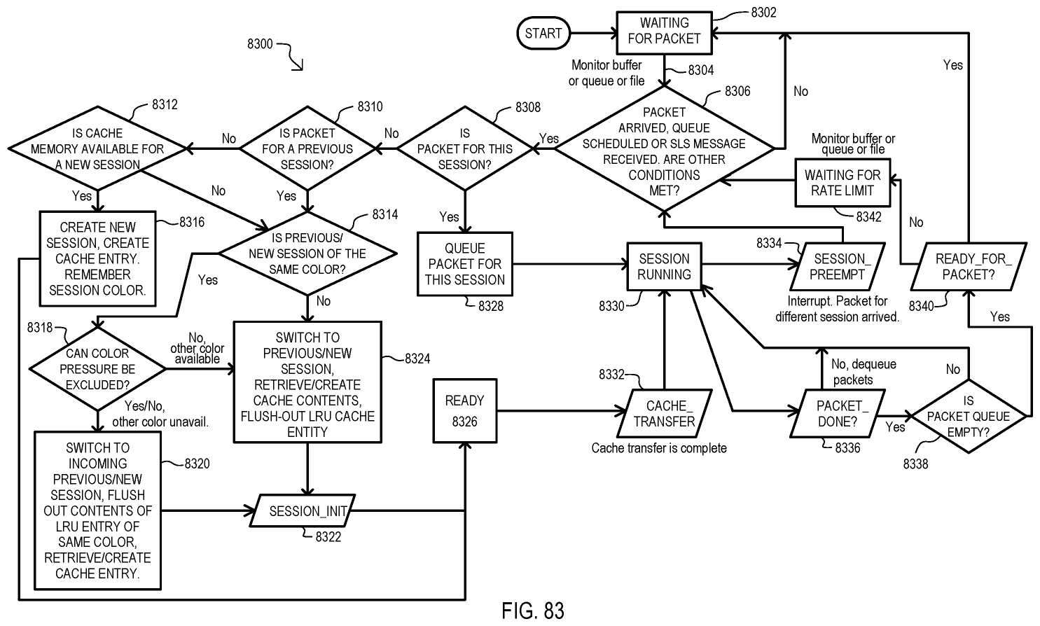

FIG. 83 is a flow diagram showing packet processing according to an embodiment that can utilize a hardware scheduler. The described embodiments can utilize a hardware scheduler to reduce context switching overhead and drive a downstream offload processor, such as an ARM core (wimpy core). The hardware scheduler can implement a traffic management scheme in order to meet the requirements of the wimpy core. The hardware scheduler may be operated in a preemption mode. In a preemption mode, the scheduler can be responsible for controlling the execution of a session on the OS. The hardware scheduler can decide when to remove a current session from execution and cause another session to be executed. A session may include a thread or a group of threads on the ARM core.

Referring to FIG. 83, As seen in FIG. 83, a method 8300 can wait for packets or other data (8302). Incoming packets can be received by a monitor buffer, queue or file (8304). Once a packet or service level specification (SLS) has been received, there may be a check to ensure other conditions are met (8306). If the packet/data has arrived (and optionally, other conditions met, such as those noted above) (Yes from 8306), a packet session status is determined (8308). If the packet is part of a current session (Yes from 8308), it can be queued for the current session (8328) and processed as part of the current session (8330). In some embodiments, this can include hardware scheduler queuing the packet and sending it to an offload processor for processing.

If a packet is not part of a current session (No from 8308), it can be determined if the packet is for a previous session (8310). If the packet is not from a previous session (No from 8310), it can be determined if there is enough memory for a new session (8312). If there is enough memory (Yes from 8312), a new session can be created, a cache entry can be created, and a color for the session stored (8316). When the offload processor(s) is ready (8326), the transfer of context data can be made to the cache memory of the processor(s) (8332). Once such a transfer is complete, the session can run (8330).

If the packet is from a previous session (Yes from 8310) or there is not enough memory for a new session (No from 8312), it can be determined if the previous session or new session is of the same color (8314). If this is not the case, a switch can be made to the previous session or new session (8324). A LRU cache entity can be flushed, and the previous session context can be retrieved, or the new session context created. The packets of this retrieved/new session can be assigned a new color which can be retained. In some embodiments, this can include reading context data stored in a low latency memory to the cache of an offload processor. If a previous/new session is of the same color (Yes from 8314), a check can be made to see if the color pressure can be exceeded (8318). If this is not possible, but another color is available (“No, other color available” from 8318), a switch to the previous or new session can be made (i.e., 8324). If the color pressure can be excluded, or it cannot, but no other color is available (“Yes/No, other color unavail.” from 8318), an LRU cache entity of the same color can be flushed, and the previous session context can be retrieved, or the new session context created (8320). These packets will retain their assigned color. Again, in some embodiments, this can include reading context data stored in a low latency memory to the cache of an offload processor.

In the event of a context switch (8320/8324), the new session can be initialized (8322). When the offload processor(s) are ready (8326), the transfer of context data can be made to the cache memory of the processor(s) (8332). Once such a transfer is complete, the session can run (8330).

Referring still to FIG. 83, while the offload processor is processing a packet (8330), there is a periodic check to see if the packet has finished processing (8336) and return if processing is not done (No, dequeue packets from 8336). If the packet is done (Yes from 8336), a hardware scheduler can look to its output queue for more packets (8338). If there are more packets (Yes from 8338) and the offload processor is ready to receive them (Yes from 8340), the packets can be transferred to the offload processor. In some embodiments, packets can be queued into the offload processor as soon as a “ready for processing” message is triggered by the offload processor. After the offload processor is done processing the packets, the entire cycle can repeat beginning with the hardware scheduler checking to which session the packet belongs, etc.

If an offload processor is not ready for a packet (No from 8336) and it is waiting for rate limit (8342), the hardware scheduler can check to see if there are other packets available. If there are no more packets in the queue, the hardware scheduler can go into a wait mode (8302), waiting for the rate limit until more packets arrive. Thus, the hardware scheduler works quickly and efficiently to manage and supply packets going to the downstream resource.

As shown, a session can be preempted by the arrival of a packet from a different session, resulting in the new packet being processed as noted above (8306).

The described embodiments and implement a method to reduce the time duration and computational overhead of a context switch operation in an offload processor running a light-weight operating system. The described embodiments can manage session transfers and context switches so that there is minimal kernel/OS execution prior to resuming a session warmly. Advantageously, described embodiments herein do not require long intervals for the kernel saving and restoring session context.

In general, the duration of a context switch in a processor having a regular operating system is non-deterministic in nature. The described embodiments can provide a deterministic context switch system. The described embodiments provide a system and a method of performing context switch operation wherein the duration of the context switch operation is deterministic. In the described embodiments, replacing the context of a previous process by the context of a new process can involve transferring the new process context from an external low latency memory. In the process of context switching, the main system memory's access can be avoided as it is delay intensive. The new process context can be prefetched from an external low latency memory location and the process' context can be saved to the same external memory for use later. The context switch operation can be defined in terms of the number of cycles and the operations needed to be carried out.

The described embodiments can employ a system comprising an external scheduler, a low latency external memory unit, and an offload processor with a general purpose OS running on it to implement reduced overhead context switching. The offload processor can be a general purpose processor with a regular OS capable of executing server sessions as separate processes/threads/processing entities (PEs). The processes can be allocated a defined amount of memory and/or processing power. A tight context switch overhead allows the offload processor of the described embodiment to switch between multiple processing entities in less time than in a regular operating system. The offload processor can be switched from one PE to another and hence switched between traffic managed queues/session flows. By exploiting the defined nature of context switching, an external scheduler can instruct the OS on the offload processor to carry out context switching. The external scheduler can employ this functionality to carry out traffic management and arbitration between several traffic managed queues that are terminated at the offload processors. This can provide for a system where multiple sessions are efficiently managed (where a session corresponds to a data packet source, network traffic type, target application, target socket, or the like).

Modem operating systems that implement virtual memory are responsible for the allocation of both virtual and physical memory for processes, resulting in virtual to physical translations that occur when a process executes and accesses virtually addressed memory. Conventionally, in the management of a process's memory, there is typically no coordination between the allocation of a virtual address range and the corresponding physical addresses that will be mapped by the virtual addresses. This lack of coordination affects the processor cache overhead and effectiveness when a process is executing.

A processor allocates, for each process that is executing, memory pages that are contiguous in virtual memory. The processor also allocates pages in physical memory which are not necessarily contiguous. A translation scheme is established between the two schemes of addressing to ensure that the abstraction of virtual memory is correctly supported by physical memory pages. Processors employ cache blocks that are resident close to the CPU to meet the immediate data processing needs of the CPU. Caches are arranged in a hierarchy. L1 caches are closest to the CPU, followed by L2, L3 and so on. L2 acts as a backup to L1 and so on. The main memory acts as the backup to the cache before it.

For caches that are indexed by a part of the process's physical addresses, the lack of correlation between the allocation of virtual and physical memory for a range of addresses beyond the size of an MMU page, results in haphazard and inefficient effects in the processor caches. This increases cache overheads and delay is introduced during a context switch operation. In physically addressed caches, the cache entry for the next page in the virtual memory may not correspond to the next contiguous page in the cache—thus degrading the overall performance that can be achieved.

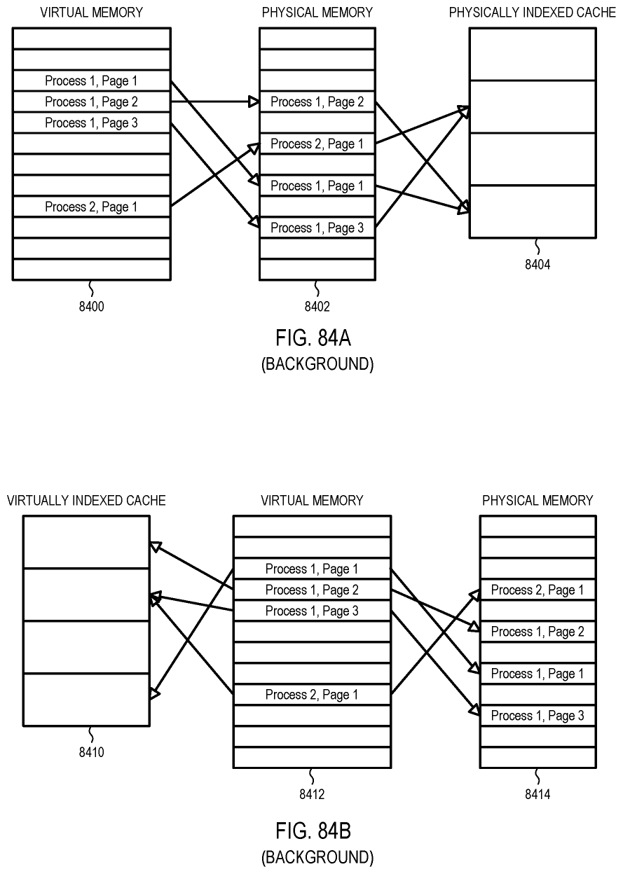

FIG. 84A is a diagram of a conventional memory translation and indexing arrangement showing a virtual memory 8400, physical memory 8402 and physically indexed cache 8404. As shown, contiguous pages in virtual memory (Pages 1 and 2 of Process 1) collide in the cache as their physical addresses index to the same cache location. The processor cache is physically indexed, and the addresses of the pages in the physical memory index to the same page in the cache. Furthermore, when the effects of multiple processes accessing a shared cache are considered, there is typically a lack of consideration of overall cache performance when the OS allocates physical memory to processes. This lack of consideration can result in different processes thrashing in the cache across context switches unnecessarily displacing each other's lines, which results in an indeterminate number of cache miss/fills upon resuming a process, or an increased number of line writebacks across context switches. This is shown by Process 1, Page and Process 2, Page 1 in FIG. 84A.

Processor caches can be indexed by a part of the process's virtual addresses. Virtually indexed caches are accessed by using a section of the bits of the virtual address of the processor. Pages that are contiguous in virtual memory will be contiguous in virtually indexed caches. FIG. 84B is a diagram of such an arrangement, showing a virtual memory 8412 that indexes to a virtually indexed cache 8410 and a physical memory 8414. As long as processor caches are virtually indexed, no attention needs to be paid to coordinating the allocation of physical memory with the allocation of virtual addresses, as programs sweep through virtual address ranges, they will enjoy the benefits of spatial locality in the processor cache.

Set-associative caches have several entries corresponding to an index. A given page which maps onto the given cache index can be anywhere in that particular set. Given that there are several positions available for a cache entry, the problems that caused thrashing in the cache across context switches are alleviated to a certain extent with set-associative caches, as the processor can afford to keep used entries in the cache to the extent possible. For this, caches employ the least recently used algorithm. This resulted in mitigation of some of the problems associated with a virtual addressing scheme followed by OSes, but obviously placed constraints on the size of the cache. Bigger caches, which were multi-way associative are required to ensure that recently used entries are not invalidated/flushed out. The comparator circuitry for a multi-way set associative cache has to be more complex to accommodate for parallel comparison, which increases the circuit level complexity associated with the cache.

A scheme known as Page-coloring has been used by some OS to deal with this problem of cache-misses due to the virtual addressing scheme. If the processor cache was physically indexed, the OSes are constrained to look for physical memory locations that will not index to locations in the cache of the same color. OSes have to assess, for every virtual address, the pages in the physical memory that are allowable based on the index they hash to in the physically indexed cache. Several physical addresses are disallowed as the indices derived might be of the same color. So, for physically indexed caches, every page in the virtual memory needs to be colored to identify its corresponding cache location and determine if the next page is allocated to a physical memory, and thus cache location of the same color or not. This is a cumbersome process repeated for every page. While it improves cache efficiency, page coloring increases the overhead on the memory management and translation unit as colors of every page have to be identified to prevent recently used pages from being overwritten. The level of complexity of the OS increases, as it needs an indicator of the color of the previous virtual memory page in the cache.

The problem with a virtually indexed cache is that, despite the fact that the cache access latencies are higher, there is the pervasive problem of aliasing. In aliasing, multiple virtual addresses (with different indices) mapping to the same page in the physical memory are at different locations in the cache (due to the different indices). Page coloring allows the virtual pages and physical pages to have the same color and therefore occupy the same set in the cache. Page coloring makes aliases to share the same superset bits and index to the same lines in the cache. This removes the problem of aliasing.

Page coloring imposes constraints on memory allocation. When a new physical page is allocated on a page fault, the memory management algorithm must pick a page with the same color as the virtual color from the free list. Because systems allocate virtual space systematically, the pages of different programs tend to have the same colors, and thus some physical colors may be more frequent than others. Thus page coloring may impact the page fault rate. Moreover, the predominance of some physical colors may create mapping conflicts between programs in a second-level cache accessed with physical addresses. The processor is also faced with a very big problem with the page coloring scheme just described. Each of the virtual pages could be occupying different pages in the physical memory such that they occupy different cache colors, but the processor would need to store the address translation of each and every page. Given that a process could be sufficiently large, and each process can include several virtual pages, the Page coloring algorithm would become messy. This would also complicate it at the TLB end, as it would need to identify for each Page of the processor's virtual memory, the equivalent physical address.

Conventionally, as context switches tend to invalidate the TLB entries, the processor would need to carry out Page Walks and fill the TLB entries and this would further add indeterminism and latency to what is a routine context switch. Therefore, in normal operating systems, we see that context switches result in collisions in the cache as well as TLB misses when a process is resumed. When the thread resumes, there are an indeterminate number of instruction and data cache misses as the thread's working set is reloaded back into the cache. I.e., as the thread resumes in user space and executes instructions, the instructions will typically have to be loaded into the cache, along with the application data. Upon switch-in, the TLB mappings may be completely or partially invalidated, with the base of the new thread's page tables written to a register reserved for that purpose. As the thread executes, the TLB misses will result in page table walks (either by hardware or software) which result in TLB fills. Each of these TLB misses has its own hardware costs: pipeline stall due to an exception; the memory accesses when performing a page table walk, along with the associated cache misses/memory loads if the page tables are not in the cache. These costs are dependent upon what took place in the processor between successive runs of a process and are therefore not fixed costs. Furthermore, these extra latencies add to the cost of a context switch and detract from the effective execution of a process.

Referring back to FIG. 80, a computing system 8000 can include items as described herein, including a hardware scheduler 8004 and an offload processor 8006. According to an embodiment, also included can be a context snapshot 8030. a system 800 can receive packets 8020 over a network interface 8018 from a cloud of devices 8022. Packets 8020 can be transferred over to the hardware scheduler 8004 using a virtual switch 8018.

Virtual switch 8018 can be capable of examining packets and using its control plane (that is implemented in software), examine appropriate output ports for said packets. Based on the route calculation for the said network packets or the flows associated with said packets, the forwarding plane of the virtual switch 8018 can transfer the packets to an output interface. An output interface of the virtual switch may be connected with an IO bus 8014, and the virtual switch 8018 can have the capability of transferring the packets to a memory bus for a memory read or write operation (direct memory access operation). The network packets could be assigned specific memory locations based on said control plane functionality.

An offload processor 8006 according to the described embodiment can execute multiple sessions and allocate processor resources to each of the sessions. The offload processor can be a general purpose processor capable of being integrated and fit into a memory module. A hardware scheduler 8004 can be responsible for switching between a session and a new session on the offload processor 8006. The hardware scheduler 8004 can be responsible for carrying out traffic management of incoming packets of different sessions using queues and scheduling logic. The hardware scheduler 8004 can arbitrate between queues that have a one-to-one/one-to-many/many-to-one correspondence with one or more threads executing on the offload processor. The hardware scheduler 8004 can use a zero overhead context switching (ZOCS) system to switch from one session to another.

The context of a session can include: a state of the processor registers saved in register save area, instructions in the pipeline being executed, a stack pointer and program counter, instructions and data that are prefetched and waiting to be executed by the session, data written into the cache recently and any other relevant information that can identify a session executing on the offload processor 8006. The session context can be identified clearly in the described embodiment using the following together: session id, session index in the cache and starting physical address.

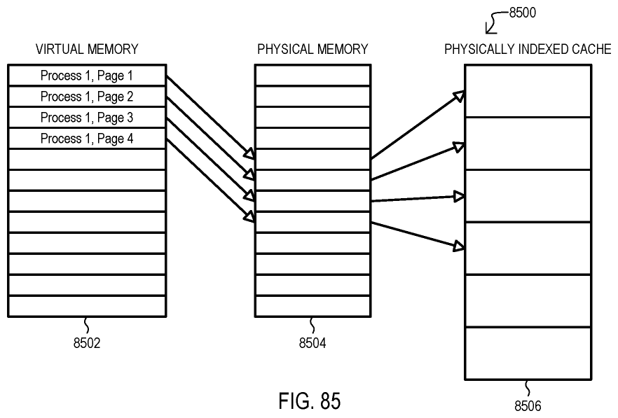

In the described embodiment, session contents can be contiguous in the physically indexed cache. FIG. 85 shows memory translation/indexing according to an embodiment and shows a virtual memory addressing 8502, physical memory addressing 8504 and physically indexed cache 8506. The described embodiment uses a translation scheme such that contiguous pages of a session in virtual memory 8502 are physically contiguous in the physically indexed cache 8606. Referring to FIG. 85 in conjunction with FIG. 83, the contiguous nature of a session in the cache can allow for a bulk read out of the session context into a ‘context snapshot’ 8030, from where it can be retrieved when the OS switches processor resources back to the session. The ability to seamlessly fetch session context from a memory unit that is low latency (orders of magnitude faster than main memory) provides for an expansion in the effective size of the L2 cache.

The OS can also carry out optimizations in its IOMMU to allow TLB contents corresponding to a session to be identified distinctly. This can allow address translations to be identified distinctly during a session and switched out and transferred to a page table cache that is external to the TLB. The usage of a page table cache allows for an expansion in the size of the TLB. Also given the fact that contiguous locations in the virtual memory 8502 are at contiguous locations in physical memory 8504 and in physically indexed cache 8506, the number of address translations required for identifying a session can be significantly reduced.

The described embodiment of FIG. 85 can be implemented on an offload processor 8006 that carries out session and packet termination services. The offload processor 8006 can be further optimized as the network stack of the offload processor can be extricated out to an external hardware scheduler 8004. The external hardware scheduler 8004 can act as a traffic management queue, arbitration circuit and a network stack offload device. The external hardware scheduler 8004 can be responsible for handling entire session and flow management on behalf of the offload processor 8006. The offload processor 8006 can be fed with the packets pertaining to a session directly into a buffer, from where it can extract out the packets and use them. The offload processor network stack can be optimized to avoid switches to a kernel mode to handle network generated interrupts (and execute an interrupt service routine). The described embodiment provides for a system comprising an offload processor (e.g., 8006) and operating system (e.g., 8010) that can be heavily optimized to carry out context switching of sessions seamlessly and with as little overhead as possible.

Referring back to FIG. 59-0, an implementation of reduced overhead context switching will be described. In an embodiment, a snooping unit, or access unit to access the L2 cache contents of an offload processor (5908i). An access unit 59081 can provide a port or such other means, to load external, non-cached memory 5908g data into the L2 cache, as well as transfer the cache contents to a non-cached memory 5908g. As part of an offload computational element, there can be several RAMs 5908g associated with the computational FPGA (cFPGA) 5900; the RAMs can be used to store the cache contents of sessions. The external low latency memory can be used to supplement and augment the available L2 cache and extend the coherency domain of sessions. This extra hardware support can reduce the effect of cache misses for switched in sessions, in that a session's context will be fetched and pre-fetched into the cache so that when the thread resumes most of its previous working set is there in the cache already. And in order to implement this optimization, when a session is switched out its L2 cache is transferred to cFPGA RAM via an access unit 5908k.

Note, however, that since a thread's register set is saved to memory as part of switch-out, the register contents can be resident in the cache. Therefore, as part of switch-in, when a session's contents are prefetched and transferred into the cache, the present described embodiment believes that when the register contents are loaded by the kernel upon resuming the thread, these loads should be from the cache and not from memory. Thus, with the careful management of a session's cache contents, the cost of context switching due to register set save and restore and cache misses on switch-in are greatly reduced, and even eliminated in some optimal cases, thereby eliminating two sources of context switch overhead and reducing the latency for the switched-in session to resume useful processing.

Embodiments can provide a snooping unit or access unit (e.g., 59081)) with the indices of all the lines in the cache where the relevant session context resides. If the session is scattered across locations in a physically indexed cache, it becomes very cumbersome to access all of the session contents as multiple address translations would be required to access multiple pages of the same session.

The described embodiment provides for a page coloring scheme using which the session contents are established in contiguous locations in a physically indexed cache. The embodiment can use a memory allocator for session data that will have to be allocated from physically contiguous pages so that we have control over physical address ranges for the sessions. This can be done by aligning the virtual memory page and the physical memory page to index to the same location in the cache. Even otherwise, if they do not index to the same location in the L2 cache (which is physically indexed), it could be advantageous to have the different pages of the session contiguous in physical memory, such that knowledge of the beginning index and size of the entry in the cache suffices to access all session data. Further, the set size is equal to the size of a session, so that once the index of a session entry in the cache is known; the index, the size and the set color could be used to completely transfer out the session contents from the cache to external, low latency memory.

All pages of a session can be assigned the same color in the processor cache. In an embodiment, all pages of a session have to start at the page boundary of a defined color. The number of pages allocated to a color can best be fixed based on the size of a session on the cache. The offload processor is used for executing specific types of sessions and it is informed of the size of each session beforehand. Based on this, the offload processor can begin a new entry at a session boundary. It similarly allocates pages in physical memory that index to the session boundary in the cache. The entire cache context is saved beginning at the session boundary. In the current embodiment, multiple pages in the session are contiguous in the physically indexed cache. Multiple pages of a session have the same color (they are part of the same set) and are located contiguously. Pages of a session are accessible by using an offset from the base index of the session. The cache is arranged and broken up into distinct sets, not as pages but as sessions. To move from one session to another, the memory allocation scheme can use an offset to the lowest bit of the indexes used to access these sessions. For example, a physically indexed cache with a size of 512 kb is implemented in one. The cache is 8-way associative. There are eight ways per set in the L2 cache. Therefore, there are eight lines per any color in L2, or eight separate instances of each color in L2. With a session context size of 8Kb, there will then be eight different session areas within the 512Kb L2 cache, or eight session colors with these chosen sizes.

Embodiments can implement a physical memory allocator that identifies the color corresponding to a session based on the cache entry/main memory entry of the temporally previous session. In the case given above, the physical memory allocator can identify the session of the previous session based on the 3 bits of the address used to assign a cache entry to the previous session. A physical memory allocator can assign the new session to a main memory location (whose color can be determined through a few comparisons to the most recently used entry) and will cause a cache entry corresponding to a session of a different color to be evicted based on a least recently used policy. In one embodiment, the offload processor comprises multiple cores. In such an embodiment, cache entries can be locked out for use by each processor core. For example, if the offload processor had two cores, given cache lines in the L2 core would be divided among processors and the number of colors would have to be halved. The color of the session, index of the session and session size, when a new session is created, can be communicated to an external scheduler. An external scheduler can use this information for queue management of incoming session flows.

The described embodiments can provide a means to isolate shared text and any shared data and lock these lines into the L2 cache, apart from any session data. Again, a physical memory allocator and physical coloring techniques can be used to accomplish this. Furthermore, if shared data can be separated in the cache, it can be locked into the L2 cache, as long as no ACP transfers will try to copy the lines. When allocating memory for session data, the memory allocator can be aware of physical color, as a location of session data residing in the L2 cache is mapped out.

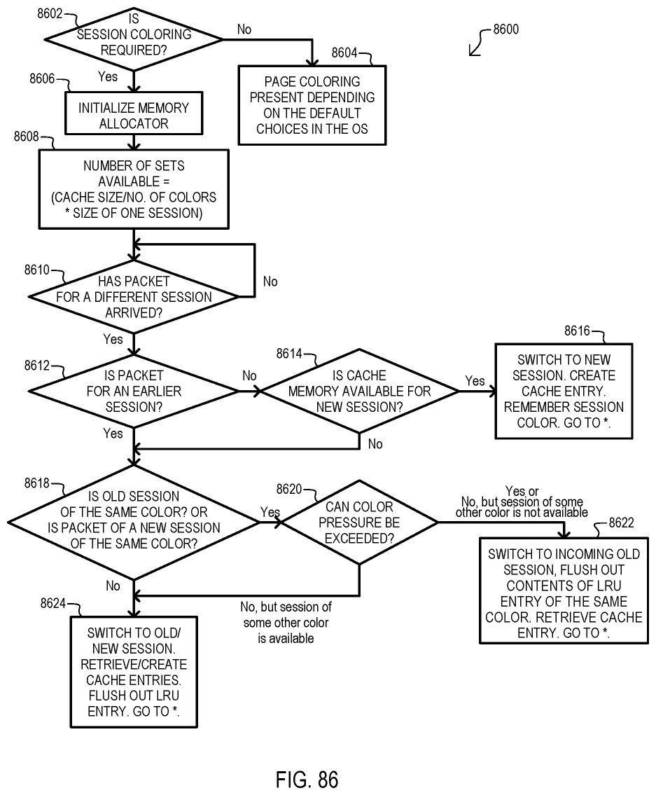

FIG. 86 shows a method 8600 for a reduced overhead context switching system. At initialization, an OS can determine if session coloring is required for the system 8602. If session coloring is not required, page coloring can be present depending upon the default choices in the OS 8604.

If session coloring is required, the OS can initialize a memory allocator 8606. The memory allocator can employ a cache optimization technique that allocates each session entry to a “session” boundary. The memory allocator can determine the starting address of each session, the number of sessions allowable in the cache, and the number of locations wherein a session can be found for a given color 8608. When a packet for a session arrives, the OS can determine if the packet is for the same session or for a different session 8610, and if it is for a different session, the OS determines if the packet is for an old session or a new session 8612.

If a packet is for an earlier session 8612, a method 8600 can determine if there is some space available in the cache for a new session 8614. If there is space, then it can immediately allocate a new session at a session boundary and it can save the context of the process that is currently executing to external low latency memory 8616.

If the packet is for an old/new session of the same color 8618, a method 8600 can examine if the color pressure can be exceeded 8620. If the color pressure can be exceeded or cannot be exceeded but a session of some other color is not available, a method 8600 can switch to the old session, flush contents of a LRU entry of the same color. The corresponding cache can be retrieved 8622. If a packet is not for an old/new session of the same color 8618, a method 8600 can switch to the old/new session, retrieve/create cache entries, and flush out LRU entry 8624.

Due to the high costs involved in building and maintaining data centers, it is imperative that the network architecture used in them be highly flexible and scalable. The tree-like topology used in conventional data centers is prone to traffic and computation hotspots. All the servers in such data centers communicate with each other through higher level ethernet switches, such as Top-of-Rack (TOR) switches. Flow of all the traffic through such TOR switches leads to congestion resulting in increased latency, particularly during the periods of high usage. Further, these switches need to be replaced to accommodate higher network speeds. This adversely affects the profitability of data center operators.

Embodiments can disaggregate the function of server communication (both intra rack and inter rack) to the servers themselves, specifically to Xockets DIMM modules (referred to as XIMMs or XIMM modules) deployed in the individual server units. Such architecture creates a midplane switching fabric and provides a mesh-like interconnectivity between all the servers. Features of the described embodiment are listed as follows (1) The XIMM modules can create a switching layer between the TOR switches and the server units; (2) each XIMM module can act as a switch capable of receiving and forwarding packets; (3) ingress packets are examined and switched based on their classification; and (4) packets can be forwarded to other XIMM modules or to NICs.

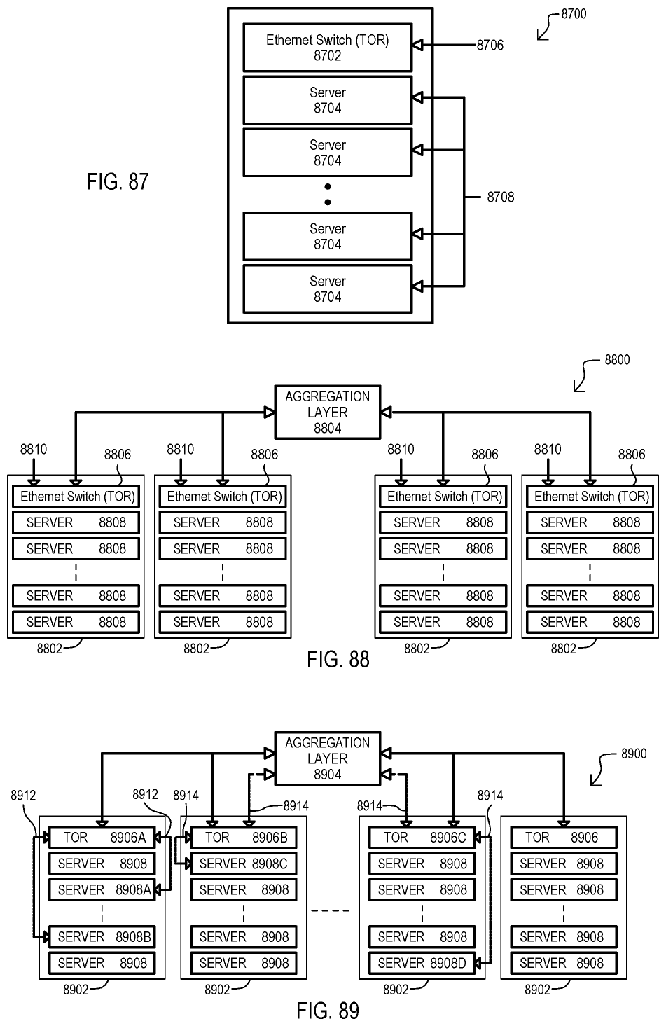

Servers are typically arranged in multi-server units referred to as “racks”. Multiple such modular units are used in an interconnected fashion in a data center. FIG. 87 shows a server rack 8700 with multiple server units 8704. Each rack 8700 can have a layer 2 ethernet switch, such as Top-Of-Rack switch 8702, which can interface with all the server units 8704 in the rack 8700.

As shown in a system 8800 in FIG. 88, multiple racks 8802 can be connected through their respective TOR switches 8806. TOR switches 8806 can communicate with each other through an aggregation layer 8804. Aggregation layer 8804 can include several switches and routers and can act as the interface between the external network and the server racks 8902. In such tree-like topologies, data frame communication between various server units 8902 can be routed through the corresponding TOR switches 8806.

As shown in a system 8900 in FIG. 89, if a server unit 8908B needs to forward a packet to another server unit 8908A (intra-rack communication), it may do so via path 8912 (dashed line). Communication between server unit 8908B and 8908D (inter rack communication) can happen via path 8984 (dotted line). Thus, TOR switches are involved in both intra rack (8906A) and inter rack communication (8906B/C) and are increasingly becoming bottlenecks as networks become faster. While additional TOR switches can be added to increase bandwidth and introduce redundancy, it is not a cost effective solution, particularly since these switches may have to be periodically replaced to handle higher network speeds.

A structure of embodiments will be described. Embodiments disclosed herein can relate to a midplane switching fabric that can be advantageously implemented to provide higher bandwidth in high-speed networks. Using one or more midplane switches, server units in multiple racks can communicate with each other directly instead of routing their communication through one or more TOR switches. Such distributed switching architecture provides full mesh interconnectivity between all the server units in a data center.

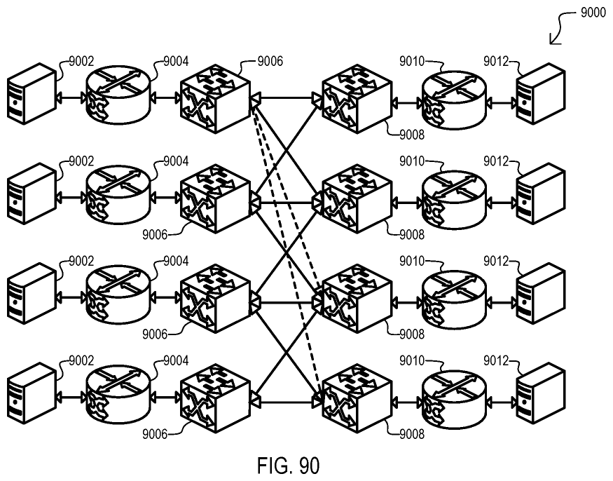

FIG. 90 shows the midplane switch architecture according to an embodiment. FIG. 90 shows servers 9002/9012 which can include XIMM modules 9004/9010 that can act as virtual switches 9006/9008. One or more server units 9002 can be equipped with XIMM modules 9004. Each of the XIMM modules 9004 can act as a virtual switch 9006 that is capable of receiving and forwarding packets. All the virtual switches 9006/9008 can be connected to each other. Ingress packets are examined and classified by the XIMM modules 9004/9010. Since they handle a large number of packets, TOR switches used in conventional tree-like topologies forward packets only based on MAC address. The XIMM modules 9004/9010, however, can perform deep packet inspection and classify packets with much more granularity before they are forwarded.

In certain embodiments, the role of layer 2 TOR switches can be limited to forwarding packets to XIMM modules such that all the packet processing is handled by the XIMM modules. In such cases, progressively more server units can be equipped with XIMM modules to scale the packet handling capabilities instead of upgrading the TOR switches (which is costly).

One or more of the XIMM modules 9010 can be further configured to act as traffic manager for the midplane switch. Such a traffic manager XIMM can monitor the traffic and provide multiple communication paths between the servers. Such an arrangement may have better fault tolerance compared to tree-like network topologies.

In conventional network architectures, layer 2 TOR switches can act as the interfaces between the server racks and the external network. In certain embodiments, one or more XIMM modules 9004/9010 can be configured as layer 3 routers that can route traffic into and out of the server racks. These XIMM modules bridge interconnected servers to an external (10 GB or faster) ethernet connection. Thus, using the midplane switch architecture of the described embodiment, conventional TOR switches may be completely omitted.

An exemplary embodiment corresponding to a map-reduce function (e.g., Hadoop) will be described. Map-Reduce can be a popular paradigm for data-intensive parallel computation in shared-nothing clusters. Example applications for the Map-Reduce paradigm include processing crawled documents, web request logs and so on. In Map-Reduce, data is initially partitioned across the nodes of a cluster and stored in a distributed file system (DFS). Data is represented as (key, value) pairs. The computation is expressed using two functions:

Map(k1,v1)→list(k2,v2); Reduce(k2,list(v2))→list(v3)

The input data is partitioned, and Map functions are applied in parallel on all the partitions (called “splits”). A mapper is initiated for each of the partitions which applies the map function to all the input (key, value) pairs. The results from all the mappers are merged into a single sorted stream. At each receiving node, a reducer fetches all of its sorted partitions during the shuffle phase and merges them into a single sorted stream. All the pair values that share a certain key are passed to a single reduce call. The output of each Reduce function is written to a distributed file in the DFS.

Hadoop is an open source, Java based platform that supports the Map-Reduce paradigm. A master node runs a JobTracker which organizes the cluster's activities. Each of the worker nodes runs a TaskTracker which organizes the worker node's activities. All input jobs are organized into sequential tiers of map tasks and reduce tasks. The TaskTracker runs a number of map and reduce tasks concurrently and pulls new tasks from the JobTracker as soon as the old tasks are completed. All the nodes communicate results from the Map-Reduce operations in the form of blocks of data over the network using a HTTP based protocol. The Hadoop Map-Reduce layer stores intermediate data produced by the map and reduce tasks in the Hadoop Distributed File System (HDFS). HDFS is designed to provide high streaming throughput to large, write-once-read-many-times files.

Hadoop is built with rack-level locality in mind. Thus, direct communication between the servers bypassing the TOR switch through intelligent virtual switching of the XIMMs can tightly connect all the processing within a rack. The shuffling step (communication of map results to the reducers) is most often the bottleneck in handling Hadoop workloads.

Referring back to FIG. 53, mappers 5314a/b can operate map functions on the splits 5310a/b. The results can then be communicated to the reducers 5320a/b (via shuffling step 5317). Instead of using HTTP for such communication, the shuffling step 5317 can be performed using a “publish-subscribe” scheme. The results from the map steps can be obtained by XIMM modules performing DMA operations on the main memory. The (key, value) pairs can then be parsed by the XIMM modules and the key is published through the midplane switch fabric. Keys can be identified (through content addressable memory) and forwarded to reducers via virtual interrupts. A midplane switch defined by XIMMs can drive and receive the entire PCI-e 3.0 bandwidth (240 Gbps) connecting map steps with reduce steps within a rack and outside of the rack.

Embodiments have been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

While various embodiments have been described above, it should be understood that they have been presented by way of example only, and not limitation. It will be understood by those skilled in the relevant art that various changes in form and details can be made therein without departing from the spirit and scope of the embodiments described herein. It should be understood that this description is not limited to these examples. This description is applicable to any elements operating as described herein. Accordingly, the breadth and scope of this description should not be limited by any of the above-described exemplary embodiments but should be defined only in accordance with the following claims and their equivalents.

What is claimed is:

1. A method for accelerating computing applications with bus compatible modules, comprising:
by operation of a first module that is bus compatible with a server system, receiving network packets that include data for processing, the data being a portion of a larger data set processed by an application;
by operation of evaluation circuits of the first module, evaluate header information of the network packets to map network packets to any of a plurality of destinations on the first module, each destination corresponding to at least one of a plurality of offload processors of the first module;
by operation of the offload processors of the first module, executing a programmed operation of the application in parallel on multiple offload processors to generate first processed application data; and
by operation of input/output (I/O) circuits, transport the first processed application data out of the first module.

2. The method of claim 1, wherein:
the server system includes a host processor; and
the receiving, evaluation and processing of the network packets and transport of first processed application packets are performed independent of the host processor.

3. The method of claim 1, wherein the transport of first processed application data comprises the writing of the processed data to a storage medium.

4. The method of claim 1, wherein the transport of first processed application data comprises out-going network packets with destination corresponding to a storage medium on another server system.

5. The method of claim 1, wherein the transport of first processed application data comprises out-going network packets with destination corresponding a second module on a different server system.

6. The method of claim 1, wherein the transport of first processed application data comprises out-going network packets with destination corresponding a processor on a different server system.

7. The method of claim 1, wherein the programmed operation of the application is an intermediate operation of a sequence of operations of the application.

8. The method of claim 7, wherein:
the application is a map-reduce application; and
the programmed operation is a record reader operation.

9. The method of claim 7, wherein:
the application is a map-reduce application; and
the programmed operation is a map operation.

10. The method of claim 1, further including, by operation of the I/O circuits, transmit network packets identifying the first processed application data to other modules.

11. A system, comprising:
a first module, comprising:
a connection that is bus compatible with a server system having a host processor;
input/output (I/O) circuits configured to receive network packets that include data for processing, the data being a portion of a larger data set processed by an application, and transport first processed application data out of the first module;
evaluation circuits configured to evaluate header information of the network packets to map network packets to any of a plurality of destinations on the first module, each destination corresponding to at least one of a plurality of offload processors of the first module; and
the plurality of offload processors configured to execute a programmed operation of the application in parallel on multiple offload processors to generate the first processed application data.

12. The system of claim 11, wherein:
the server system includes a host processor; and
the receiving, evaluation and processing of the network packets and transport of first processed application packets are executed independent of the host processor.

13. The system of claim 11, further including a storage medium configured to receive and store the first processed application data.

14. The system of claim 11, further including:
the first processed application data comprises out-going network packets; and
a storage medium on another server system configured to receive and store the first processed application data.

15. The system of claim 11, further including:
the first processed application data comprises out-going network packets; and
a second module on another server system configured to receive the first processed application data.

16. The system of claim 11, further including:
the first processed application data comprises out-going network packets; and
a processor on a different server system configured to receive the first processed application data.

17. The system of claim 11, wherein the programmed operation of the application is an intermediate operation of a sequence of operations of the application.

18. The system of claim 17, wherein:
the application is a map-reduce application; and
the programmed same operation is a record reader operation.

19. The system of claim 17, wherein:
the application is a map-reduce application; and
the programmed operation is a map operation.

20. The system of claim 11, wherein the I/O circuits are configured to transmit network packets identifying the first processed application data to other modules.
